SEQUENCE LISTING (31 sequences)

SEQ ID NO: 1 - DNA, 710 bp, Homo sapiens
  misc_feature (201)..(201): n is g or t
accaaattgttgctaccaatcagtcaatcctaggcacatttaccttcccagttgaacaatcaattatttacacttcctacttcactgtatctttagattatcaatattttcttcaatcttttagttatttaatgtcatatgactaccctcaataatagtatatatgaatgtttgttttggtgatgggaggtcaatcagatngttccagataaccactgccttcctaccttgcctaaataggtatttcacatattctttcccttaaaaactgacataggtcaggcacggtggctgacgcctgtaatcccagcactttgggaggccgaggcaggtggatcacttgaggtcgggagtttgagaccagcccgaccaacatggagaaaccccgtctctactaaaaatacaaaattagccaggtgtggtggcacatgcctgtaatcccagctactggggaggctgagacaggagaattgcttgaactcaggaggcagaggttgcagtgagccaagatcaagccattgcactcaagcttgggcaacaagagcaaaactccatctcaagaaacaaaaaaaaaacaagacaaaaccaaaagaacctgacatagttgtttatctgctgagagtacaagttattgtgataacaaatggcattgcaattggtcatccttttctaatggtatatttgcattttaataactgtattgaaaaact

SEQ ID NO: 2 - DNA, 601 bp, Homo sapiens
  misc_feature (301)..(301): n is c or t
gtcagatatatgtgagttttttgtcaactaaattcatagttgtcttaatattcatcccttgctaaaattaaggtgcagaaataaaatctgtctaatagagaaatataaatccatcttttgtctggataatcaaattttactatattttgttttaatcctgagaatgaaattttacaaatagctcaggaggttttccctagagttccaaataaaagtgtgtggatcatatacacgttctgcttaatcacatgacggttccaaatttttaatttcaatccttcattacgatgaaaatttttgngttttttttccaccagctctttgttttgtttttcaatggctcaggaaaggagaggggtgtgggagactctgtctcttttgacaatcaccagcgccatctactgtcaagaaataaaatcgtgactcattgttaacgcgtcaatgaacattagggcttaaagagggaaagacaattttataccccagtacttactgataaatataagttcatgtacacatatttttatcttatattattgtattcttaagcagcctatagggagaatacaatgaacttaatatataatcatttatgtaattc

SEQ ID NO: 3 - DNA, 837 bp, Homo sapiens
  misc_feature (431)..(431): n is c or t
ctggcggatgcactagccgggctgagggtcaggaatagccttgtggccgcttgtgctcctctggctcctcccaatgagggtcctctagtggagcctcccaatggggctcctctaccctcagcagtgcccttggtcaccaggtcctgtcttggtgccaacaaattcagttctcaaaccatctactgagcacctgctctgggctaggagccctggagccctgatacaaccaagaggtagagcccggagtattgttcttgctgaggagaagcttctggaaggttcagccacaaagatgtcatctgagatcagctttgaaaacattggacaggagcaggttcgagaatgggaggaggaaaggagggttctcctaagtattcaaattagcaccaggagcaggttcgagaatgggaggaggaaaggagggttctccngagtattcaaattagcaccaagagcaggttcgagaatgggaggaggaaaggagggttctcctaagtattcaaattagcaccacctcgtccaccacagggcgttagataagaaaaaagaatcctgccagtatcagacacctgcgcagatagggtaagcgagagtcctgggagcccctcagattcctaacctggactgctctggagcccttccaccatctgttcctttcagacaacaggaggagcagcaggtgtccggagaatgtgctaggggcctcctagtatgagcagtcccacatactgcgtgagcagaaggaggagccactcacgaatatcctcacagaacgcagatgaaaaacaagccaaacagaaacgtcacccacacatgaagaaggtggtcatatggatg

SEQ ID NO: 4 - DNA, 801 bp, Homo sapiens
  misc_feature (401)..(401): n is a or g
agccgcagaccatactctaagtagcctcagagccacacctgagatggagaggcccagccttagactctggtggggtagagtgaagaggacagactcaaatctctaagccaggtgtatcaaaggctaacctgagacctaccatctggtcagaaaggctaacctcagactcacaccccccgaccaaggaggctagtttcaattccaaagccaggagcaagactcacacccccaagcaaggagattagtttcaattcctaagccaggagctaacctcagatggccctgggcaggtggcatgatctctctctccaggctggggagcaggaaagggctcactccacccttgtatgccatttgaggagaacaactccagctggtcctctgggagcacatggagaacnaccacattgtgtcccagggttgcttgcctggcctgcaggcaggacacatacctcctgggccagccggttgatctttagctgcttttccttctccagcatttcctctttctctttgtaaagcttttgctcaaactccagttctttcttattctttctcaagtcctgcaggctgccatacttggctttcttcttatcttttcctttctgagtagatgtggcattgtttatatgacaaaggttagaaatagtgtcgacagcacagcacacggggcatccagtcctcacataacacaaccatcccatggtgagcccctcccccagctctctcaccactctggacatcagacctcaggtttaggacaggaaggccactgctacctactgcagagtgggagacaca

SEQ ID NO: 5 - DNA, 704 bp, Homo sapiens
  misc_feature (504)..(504): n is a or g
cttagaaaaaagggatttggggccaggtgcggtggctcacacctgtaatccctgcactttgggaggccgaggtgggtggatcacgaggtcaggagatcgagaacatcctggctaacatggtgaaaccccatctctactaaaaatacaaaaacattagccgggcgtggtggcaggtgcttgtagtcccagctacttgggagggtgaggcaggagaattgcttgaacacgggaggtagaggttgtggtgagctgagactgcactccagcctgggcaacagagtgagactctatctcaaaaaaaaaaaaaaaaaaaaaagataaaagggattttggatccttataacaccttatccaaatctttaactttttcctgtttttcaaaaaagaaactgtgctgtctgaaggcctgaggaagtagcagactgagtgctacagaatagaacaggacacactccccttgggcctttatcatttccccagagtgggcagtcctcccggacaccncagaatccctacctggcaagagaggctgcagcagctgagttgcttaaaccaaaatttaagtcccaaacctgaaagttttaagaaaagcaaacccccaatacttcccagacctgtttcaaatcattcttgtcggagaagaaatgtaaaggaagggagaactcttagatattggttccaatgaaccgatgctcatcttggtt

SEQ ID NO: 6 - DNA, 1407 bp, Homo sapiens
  misc_feature (662)..(662): n is a or c
tttaaaaacaattttttgttctcctggtaactgtggttctccattcatcccagtgtgttccctgaaagcagagatccttctccaaattcatgttgaagtcctaaaccccagtacctcagaatgagattgtattttgagatgggcctttacagaggtaattaaggttaaatgatattatcagggtaggccctaatccaatatggctggtgtccttatagaagaggagattaggacacagacacacacagggggatgaccacgtgaggagaggagggaagacggccaaatacgagccaagcagagacaccttagcagaaaccaaccctgcccacaccttgatgttgacctgcagcctccagaactgtgaaaattttctgttacatgagccacccagtctgtggtactttattatggctgccagagcagactaagacagtcacccatttaaggggaaaaaaaaggaagttcaggttgaagaaacaggaaacattctgaaaacatgcatataatcaacaagaaaacaaagaattatttagcatattagaaatggaaaaaaagtccgggcgcgatggctcatgcaggtaatcccagcacttcgggaggctgaggcaggcagatcacctgaggtcaggagttcgagaccagcctggccaatatggtgnatccccgtctagaatatgaagcaggcagaagaacgtgaaaaactagactggcttagcctcccagcccacatctttctcccatgctggatgctccctgccattaaacatcagactccaagttcttcagttttgggactcggactggctctccttgctcctcagcttgcagatggcctattgtgggaccttgtgatcatgtgagttaatatttaataaactccctaatatatcctatcagttctgtccctctagagaacactgactaatacacccagacttgcagaatcaccctcaccttcaacaccagcattctggcctgggggctggacatgcaggctggcctgttcctttgcaatcatcccagcatcacagaggccactgtggctgcatggacctatcactcctgacctgttgttactccctctcctcatcttccctgtcctgccccttgagacggctccacttcctgaactccccaaatccaacttccacattccatcttcattgctaacaccctggaccagggcactgagatctctaccctacaagaccacggcaccctcctcatggggctccccacctccacaccaggccctgggtcctccaccttcccaacaggagccagagggagagctttaagtcataaaacagatgatgttgcctctccttgccattcggacttacaactttccagtggcctccaatgaacctacaatgaaatccaaaatccccagcataagagtat

SEQ ID NO: 7 - DNA, 746 bp, Homo sapiens
  misc_feature (501)..(501): n is a or g
ccaatacagtgcacattcttcaatatatcattgaagatcctccacaattagacacaggcctagcagccagacctctcttttctttttttttttttgagacggagtctcgctctgtcgcccaggctggagtgcagtggcgcagtctcggctcaccgcaagctccgcctcccgggttcatgccattctcctgcctcagcctcccgagtagctgggactacaggcgcctgccaccacgcccggctaattttttgtatttttagtagagacggggtttcaccgtgttagccaggatggtctcgatctcctgacctcgtgatctgcccgcctcggcctcccaaagtgctgggattacaggcgtgagccactgcacccggcccagacctctcttttctacggccctctgtgtgtatcccagcccgcagtaaaactggcaccctgggcattccatgagctcagtttgcactatcttacctttgtggctttgctcatattttccctctntctgaacactcttccctccatccgtgaaaaacctgttcgtccttccatgtcctgatttctagccagacacaatactcagtattcctccatagcccgtatcccaatccatctgtgtgaagcagtctagctgcatggccctggggtcggaggcactgtagacaaatggaggctaatgttaccatgtcctgccaggagcagccagctccctccactgccccatgcctcccatcagctccctggctatt

SEQ ID NO: 8 - DNA, 956 bp, Homo sapiens
  misc_feature (222)..(222): n is c or t
gtaaccaagctaagactggatatagatcccacagatatttttggaaatgatgcctgaaatgaatcgttcttcttccagttctgaaagcttatggccctatgatagcataaaaatcaaacatctatcaagtatttttattttctccagtatcactctttgtaaatgatacttctatctcttattttttgttttttcatcttttatttttaaaataattttctnacaattaatatagggagaggaaaaatggtttattagttacctattcctatatttaaaaaatcctcaaaacttagcaatttaaaacaacaatcaagcattttctcttcaagtctgaaatctgagtaccttagctgggaggttctggctctaggtctttcatgaggctgcagtcatgctgtcagttatagctccattctcatttgaaaactttacaaagggaggatccacttaacaattcacctatgtgattgttgttaggcctcagtttcttgctgccttttggccaagccaggtatttcagttccttaccatgtcggcctctccacagcctgaaaaaatttcctttggatatgcaatggtcttcttcttgagggagtgacccacgaggaaagtgtaccccagaaggaagttgcattacttagtattagaagtaatatagtatgccttttgcttttagctagaaataagtcattaagtcaagctgacactcacggggaaagaaattaagctcaactccttgaagggagggttatcaaaaaagttgtggacatatcttttaaactaacccaagtaggtttggaaaaattcttcacaagtaggtttggaaaaattcttcacaagttaattggtctaaagatgatataaaaggcatgtttactttatatcattattttgaaatacaattaaaacaaacaagattaaaaaggaggcatgaaaaggttactttcattgaa

SEQ ID NO: 9 - DNA, 601 bp, Homo sapiens
  misc_feature (301)..(301): n is c or t
tgagacccgcggcccaagcacgggctcgccggcgccgagtcccaggcaggagccgcagtgtcctaccaaagggcagggacgccccgaaccctccagcctcaaaggagtcttcaccccgcgactcccactgcccgtcgcaggcaaaagaataaaaagagagaagcgccgcgcagggctgaccgcgcgagccgggcaccaggtgatgtcagccaacacggcgcggggcacggaaggggcggacttagaaaccgggaatacaaaacggagaagacagcgagagcgctttttcttaccgccgccnggtcctctgggtgcacgtccaccagggtacaccagttccgcgtcccgttcatcttccctcggggtcgcagcacacacgccacttgtccaccccgctgtctggctccaactgggcgggcgcgcgcggaaccgcccccttgtataggcccatcaggggcggggctgaagataggccgcgcccccagttcgcggtttcgcagagaactaacgataggcgaggaggtgaggtgggcggagccaatgggtctgggacatgccccatcggtgctcgcatagatttacacaaaggtggggcttggga

SEQ ID NO: 10 - DNA, 601 bp, Homo sapiens
  misc_feature (301)..(301): n is g or t
cctctattacagatgtctagaataacaagcaaatttaaccactatcacctacggcacaaacttgcaaaagctgtccacaccattttttctttcttgcttgctttaattgtcaggctgcccattcctcccacttctgttctattttcttaaagcacaacgagttcctagttgatagtatggtggagaagagtagaaacagcatggtctatttattttatttttaattcacctagtattcacaaataagaaacgggtatttgtagaaaaaatatatcatatataaaaagtagataagtcccangcaggccattttttagctgatatttacttattgcagattcatacaagggttaaattagataaaacactttgcgtgctgctaataaacaatataaatgtaaaaatacaattctgttagacgttaaagtacaaatggaatagtatttacatttcaaaggaactttgggttcagtcagcctttataggtataagaaatgatgtaacagaactatcactggactagcagtaaggaaacctgggctccaaccttgcctttatcacagtctctaaatgactgtgatattagaaaagtcactcattt

SEQ ID NO: 11 - DNA, 601 bp, Homo sapiens
  misc_feature (301)..(301): n is c or t
aagtcacatgtctttagtttgttttttcttggtcttacttttcacagggaaaaattctcttcatgaggctaatttgaagtttttgaaattaaagactggaatactttcatgctgacagaggtagacgcacacgcactggtatatgcagttacaaatactcgcataaaatggaaaccattatttcatatataaattaattaatcacaaatgctctccatggctaagaaggaatcagtggaaaccagacagaaggtatgcaagacagtcctacagaatgttctaatttgcttttatcacatgnagttgctacattttaggaaaacatgatttaaatatgaaacatgtaatataaattaatatagtggcatgatttattcaggttctcgatgcatataacctggaggtgactaaacgctgatctataacatggtcctatagcttggtactgagaatcacaactctgcgtgtgtgtgtgtgtgtgtgtgtgtgtgtgtgtgtgtgtgtatgttttgcatgttttcctttcctaccacaaacagtgttataaccagattatggcaaataaaagaacagttgtaaatttacccaaatatatcataaa

SEQ ID NO: 12 - DNA, 801 bp, Homo sapiens
  misc_feature (401)..(401): n is a or g
cttacagcatacccgaaagcattggtgaggacacaaaaactacagataagaatcagattctaaaaagacaattctcttttccattcctgtcctctcccctgcaacttcccaatccctcacctctaattaacccgcccaccccttcactagcttctgatttcaggcaacgtccagtacttgttccacctttctctctgaccagccatcaagaagatcttgtatgtttctcctacacacccctgcccctggacccaggaattcttccatttttccatatttgggctatattaagtaataagcccacatgctttctgttgagaaaatacaaaaagatgtttccctctgtcataaagaaaaagaggtaacccagggaacattttgtccctctagttatcttcccncaggcccatcaagaatcaggcagtaggtgaaaaagaaacacagagaacctaggaacacaataggaagaccaccatgggcccttagggagtcagcgaaggcttatgatgcaaaaagaaggtcccaggtaccttaaaaactccacttccctctctaggatccccaagagagcttgacagcgtccctctatgcagatgttcataaatcaggcatatgtaactctgcggtttcctgcacataattgatcacagttgagctgctcagacattaaatccaaaggacatcagagaaggacgagttcagtaaagaacactgagaaagaagtggaccctgagcatagatcttggcatacatgcgtgggaaatggcctctcaaggggtcattatccattcaattacacac

SEQ ID NO: 13 - DNA, 2603 bp, Homo sapiens
  misc_feature (603)..(603): n is c or t
catacttctaaatgaaagttacttgcttttcaagaaaaatttgaagtccatgggttattgctgcgtgattgtactacaaatagagaggactatggcaagtacagttgacccttgaatgatgagggggttaggggtgccaacccccagtgcagtcaaaaacccatgtataacttttgactctccaaaaacttaactactaatagcccactgttgactggaagcctcgtcaataacataaacagttgattaacacatattttgtatatgtattatatattgtattcttatggtaaagcaagctagagaaaaaaatgttactaagggaatcattaaggaagataaaatatatttattattcattaagtggaagtggatcatcataaaggtcttcaatcccatcatcttaataatgagtaggctgaggaggaagaggaggggttgctcttcgctgtctcggggtgacagaggcagaagaggtggaggtggtagaaggggaggcagaaggggcaggcacactccggataactttatggaaattgtaatttctatctgatgtttttgctctttcatttctctaaaaacgtttttgtatggtaccaatcngtcttccactgtttgctttattttcagtgtctgtatcagagaagggtccatgttgtaaaagaagttgaaaggagtcttgaataatcagaaccgttctgccatactgtctaatgtcaatttgtttcctggcactgcttttggtacatcttcttcctcatcatctggtactgttcagaagcactcatctccatcaagcctcttctgttaattactctgctgtggtgtctattagctcttgaattaatccaagatccatatcttgaaagccttcatacactccccaccttttttgccatatgcacaatctctttagtgatttccttgattggccctgccataaatcctgtgaagtcttgcacaacatctggacagttttttccagcaggaatttactgttaggggcttgatggccttcaaggcgttttccacaataacaatggcatcttcaatggtgtaatctttccagattttcatgttctatcagggttttcttccacagtgacaatccttcccatagagtaccatgtgtaatgagccttaaaggtccttatgatcccctactctagaggctgaattaggggcgttatgtttaggggcaagttggccccttggacaccttcagtgttgaactcatgttattctgggtggccaggggtactgtccaatatcaaaataactttaaaagtcagtcccttactggcaagatattgcctgactccagagacaaagccattgatggaaacaatccagaaacagggttctcatcgtccaggccttcttgctgtacaaccaaaagacaggcagctggtatttatcttttcacttaaagcctcagaagttagcaactttatagataagggcagtcctgattttcaacccaactgcatttgtacaaaacagtagagttagcctatcctttcctgccttaaatcctggtgctgcttgcttctcttcctaataaatgtccttcgagcatccttttttttttttttttctccgtaatagggcacttctgtctgcattaaaaactcattcaggcagatatactttctcttcaatgattttttcttaatggcgcctgggaactgtctgctgtctcttggttggcagaagctacttcgcctatttcttgacattttttaagcaaacctcttcctaaaattatcaaaccatcctttgctggcattaaattctccagctttagatccttcactttctttttgctttaagttgtcatatttttcttgaatcatattagatgtaagtatgcctttctacagcaatcctgcatctacataaaagctgcattttcaatgtgagataaaaagatgttctgcaaaaagtgcaagcctgctggagtagctgcagtgatgggttcatgactattcttttctttgtttacaatggtccttacattggatttgtttatcttgaaatggagggcaaacgcagccgcagacctcaatccatggtatgtatcaggcaattcaactttttcttgtaatgtcatgacttttctcagcttcttaggagcacttccagcatcactagtggcactttgtatgggtcccatggtgtcattcaaggtttatggtattgcactaaacatgataaaaaaatacaagagaattccaagagatcaatttttactatgatacacaatttactaaagagatgaaccactcacacaaagatgattagtgtcacatgacattttatgctcaatacttgtaacacttgagttcactgcaatagcaacaggtggccacaaaattattacagtagtacagtattactagagttaattttatgccattatgatttaatgcatctttacatttctttacatttctctcaactgtaaatggtgccatgtatggtctataaatatttgtaaactttgataaattttaactctttataacagatttgtgcatatttataaactagtatctatctacatatattttatgcgttcacgacatatctaactttttctt

SEQ ID NO: 14 - DNA, 401 bp, Homo sapiens
  misc_feature (201)..(201): n is a or g
acctccttattgagactgaagttcaggctaggttgtgcatcaccacttgatactagacttggtatttaaactgccttttctcagctaaagtttcttaagcttgttagacattaaactgaagtatgtagccatgcaattcaaatcagccttagtcttaatttaaaagtgagtagttattgtttcttgacctctgtcagacangaggagctacattttgatgatagtgtagactttgtattacagaacaaattatgtaataaaagcttagtacatgtttgttgaattaaataatcaggacctcggtaattttctctttcatcatcttaagcaatccagttatcttatgaatgacttcttctggttcatgcattgatataaaattattacactaaatggtcaag

SEQ ID NO: 15 - DNA, 1641 bp, Homo sapiens
  misc_feature (1420)..(1420): n is c or t
aaggactgaaaactgcaatagagttaccagagatgccattcttttaaaattcagcaacgttcatttccattgtgcttaaagtttttgtatttctctttttagcaacataggtttgaagactattttacaatattgtatagaatataaaacttcaaagtacatatttcctatgtaaagtcacatgctgtataatgacatttcagtggtcccataagattataatggagctggaaaattcctattgcctcgtatttacaatactatatttttactgttattttagagtgtaccccgacttattaaaaaaaatcaaacaagttaactataatacagcctcaggctgtcttcacgaggcatccagaagaaggtattgttatcataggagatgacacctctatgcttgttattgcccctgaataccttccagtgggacaagaggtggaggtggaaaacagtgatattgatgatcctgacttgtgcaggcctaggctaatgtatgtgtctgtgtcttaatttttaccaaagttttaaaagttaaaaaattgggaaaaagcttattgaataaggatataaagaatatgttttgtacagctctgcgatatgttttaaactacgttattactaaagagtcaaaaagccttaaaaacttaaaaaattattaattaaaaaagttacagtatgctaaggttaatttattattgaagaaaaaattaacaagtttagtattgtctgatttgtaaatgctcataaagtctatagtagtgtatagtaatatcctaggccttcacatacactccccattcactctgactcacccagagcaacttccagtcctgcaagctccattcatggtaagtgcactgtacaggtgtcccatggctggaaaccatcattctcagcaaactaacacaggaacagaaaaccaaacaccgcatgttctcactcataaatgggagttgcacaatgagaacgcatggacacaaggaggggaatatcacacactggggcctgtcgtggggtggggggctaggggagggatagcattagaagaaatacctaatgtagatgacgggttaatgggtgcagcaaaccaccatggcacgtgtatacctatgtaacaaacctgcacgttctgcacatgtatcccagaacttaaagtataataaagaaagtaaaaaaaaaaatcttttatactttttttactgcgccttttctatgtttagatagacacatacttactgttgtgttataactgcctacagtatatagtatagtaacatgctacacaggtttgtagcccaggagcaataggctatactatataggctaggtgtgtggtagactatgatatctaaatttgtacactctatgatgttcacacaatgatggaatcacctaacatttatcaggacgtatcccnggtgttaagcaacacatgattttgttatactaacaattctcttagagattattggggaaaaatttaataagatatttcctacgtttgtaatagaccatcagtggtgacgctctaacaagctgtcatgaagatggccatacacaacaattctgcgtgttttcttttgctatttaagagtgctctgtttgggaaccctgacttataaaccgtggttctggcca

SEQ ID NO: 16 - DNA, 619 bp, Homo sapiens
  misc_feature (105)..(105): n is c or t
taacgggcaccctctgctaactgacaatactgggcaaatacagatgttctccacgccagtttcatcatgtacaaaatcaggataagatctaccacaaaaggccangaggattaaatgtagtcttctgcaagaccattaaactgacagcaggatgcaacggcatgtacccagccagtggcctaaccttgcaggcacaggttagactaggcactgccttaccctgttcgattcttagtgttggtttctagtgaaacgctccaaataaactcaaaattcaaaagtattgttccaaaccctcaggacaggaactatcaatctagtttgccaagaaatgtacttttcattaacttctgatcaggggcaaaaatataatgggtcagaactgaagaatcccatactgagaacttttaaacaaaacttagctacacattgcctcccactcatttttgctttccttgtactgatgtcctttgaacactagtctgaactgcagaatccacttatacacagacttactttcacctctgccatccctgagacagcaagaccaactcctcctttcctcctcagtcaactcaagatgacaaggatgaaaacctttatgatccatttccactta

SEQ ID NO: 17 - DNA, 501 bp, Homo sapiens
  misc_feature (251)..(251): n is c or t
atttgcaatctgcaaaagaaaagccatctatctaaaggggcacgccacactgttattcctttgtaatattaagaaatttatcctaatttaaaagataactgaattcttattcttttacaaattagactttaaaacacagccactgaattgaccaagcactaccaagcttttatcctacttttatttaaatgtactgaaacattagtgatgaaagctttcatttaaagaattctgatgattctaatattcanttataatgtccatttagctaccacattgtgtttatgccccttaaaagctgaagctatgactgctctagtactgagttctccagtgcttatcattaattaaaaggtaaaacacgattaccagggtatctgcaatcaagctttcaatgtaagaaatatcaatatccagtacttgagaacattttggaaccaattttaataggtaaaaaagtccaaagagaagaaaaaatgttctttattatttcaaattaaa

SEQ ID NO: 18 - DNA, 601 bp, Homo sapiens
  misc_feature (301)..(301): n is g or t
atacgtgagcaacgtgtgtgctcgatgtcagaggaaatacagcggctggctcaccccgcccctcccagagggacgatctacacgcagtgttaggagggggcacggagtccacagatcatgggaagaactccatgaatggcctgtgacttgaagcagaagcagacactttccagacaggaaaagaggtgaggagaggcaagggtggtaaagcgccgtatttttggtgaactggccaaaggctgggtggctaatgcacagctgtgttgggacactgagggtagacagggctcaagaagcaagnacagggtggtgagcaggattgcacaaagcagtcacaaggaaggaggccccagtaccgagctgggctggactccaacgtcacagggggctctaactggcaaaaaggaaaaagcatcacaggtgtatgttcatcctggaggacccctggcagtcctgggaggacactcgggagaaagcaggagtggacatggaaactctaggtaagagaacctcagcctcgggcaacagccctagaaacacagataaatgtacaggggagaggacggccatagcagtggagaggtgacgggagattggtcat

SEQ ID NO: 19 - DNA, 646 bp, Homo sapiens
  misc_feature (218)..(218): n is a or g
agagcacagatgactgttgttaagagagagatgtgttactgaggaagataagcagcagccccttgccaatccttagcagcagcttgaagcgaaggggttgagttgcaggatgggcactaaacgcagatgtgagagaaagagcaatggacttggaatcatgactttggggaattcatgtcacttttttgggacttagtttcttggtttataaaatgaanaggctgggctctaaagttcatcccagggatatgtaggttttggtaagagactgggaatggcaagttctgggagctggaattgcttagaaggagtggtctgtgtaagcaccctagtaagaagcttgggtcagcaggagaaaatgtgagggtactggacatctctaagggaaagtaaggggagcatagcaagggcgtggagagtccttgaagccttacctcatagctgtgctaagggtcatccttgaattgaagattgagcagaagcaagggctatttacagttattattcaacaaacatttatggagtgctttttacattaaagatactgtagtaagcacagtaaggcaataaggacaagtgatccagagattcactacttaaaagcagacaaacacaaatgctctaagagcagagtgtgatgagtacc

SEQ ID NO: 20 - DNA, 501 bp, Homo sapiens
  misc_feature (251)..(251): n is a or g
attacaggtgtgagccaccatgccaggcccaggttatgtaaatatttaattgagataatccacataatgcataaatcttagaacatagcaacaaatcaataaagagtagcaatggtgtcgtcacctctgccacattcatcagcaatcaaggtgtgtgccccatcagtcagtggccaagacagggctccacatgtcccgcatctgctcatacccaagagcgaactttcctcgacttcctgcttcatcctccntggtctttgttgaaacaaaacttgaaccaacagttcaacaataaaccagagtattttactttgttttcttctttccctagataactttttattatcttcagagactagggctctgtcgtcaataaatatttttcagacaaggggaagaagaacactaggtgaaacacaaaaccttaggagaaaggttaccacatttattttgatgccaatcccactgaaagttaaagtcaaagcatctgttaaccagatc

SEQ ID NO: 21 - DNA, 1041 bp, Homo sapiens
  misc_feature (521)..(521): n is g or t
tgcacaagatctacttgaggtctgtgcaatcccatttcaaatctcagcagttagtttgcggatattgacaaaatgattccaaagtttatatggagagataaaagatgcaaaaaagtcaagtcagtgttggataaggagaaaagtggaagactaacattaacctaattcaagactgactgtaaagctatagtaatcaagacagtgtagtattggtgatagaatagaaaaattgaatagattaatggaagagaatagagagcccagaaatagactcacataaatattgccaacagatttttgacaaaggagtaaaggcaataccttggcagatagtctttcagcatatggtgctggaacagccagtcatctacaggcaaaaaaaaaaaaaaaaaattccctaaatttaaacccctcagaaaaattaactaaaaagagttataatcctaaatgcaaaattcaaaactataaaactcctggaagataacaggagaaaatctggatactattaggtatagtgatgnctttcaaaataaaccaccaaaggcatgcttcatggaaaaaaaagttgacaagctggatgttattaaaattaaaacttctgctttgcaaacaacaatttcaagagtataagacaagccacagactggaaaaaaatattttcacaagatacactactaaagcactcttatccaacatgtaaaagacactcaaaatttaataatgagaaaatatacaaccttatttaaaaaatagacaaaatatatgaacaaccacctcacaaaagaagacaaacatatgaaaaattagcacatgaatgacgttcaacttcatattgtcattagagaattgcaaattaaaacagtgagataccactgcacacctattagaatgtccaaaatccaaaatactgacaagaccaaatgttgtcaaggatgtggagcaacaggaactctcattcactgctagtgggaatacaaaatggtacagacagtttggaagacagtttggcaatttattataagaacaaccacctcacaaaag

SEQ ID NO: 22 - DNA, 1048 bp, Homo sapiens
  misc_feature (631)..(631): n is c or t
tccgacaatcattatcacatgactttttatcccttggaaaatgattttcttttcataaatcaattcaagctattgattaaaataagagctgaaattccaaaagtaaaaaaaatttgcattgtagctagtaaaacaactaaacgttcctacggagaaaaataatcttatggatatttttctgttgcctctgggggaaaaatacaaagaaatttaatgatgcaagcaatgctatcaaataagatacttttcagtgcttaaactgattgaaactgagtctggagatgcagctggcatcatttccaaataaatatgtatttctcagaaaaccctattagatgcttgacatgctctgtcatttctgaataacctactactgaaatctacacatagaaaaaattaataaactaattgtttctgcttttactatagtagctgagttacaaagcagggggctgaatttgtttaagaaacaaaagattaagagaaacttttcttaatatgatccccatggagcaaagctcctaaggatgttccagaagaaaaactacgccctctaccaagaccaccaaaggtattagaatttgtcaagagttttagtgactggtggtagaacttaatgtggaaagttaanggcctaaatgaaaccatgccccacaatctaacttacctgctttatatgaagaacgcaccaaagggccacttgcagtataatgaaatccaagttcatttcctactttttcccagtatttgaatttttcaggagtaatatattcttcaacctagatttaaataattacttctgatcagattttagaattccactttgattctgcagaaagtctatacctatgtatgcagaatgctcttcactgcgtaatttatcttgcccccacccccaggcttttgtcctctccctcctccctgactacgtgtttactggttactttttggccactctattgggatgtaaatacagggaattacagagacagggaagcatatcaattttgtgctacaatggctattccaaaggacagagaaagaagag

SEQ ID NO: 23 - DNA, 1001 bp, Homo sapiens
  misc_feature (501)..(501): n is c or t
aaaaaacagatttaaggtataattgacatacaataagtggtacatcttaagggtgtacaatttgagaactttggacatactattcacctgagaaattgttaacacaaccaagatgatgaacatatccatcacctccaaagttttctcataccctgtggtaatctctcctaatctcaccatatgatcccatctctaaacacgtactgatctacattttacccttttttgattgctttatggtagaatttgctttattgtggtggcctggaattggacctgcaatatctccgaggaatgcctgtatgctgggcaaaaaaagccagacaaaaaagggtatatattctattattctatgtttagaaaattttagaaaagtaaactaatctatagtgacaaaaagtagtcagtagatcctatctcaagacaccactttctttgctcatccataagaaggaactcctcatctattcaagtttgatcatgagattgcagaaattcagntacatcttatggctcactttctttcttccttccttcccccctccctccttccctccctctcttccttcccttccttccttccttccttccttccttccttccttcctttctgtctttctttctctctctctctctctctcccccccaccccccaactttctttttttctattttttttttttttgacagagtctcactctgttgcccaggctggagtgcaatggcgcgatcttggctcactgcaacctctgcctcctgcgttcaagcaattctcctgcctcagcatctgaagtagctgggattaacaggcgagcaccactatgcctggctcattttttaatttttttttagtagagatggggttcaccatgttggccaggctggtctcgaactccagacctcaggtgatctgcccgccttggcctcccaaagtgctgggattataggtgtgagccactacacccggcccaggctctacttctaatccttgttctctcaca

SEQ ID NO: 24 - DNA, 623 bp, Homo sapiens
  misc_feature (147)..(147): n is c or t
aagcttcaagggacattgcaatttaaataaattcatcttgttttcttgggtcctgatactcaaatgagtaatatgtgatatattatccatcagctttctaatgggacatcatttttcattacattctgacaacagaaatatcccatngcagacaaagccccaggtgtgctgcctcttagctatctttgttctgctacaagtttctttttggctttttaaatattagatgtttaacttgctctggaatagagcaatggtgtgcagcaaaagttacggttacagtaagaggaggaaaaggccaaggcgcttttagcttcttaatttgctctgttttttaaatgatgaacgaaataataaatgacaaaaacaataaaaagcctggacaattgagcaaaattgaatggtgtaggctcatttaaggaaagctgcttgactttttaatattagaatctccattaactgttaacagcacatggagtagataagcaaccctacaggtagaaatgagttcgttgaaagtccattcccagctaaaagccatcaaaatgcaaattaaaagtagtcattgtgatactggagcaaaatgagcaaacgtatgtttcgttttgtgaaatctgaagctt

SEQ ID NO: 25 - DNA, 401 bp, Homo sapiens
  misc_feature (201)..(201): n is a or g
tttgctatttcttatgtaaacttggtgggatttggatactagttactaaaatgagataaaatatgaatctggtttcaagacttctataagggtaaactactttaggagacagaaaaggaataggacaactctccctatcccatgacttggggtgggggtagatgagaaaaataaatggaggcgagaaggaaagaagttcantctaagaatggagatttcatagcttggtcagacatgcatgtccatacagataaactagcagacagttaaaaaataagaaaagaaagttaagattctgaattcttgatttcttccccatatattattcagcataactagcttatatactgtcaactctccaaacaacattaaaaaacctcactcatctagcaaagctaagt

SEQ ID NO: 26 - DNA, 837 bp, Homo sapiens
  misc_feature (408)..(408): n is a or c
ccagggccacctgaaacaccctcaatttcagaaacattttacatttcatgactagcagataaatacccctggggtagtgaattttcaaaatctcacacaggtctccttagagcagagtttctcatctccagcaatattgacatttggagtcagataattatttttgggttggggggtgggcactgatatgttcattgtaggatgtttagcaagatctctggactctgcacactagataccagtagcacccccatagtggtgacaattaactgtgtccccagacattgccaaatgtatcctggggagcaaaatcatctcctattctcacctcctgagaaagaagtgcaggatatcacaatagcagagggcaatggaagatgacagtcccatgctagaagctgctttacnaacacagtcagctgctatctccacaacaggcgggtgaggaaggattcatgaccctcaatgaaatgaacaaatgcaagcaaagccaagttgccattgaatgtggcagttattgtttatttattttattatttattttatttatttatattttaatttctctctctcttttttcttttttcttttttttttttttttttagagagagattgggtctcactgtgttgcccaggctggtctcaaatgtctggcttcaagcaatcctctcaccttagactcccaaagtgcactccgccctgccagagttactatttgaatccagacattctgactctgaggctgcgttttaaccagcctgacatcacgcctcaagcaggggatttttcaaaggacaggatgatggagctgaggctcaagagacagtcagccttg

SEQ ID NO: 27 - DNA, 991 bp, Homo sapiens
  misc_feature (493)..(493): n is c or t
tgacagtatccactgtggacatcctggttccatcttccattgtatactgggtgtgtgtaggcagatgatttgtattttcagtttatgagtctcaaggaatcacagtgtggaagctacactcaagcaatgaaacccaaagtgcctcctatgcacctggacctggtttagatgacaagatcctgacctctagcttgggtctgctatcctaatggaataggacttatgagggcctcagggagtgggggtgagtgtaatttggacatggaagaattgtaaatagtcatacccagagtgtagcaggcagtgatgggttaaatatggctagacattttcgtcacgtctcccattgagtggcagagttcatttccgctcccattgaatctagaatagcctgagccttgctttgcccaacgggacatagtagaagtgatgctgtataatgtctgaggctggggcttaggagagctcggcttcaggttgcagctccacagantccctctcttggagctcagatgcagtgtcgtgagaaccccagtacttgcggtgaggcaatggaaaggaactgaagtgcttctattgatgtctccagccgagctcccagccaacagccagcaccgagtgccagtgtgtgagcaagtcaccagggatgtccagtcaagatgaaccttcagatgaccacagaacccagctgacatctcagggagtaaaactgtccagctgaacctcatcaccccactcaatcatgagaactagttattttttacttaagccactttttttggggggcggtttgtcctgaagcaatagataattaaaacaagcacctttcttccactttaacatttttgatctggttaaaactctctttcaagttaaaaatgaccctgatcttgcatgttcctcgtaaaaaaacaagacctcatgtaccttttaggggaggggctagacttgacattgccatggtagggagggattggggccgtttatgaga

SEQ ID NO: 28 - DNA, 727 bp, Homo sapiens
  misc_feature (461)..(461): n is a or g
cctctttaaagctggactttgaggagttcagatgaccaggtatacactccctcctggtcagttaaaagttatactcaccactttatcctgatgtaatttcttgaacccacagtgtcagacactgttttagagaccggtaatgttattctcttatttgatattcttaagaattgcaactactttatgagttagcctaatgcaggtaacactgaggcaggaaaagaccccagagttagtgacatacaacagcaaaggttgattgttgctcatgctgtagatctaatgcagatcagctgtggctctgctgtgcattgcctttgtcctgaaatctagactaaaagggcacttttgaatacaaaattgcaaaggaaaaagagacccagaaaactattcgctcttaaaacttgtcagacatgacacgtgttactcctgcccacatttcactgaccaaataagttagntagtcacttctaagttcagtagggtggaaaaatataatcctcctgcaaggaaggacagggtagaaaaatggaatatatggctagcagaaatgcaatctgcaatgcactatttagccaccaaatatttagttccctctctcacccataggcagaacatacctccttccctgaggaggcaactcaaaagtcctattcagtaattgttcttagcttaaaagtcaggcttttcggtgatgcaaatttttttcaccataggcctgtatgtt

SEQ ID NO: 29 - DNA, 801 bp, Homo sapiens
  misc_feature (401)..(401): n is c or t
accacgccaagctaatttttgtatttttagtagagacggggtttcaccatattggccaggctggtcttgaacccctgacctcaggtgatccgcccaccctggcctcccaaagtgctgggattacaggcgtgagccaccgcgcccggcccagacacagacttatacatgggcacacacacagacacacagggacacatgcctgtctccaggcatgcacacagacccccccgccaacctgcaaggtgtccctgtatgacatgggtcttgacagtgaccacgtttccccatcaggtcctgcaccctgcacaggtggccccaagccgctgtcacctgcgtctagccaggacaagctgcccccactgcccccactaccgaaccaggaagagaactacgtgaccccnattggagatggcccagctgttgactatgagaaccaagatggtgggtggggaacagagctgctgagagctgggggttggggaaacaggttaacagctgatgtgacacgttacacttttgtccacgcagtggcttcctctagttggccagtcatcctgaagccaaagaagttgccaaagcctcctgccaagcttccaaagccacccgttggacccaagccaggttggggtcccccccatatcccaccctcacctgatggcaggccagcctcagccctcatctgacttttttttttttttttgagacagtctcactctgtcgcccaggctggagtgcagtggcacaaccttggctcactgcaagctccgcctcctgggttcacgccattctcctgcctcagcc

SEQ ID NO: 30 - DNA, 472 bp, Homo sapiens
  misc_feature (201)..(201): n is a or c
caataatatatgctttgtgcaatagaaatataacattaacaaaacaatttaatgaatattcttgtctgtatttttgaaaatattttcatttaagaaagctcataagaatataattactggcctagggtttattcaaaattaaatatttttaaccatcttaaattgtcctccagaattgttgtatccattaatccgaaatancctgcatggaagggcctttttgacaacatattcataacaatttaatgctatctctaacagtttgatgggttagcttctctatgttaatttacatttatctgattactctaaaatatgcatatctttcaaagtatatttgccatttttagttgtctctttgttcatattaattgtttttttggttatttgcttgcttgtttcagtttattgctttggtggatgaggtttgtaaaattctaacattttactatactttttagttcatgaattt

SEQ ID NO: 31 - DNA, 1001 bp, Homo sapiens
  misc_feature (501)..(501): n is c or t
taattggtaataaactatggtgcttccaaataatgaaattctttgtagccattaaaaatgttgctatagatccctatttatgctgtaacctgctccatgctgagccacattcctggttcccctccctgcattgctttttccctagcacgaatccctcaaatgtgctctgtaatttattccttcaatatctgcatccttatctgtaactacccgctagaatgtaagctcagagaggacagtgttaagtgtctttcttcttggatgtatctcaactgcccagaaaaattcttcacaagagttcttgagtaggcactcaataaatatttgttgtaggagagcaacttagaaccagaatttctgtgcaaagaagtataaacatgttcaaaacctctagggcatcctataaaattgtttctatggagatatatatacattcacactttaaaagggactttttaaagcaccatgaaacatgctcagagatgatagatcatcaatatntcccccccgttttaggatcttcagcaaagcataatgtgtttttttctatcagaacttaaaagaacactttgttcttccacaatctttttttcactgtatgaacttaagactgttttttaaaagtaagctcctaggatttccctttacaatccaaatagttccctgacctagtctaaaagtcctaataaagagttattttgagattgacttttcttttgtagttttatatttattgcgttttaagaaagcatctcccagaaacattgcattaacaaaataaaatctaggccgggtgtggtggctcacacctgtaatcccagcactttgagaggccgagccaggcggatcgcttgagcccaggagtttgagaccagcctgggcaacatagggagacaatgtctctgcaaaaagatataaaaattagccgggcatggtgacacgcaactttactcccagctacttgagaggctgaggcaggagtatcgcttgagcccggaagg

(19) United States
(12) Patent Application Publication
(10) Pub. No.: US 2011/0301863 A1
(43) Pub. Date: Dec. 8, 2011

(54) PREDICTION METHOD FOR THE SCREENING, PROGNOSIS, DIAGNOSIS OR THERAPEUTIC RESPONSE OF PROSTATE CANCER, AND DEVICE FOR IMPLEMENTING SAID METHOD

(75) Inventors: Prénoms Karine Auribault, Montrouge (FR); Jean-Denis Muller, Clairefontaine-En-yvelines (FR); Géraldine Cancel-Tassin, Soisy-Sur-Seine (FR); Olivier Cussenot, Paris (FR); Stéphane Gazut, Gif-Sur-Yvette (FR); Nicolas Gilardi, La Richardais (FR); David Mercier, Dourdan (FR); Jean-Philippe Poli, Paris (FR); Emmanuel Ramasso, Besancon (FR); Frédéric Suard, Versailles (FR)

(73) Assignee: COMMISSARIAT A L'ENERGIE ATOMIQUE ET AUX ENERGIES ALTERNATIVES, Paris (FR)

(21) Appl. No.: 13/056,746

(22) PCT Filed: Jul. 31, 2009
(86) PCT No.: PCT/EP2009/059930

§ 371 Date: Mar. 29, 2011

(30) Foreign Application Priority Data
Aug. 1, 2008 (FR) 08 04414

(51) Int. Cl. G06F 19/00

(52) U.S. Cl. 702/20

(57) ABSTRACT

The invention includes a prediction method for the screening or diagnosis or therapeutic management or prognosis of prostate cancer, including collecting individual input data and providing predictive information on the risk linked to a type of disease. The input data includes at least one variable or a combination of variables of the genetic type such as the identification of markers of genetic polymorphisms considered as being linked to the development of the disease. The invention also provides an individual prediction device for the screening or diagnosis or therapeutic management or prognosis of prostate cancer including first means for acquiring individual information data by a user, and at least a first software interface on which the said first means operate. The invention additionally includes a computer program product having the method and providing predictive information on risk linked to a disease.

### CROSS-REFERENCE TO RELATED APPLICATIONS

This application is a National Stage of International patent application PCT/EP2009/059930, filed on Jul. 31, 2009, which claims priority to foreign French patent application No. FR 08 04414, filed on Aug. 1, 2008, the disclosures of which are incorporated by reference in their entirety.

### FIELD OF THE INVENTION

The field of the invention is that of individual prediction methods for the screening, diagnosis, prognosis or therapeutic response of diseases and the side effects of medicaments in the case of complex and multifactorial diseases such as cancers and notably prostate cancer.

### BACKGROUND OF THE INVENTION

Nowadays, there are forms of cancer, and notably prostate cancer, that are widespread in humans in industrialized countries and whose incidence has substantially increased in recent years.

The diagnosis and the treatments proposed require the carrying out of invasive and expensive procedures. The current methods developed for determining populations at risk or the management strategies propose positive or negative predictive values (cancer/no cancer) according to tests (tumor markers, molecular signatures and the like) or results obtained from linear functions of the nomogram type, but their reliability is less than 80% and the results are rarely reproducible on an individual scale.

Currently, it has been proposed to evaluate a risk of prostate cancer by a blood test for the prostate specific antigen (PSA) which is the reference marker for deciding on an invasive procedure of the biopsy type for the histological confirmation of a prostate cancer, typically in the cases of detection of a measured level greater than 4 ng/ml, or even 2.5 ng/ml in some protocols.

Above 4 ng/ml of blood PSA level, the sensitivity is 30%, which means that among the people who have a total PSA level greater than 4 ng/ml, only of the order of 3 out of 10 have a prostate cancer.

At the threshold of 4 ng/ml, the specificity of the PSA test is of the order of 80%, which means that when the PSA threshold is less than 4 ng/ml, the absence of prostate cancer is real in 8 cases out of 10.

Tools for evaluating the nomogram-type risk incorporating several parameters have been developed in order to respond to individual questions and have in particular been described in the journal [S. F. Shariat, P. I. Karakiewicz, C. G. Roehrborn and M. W. Kattan, An updated catalog of prostate cancer predictive tools, Cancer (113), p. 3075-99, 2008].

Nomograms are statistical tools intended for decision-making, which contain information obtained from hundreds of concrete observations on proven cases of prostate cancer. These tools help patients and doctors during decision-making. They provide predictions calculated from a variety of clinical data obtained from previously treated prostate cancers. They are slide rules or abacuses constructed on the basis of multivaried logistic regressions. These nomograms have a mean accuracy rate of 80%, which remains insufficient. Patients nevertheless obtain therefrom undeniable advantages because they are free of the partiality and the subjectivity found in various clinicians and health care professionals. By way of example, 12 questions and associated predictive tools are proposed by the Fondation de Recherche Canadienne sur le Cancer de la Prostate [Canadian Foundation for Research on Prostate Cancer].

The existing solutions used in this type of predictive tools are most often based on the collection of clinical and evaluation data using linear methods of modeling relative to the parameters. The methods developed are insufficient in terms of reliability and do not make it possible to carry out hierarchical predictions such as: risk of cancer, risk of rapidly progressing cancer, risk of cancer resistant to a treatment which are sufficiently low.

Decision taking in good concepts of personalized medicine could ideally take into account characteristics specific to the patient, for instance constituent genetic data or family histories. These informative data on cancer susceptibility, appropriately modeled, would, in the case of prostate cancer, make it possible to assist patients and specialists in deciding on the relevance of age of entry in a screening process and of the risk of a positive biopsy, and could even be decisive in terms of management of the patent diagnosed. This is because some genetic markers are correlated with the aggressiveness of prostate cancer [O. Cussenot, et al., Effect of genetic variability within 8q24 on aggressiveness patterns at diagnosis and familial status of prostate cancer, Clin Cancer Res (14) pp 5635-9; 2208] and can therefore assist in deciding on the relevance of a treatment, typically radical prostatectomy for localized forms of cancer. The notion of susceptibility to cancer to which the present invention refers can in fact be used in various clinical situations.

The search for relevant markers represents the challenge of predictive medicine. It is a technological challenge with respect to genomics, but also with respect to mathematics. The etiology relating to the causes and the progression of prostate cancers is complex and is the result of multiple stochastic interactions between constitutional genetic factors, acquired tissue factors and environmental factors. The conviction that genetic factors are important in the etiology of prostate cancer comes from the observation of clusters of cases in certain families [Carter B S Mendelian inheritance of familial prostate cancer, PNAS (89) 3367-7 (1992)]. It has been possible to demonstrate highly penetrating mutations i.e. the presence of which signifies a strong probability of becoming sick, such as those of the BRCA1 gene; see, for example [J. A Douglas et al., Common variation in the BRCA1 gene and prostate cancer risk Cancer Epidemiol Biomarkers Prev (16) pp 1510-6 (2007)].

Only 5% of prostate cancer cases appear to correspond to the simplest Mendelian inheritance model [G. Cancel-Tassin and O. Cussenot Prostate cancer genetics Minerva Urol Nefrol (4) p 289-300 (2005)]. The investigation of more complex interactions, between alleles with low penetrance, i.e. in models where each allele is only involved a small amount in the tumorigenesis process, has taken over from the search for a mutation in candidate genes. Thus, the search for genetic markers for thorough identification of the points in the genome that may be involved in susceptibility to prostate cancer has resulted in the implementation of association studies, such as the “genome wide association studies”, which produce genotyping data covering as much as possible the human genome for DNA sequence polymorphisms. This genotyping produced for control individuals and individuals suffering from prostate cancer should make it possible, by comparison, to identify polymorphisms statistically associated with the pathological condition of interest. For prostate cancer, three GWAS studies are currently a benchmark; Gudmundsson, J. et al., Genome-wide association study identifies a second prostate cancer susceptibility variant at 8q14 Nat Genet (39) p 631-7 (2007), Thomas G. et al., Multiple loci identified in a genome-wide association study of prostate cancer Nat Genet (40) p 310-5 (2008) and Eeles, R. A. Multiple newly identified loci associated with prostate cancer susceptibility Nat Genet (40) 316-21 (2008).

A second challenge for predictive medicine consists in modeling associations of variables [E. F. Easton Genome-wide association studies in cancer Hum Mol Genet (17) R109-15 (2008)], complex analyses of combinations of variables being a particular field of algorithm research.

### SUMMARY OF THE INVENTION

In this context, the present invention provides an individual prediction method for the screening or diagnosis or prognosis or therapeutic response of cancer and more particularly well suited to prostate cancer, based on the collection of very large amounts of genetic data to which clinical data can be attached and comprising the production of an advanced model which makes it possible to deliver a risk value which can be advantageously further subjected to a validation procedure.

More specifically, the subject of the present invention is an individual prediction method for the screening or diagnosis or therapeutic management or prognosis of prostate cancer comprising collecting individual input data (xi) and providing predictive information on the risk (y) linked to a type of disease, characterized in that:
representative information, which is genetic information and/or results of clinical information on a patient, is collected in order to obtain said individual data;
the individual data (xᵢ) are acquired using data capture means;
a prediction tool is produced by constructing at least one model by statistical learning, the input variables of this model being said representative information;

the genetic input information comprising at least one variable or a combination of variables (all the nucleotide locations cited correspond to those defined by the “UCSC genome browser”, assembly of March 2006) among the following:
variable defining the genotype linked to the SNP rs2174183 and/or to one or more of its neighbors in the interval 127602673-128447913 of chromosome 4;
variable defining the genotype linked to the SNP rs7576160 and/or to one or more of its neighbors in the interval 37855761-38126567 of chromosome 2;
variable defining the genotype linked to the SNP rs2012385 and/or to one or more of its neighbors in the interval 241767109-242119399 of chromosome 2;
variable defining the genotype linked to the SNP rs888298 and/or to one or more of its neighbors in the interval 63815611-64165896 of chromosome 17;
variable defining the genotype linked to the SNP rs8110935 and/or to one or more of its neighbors in the interval 62026584-62294837 of chromosome 19;
variable defining the genotype linked to the SNP rs2190453 and/or to one or more of its neighbors in the interval 17464539-17757162 of chromosome 11;
variable defining the genotype linked to the SNP rs2788140 and/or to one or more of its neighbors in the interval 210157195-210446272 of chromosome 1;
variable defining the genotype linked to the SNP rs3828054 and/or to one or more of its neighbors in the interval 149382371-149874970 of chromosome 1;
variable defining the genotype linked to the SNP rs1499955 and/or to one or more of its neighbors in the interval 116302446-117011700 of chromosome 3;
variable defining the genotype linked to the SNP rs4855539 and/or to one or more of its neighbors in the interval 69049525-69153397 of chromosome 3;
variable defining the genotype linked to the SNP rs11526176 and/or to one or more of its neighbors in the interval 27414591-27808301 of chromosome 7;
variable defining the genotype linked to the SNP rs7934514 and/or to one or more of its neighbors in the interval 99092040-99333419 of chromosome 11;
variable defining the genotype linked to the SNP rs6681102 and/or to one or more of its neighbors in the interval 236815776-236998150 of chromosome 1;
variable defining the genotype linked to the SNP rs6492998 and/or to one or more of its neighbors in the interval 38991207-39584443 of chromosome 15;
variable defining the genotype linked to the SNP rs2048873 and/or to one or more of its neighbors in the interval 113062733-113411386 of chromosome 2;
variable defining the genotype linked to the SNP rs4669835 and/or to one or more of its neighbors in the interval 12111054-12324507 of chromosome 2;
variable defining the genotype linked to the SNP rs12605415 and/or to one or more of its neighbors in the interval 2397695-24187878 of chromosome 18;
variable defining the genotype linked to the SNP rs749915 and/or to one or more of its neighbors in the interval 39097014-39163238 of chromosome 4;
variable defining the genotype linked to the SNP rs13226041 and/or to one or more of its neighbors in the interval 104002818-104863625 of chromosome 7;
variable defining the genotype linked to the SNP rs721429 and/or to one or more of its neighbors in the interval 61335448-62195826 of chromosome 17;
variable defining the genotype linked to the SNP rs2352946 and/or to one or more of its neighbors in the interval 84695541-84776802 of chromosome 16;
variable defining the genotype linked to the SNP rs9364048 and/or to one or more of its neighbors in the interval 70074721-70679396 of chromosome 6;
variable defining the genotype linked to the SNP rs6755695 and/or to one or more of its neighbors in the interval 79446556-79664842 of chromosome 2;
variable defining the genotype linked to the SNP rs1138253 and/or to one or more of its neighbors in the interval 4098195-4506560 of chromosome 19;
variable defining the genotype linked to the SNP rs1773842 and/or to one or more of its neighbors in the interval 29356293-29651117 of chromosome 10;
variable defining the genotype linked to the SNP rs10148742 and/or to one or more of its neighbors in the interval 43257771-43665346 of chromosome 14;
variable defining the genotype linked to the SNP rs10245886 and/or to one or more of its neighbors in the interval 47461234-47557773 of chromosome 7.

According to one variant of the invention, the input data correspond to the combination of a variable defining the genotype linked to the SNP rs2174183 and/or to one or more of its neighbors in the interval 127602673-128447913 of chromosome 4 and/or of a variable defining the genotype linked to the SNP rs7576160 and/or to one or more of its neighbors in the interval 37855761-38126567 of chromosome 2 and/or of a variable defining the genotype linked to the SNP rs2012385 and/or to one or more of its neighbors in the interval 241767109-242119399 of chromosome 2.

According to one variant of the invention, the input data correspond to the combination of a variable defining the genotype linked to the SNP rs2174183 and/or to one or more of its neighbors in the interval 127602673-128447913 of chromosome 4 and/or of a variable defining the genotype linked to the SNP rs2190453 and/or to one or more of its neighbors in the interval 17464539-17757162 of chromosome 11 and/or of a variable defining the genotype linked to the SNP rs888298 and/or to one or more of its neighbors in the interval 63815611-64165896 of chromosome 17.

According to one variant of the invention, the input data correspond to the combination of a variable defining the genotype linked to the SNP rs2174183 and/or to one or more of its neighbors in the interval 127602673-128447913 of chromosome 4 and/or of a variable defining the genotype linked to the SNP rs2788140 and/or to one or more of its neighbors in the interval 210157195-210446272 of chromosome 1 and/or of a variable defining the genotype linked to the SNP rs7934514 and/or to one or more of its neighbors in the interval 99092040-99333419 of chromosome 11.

According to one variant of the invention, the input data correspond to the combination of a variable defining the genotype linked to the SNP rs2174183 and/or to one or more of its neighbors in the interval 127602673-128447913 of chromosome 4 and/or of a variable defining the genotype linked to the SNP rs3828054 and/or to one or more of its neighbors in the interval 149382371-149874970 of chromosome 1 and/or of a variable defining the genotype linked to the SNP rs1499955 and/or to one or more of its neighbors in the interval 116302446-117011700 of chromosome 3.

According to one variant of the invention, the input data correspond to the combination of a variable defining the genotype linked to the SNP rs2174183 and/or to one or more of its neighbors in the interval 127602673-128447913 of chromosome 4 and of a variable defining the genotype linked to the SNP rs8110935 and/or to one or more of its neighbors in the interval 62026584-62294837 of chromosome 19.

According to one variant of the invention, the input data correspond to the combination of a variable defining the genotype linked to the SNP rs2174183 and/or to one or more of its neighbors in the interval 127602673-128447913 of chromosome 4 and of a variable defining the genotype linked to the SNP rs4855539 and/or to one or more of its neighbors in the interval 69049525-69153397 of chromosome 3 and/or of a variable defining the genotype linked to the SNP rs4242382 and/or to one or more of its neighbors in the interval 128539973-128619555 of chromosome 8.

According to one variant of the invention, the input data correspond to the combination of a variable defining the genotype linked to the SNP rs6492998 or to one of its neighbors in the interval 38991207-39584443 of chromosome 15 and of a variable defining the genotype linked to the SNP rs11526176 and/or to one or more of its neighbors in the interval 27414591-27808301 of chromosome 7 and of a variable defining the genotype linked to the SNP rs6681102 or to one of its neighbors in the interval 236815776-236998150 of chromosome 1.

According to one variant of the invention, the input data correspond to the combination of a variable defining the genotype linked to the SNP rs1511695 and/or to one or more of its neighbors in the interval 218280585-218521047 of chromosome 1 and of a variable defining the genotype linked to the SNP rs4669835 and/or to one or more of its neighbors in the interval 12111054-12324507 of chromosome 2 and of a variable defining the genotype linked to the SNP rs12605415 or to one of its neighbors in the interval 23907695-24187878 of chromosome 18.

According to one variant of the invention, the input data correspond to the combination of the four cancer history variables, of an age category variable, of a variable defining the genotype linked to the SNP rs4242384 and/or to one or more of its neighbors in the interval 128539973-128619555 of chromosome 8 and of a variable defining the genotype linked to the SNP rs9364048 and/or to one or more of its neighbors in the interval 70074721-70679396 of chromosome 6.

According to one variant of the invention, the input data correspond to the combination of a variable defining the genotype linked to the SNP rs749915 and/or to one or more of its neighbors in the interval 39097014-39163238 of chromosome 4 and of a variable defining the genotype linked to the SNP rs13226041 and/or to one or more of its neighbors in the interval 104002818-104863625 of chromosome 7 and of a variable defining the genotype linked to the SNP rs721429 and/or to one or more of its neighbors in the interval 61335448-62195826 of chromosome 17.

According to one variant of the invention, the input data correspond to the combination of a variable defining the genotype linked to the SNP rs2352946 and/or to one or more of its neighbors in the interval 84695541-84776802 of chromosome 16 and of a variable defining the genotype linked to the SNP rs6755695 and/or to one or more of its neighbors in the interval 79446556-79664842 of chromosome 2 and of a variable defining the genotype linked to the SNP rs1138253 and/or to one or more of its neighbors in the 4098195-4506560 of chromosome 19.

According to one variant of the invention, the input data correspond to the combination of a variable defining the genotype linked to the SNP rs13148138 and/or to one or more of its neighbors in the interval 127602673-128447913 of chromosome 4 and of a variable defining the genotype linked to the SNP rs1773842 and/or to one or more of its neighbors in the interval 29356293-29651117 of chromosome 10 and of a variable defining the genotype linked to the SNP rs10148742 and/or to one or more of its neighbors in the interval 43257771-43665346 of chromosome 14.

According to one variant of the invention, the input data correspond to the combination of a variable defining the genotype linked to the SNP rs2174183 and/or to one or more of its neighbors in the interval 127602673-128447913 of chromosome 4 and of a variable defining the genotype linked to the SNP rs11526176 and/or to one or more of its neighbors in the interval 27414591-27808301 of chromosome 7.

According to one variant of the invention, the input data correspond to the combination of a variable defining the genotype linked to the SNP rs2048873 and/or to one or more of its neighbors in the interval 113062733-113411386 of chromosome 2 and/or of a variable defining the genotype linked to the SNP rs6804627 and/or to one or more of its neighbors in the interval 60928379-60979489 of chromosome 3 and of a variable defining the genotype linked to the SNP rs10245886 and/or to one or more of its neighbors in the 47461234-47557773 of chromosome 7.

According to one variant of the invention, the individual prediction method relates to the screening, diagnosis, prognosis or therapeutic response of a prostate cancer, the data being of the clinical type such as individual data relating to the age of the patient, their weight, their height, the personal and family history of cancer, of the biological type with, for example, the PSA level, and of the genetic type such as the identification of genetic polymorphism markers considered to be linked to the development of the disease and selected from the abovementioned lists.

According to one variant of the invention, the method of the invention comprises a “learning” process:

the constitution of a database of examples (Bex) consisting of input data (xₘᵢ) and of proven results (yₘ*);

the construction of at least one optimum model by statistical learning comprising the following steps:
the choice of a family (F) of multivariable functions (f₁, . . . , fᵢ, . . . f_{N});
for a given function fᵢ, the production of a model defined by the adjustment of parameters θj such that the estimation delivered by the model yₘ=fᵢ (xₘᵢ, θj) is as close as possible to that of the proven result yₘ*;
the comparison of the various estimations so as to define a function fᵢ that is optimized fᵢₒₚ and that makes it possible to define an optimum model;

the exploitation of the said optimum model from the said individual data (xᵢ) so as to provide the said predictive information (y) on the risk linked to a disease.

According to one variant of the invention, the method comprises the construction, in parallel, of a set of optimum models, each model being produced from a family (Fk) of functions, the predictive information on the risk linked to a disease resulting from the exploitation of the set of optimum models.

According to one variant of the invention, the method comprises:

the creation of a learning base (BA) and a validation base (BV) from the examples base;

a process for validating the predictive result (y*) by comparison between the said predictive result obtained with a model constructed with the set of input data belonging to the learning base, and the proven result obtained from a set of similar input data belonging to the validation base.

According to one variant of the invention, the method comprises, for a given base comprising N data, the construction of the learning base carried out by random sampling (without replacement) of M data belonging to the examples base, N-M remaining data constituting the validation base.

According to one variant of the invention, the family of functions is of the MLP (Multi Layer Perceptron) type, a subset of the family of networks of neurons or of the Support Vector Machines (SVM) type or of the Relevance Vector Machines (RVM) type or of the frequentist model type relating to the nearest neighbor method.

According to one variant of the invention, the estimation delivered by the model yₘ=fᵢ (xₘᵢ, θj) is compared to the proven result yₘ* with a cost function of the cross-entropy score type in the case of the discrimination:

−[y*log(ƒ(x,θ)+(1−y*)log(1−ƒ(x,θ)]

or of the log likelihood criterion type noted

−log(P(y|x,θ))

and corresponding to the probability of obtaining y from the parameters x and θ or of the quadratic deviation type in the case of the regression:

(ƒ(x,θ)−y*)².

According to one variant of the invention, the comparison between the said predictive result obtained with a model constructed with the set of input data belonging to the learning base, and the proven result obtained from a set of input data belonging to the validation base is carried out with a cost function similar to that used in the comparison between the estimation delivered by the model and the proven result y*.

According to one variant of the invention, the final result of the modeling can be obtained by fusion of optimum models that can be constructed from two different sets of variables and obtained from different families of functions. In this fusion phase, it is useful to select the models to be fused and also the method of fusion to be implemented (model response means, product, majority vote, Choquet integral, Sugeno integral [Ludmila I. Kuncheva, James C. Bezdek, and Robert P. W. Duin. Decision templates for multiple classifier fusion: an experimental comparison. Pattern Recognition, 34:299-314, 2001]). This is because a strategy that will consist in fusing all of the optimum models constructed is not generally satisfactory. It is necessary to carry out a selection of an optimum subset of models from all the optimum models constructed, while having recourse to optimization methods, such as, for example, genetic algorithms.

According to one variant of the invention, the individual clinical data correspond to the combination of four cancer history variables and of one age category variable, the said history variables relating respectively to the family history of breast cancer, the history of prostate cancer, the personal history of cancer and the family history of other cancers.

The subject of the invention is also an individual prediction device for the screening, diagnosis or prognosis, therapeutic response of a prostate cancer comprising first means for acquiring individual information data by a user, at least a first software interface on which the said first means operate, characterized in that it additionally comprises a software using the method according to the invention and providing a predictive information on the risk linked to prostate cancer.

According to one variant of the invention, the said predictive information on the risk is restored to the user via the said software interface.

According to one variant of the invention, the device additionally comprises means of communication between the first acquisition means and the software, allowing the transmission of the information data and that of the predictive information.

According to one variant of the invention, the device additionally comprises second individual information data acquisition means and a second software interface, the first acquisition means relating to the acquisition of information of the clinical type, and the second means relating to the acquisition of information derived from a sample from the individual.

### BRIEF DESCRIPTION OF THE DRAWINGS

The invention will be understood more clearly and other advantages will appear on reading the description which follows and which is given without limitation and by virtue of the accompanying figures among which:

FIG. 1 illustrates a scheme which summarizes the interactions between the examples base, the real results and the predictive results;

FIG. 2 illustrates a representation of a type of network of neurons;

FIGS. 3a to 3e illustrate respectively the performances of algorithms of the Multi-Layer Perceptron type in relation to discriminating between patients suffering from prostate cancer and controls with, as input variables, the age category and respectively the genotype associated with the SNP rs2969612, rs1167190, rs1314813, rs2174183 and rs1604724;

FIG. 4 illustrates a first example of use in which the software tool is implanted by the practitioner;

FIG. 5 illustrates a second example of use in which the software tool is centralized by a professional providing predictive results;

FIG. 6 illustrates a comparison between the performances obtained with an NG1 model using the best 3 SNPs, including the SNP rs4242382, in the p-value sense of the abovementioned Nature Genetics article, and those obtained with a B1 model using 3 SNPs, including the SNP rs4242382, identified as synergic by the methods of the applicant;

FIG. 7 illustrates a comparison between the performances obtained with an NEJM model constructed from the age and history variables of a database constituted in the present invention and from 5 SNPs described in [Zheng S L, Sun J, Wiklund F, et al., Cumulative association of five genetic variants with prostate cancer, NEngl JMed 2008; 358:910-9], those obtained with a D2 model using SNPs disclosed in the present invention and those obtained with a fusion model according to the invention;

FIG. 8 illustrates a comparison between the performances obtained with an NEJM model constructed from the age and history variables of a base constituted in the present invention and from 5 SNPs described in Zheng SL et al., and those obtained with a D2 model using SNPs disclosed in the present invention, said models not using history variables;

FIG. 9 illustrates a comparison between the performances obtained with an NG1 model using the best 3 SNPs disclosed in G. Thomas et al., Multiple loci identified in a genome-wide association study of prostate cancer, Nature Genetics, vol 40, num3, March 2008, those obtained with the D2 model and those obtained with a fusion model;

FIG. 10 illustrates a comparison between the performances obtained with the NG1 model and those obtained with the D2 model, said models not using history variables;

FIG. 11 illustrates a comparison between the performances obtained with a B2 model using 7 SNPs selected according to the invention and those obtained with an NG2 model using the best 7 SNPs in the p-value sense of the abovementioned Nature Genetics article and the histories;

FIG. 12 illustrates the “AUC” performances of the models described above.

### DETAILED DESCRIPTION

The benefit of the present invention lies in particular in making available to doctors a tool that helps in decision making for a personalized management of their patients. Its novelty lies in the combination of an exclusive database and multidimensional statistical analyses. The user can thus benefit from a knowledge derived from multi-disciplinary research studies in medicine, biology, genetics, mathematics and from objective results. The medical impact of this expert system is also economical because it allows practitioners to better detect the early and curable stages of the disease, to reduce costs and the side effects associated with invasive diagnostic and therapeutic methods. Finally, for the patient, the aim is to obtain an optimum management of their pathology, a reduction in the risk of overtreatment, an increase in their life expectancy and an improvement in their quality of life.

According to the invention, the prediction tool is produced by virtue of the upstream construction of statistical learning models. We are going to describe the principle of construction below.

A model, constructed in the context of the theory of statistical learning, is generally a parameterized mathematical function ƒ which contains adjustable parameters θ and belonging to a larger family of functions F.

This function makes it possible to deliver an estimation y as a function of a number of inputs x which are input variables of the problem.

In the case of the present invention:
the inputs x are genetic items of information and/or the coded results of clinical items of information which may be derived notably from a patient questionnaire; when the inputs x are qualitative (or categorical) variables, the encoding of these variables as numerical values is necessary in order to make them directly usable by the models in the context of their construction and of their use as an estimator. By way of example, for the information on the family history of prostate cancer, the encoding may consist in coding the qualitative variable “my grandfather” with the value “1” which will include all the second degree relatives. The encoding should neither mask nor confuse the information, and it should be relevant. In the preceding example, the coding can be refined if it is desired to distinguish or not distinguish between the maternal grandfather illness and the paternal grandfather illness. The encoding of the data may be inventive, its quality (exhaustibility, relevance) partly determines the possibilities of resolving the problem of discrimination posed. The encoding is not necessarily binary, the number of categories (and therefore of possible numerical values) depends on the number of states of the qualitative variable. For a given SNP, there are two alleles A and B in the population, an individual may be of the AA BB or AB genotype, the encoding here is ternary. If an allele C is added to the population, the combinations which are added are CC CA CB, therefore an encoding with 6 categories.
the estimate y, delivered by the model, is the class of patient (cancer/no cancer) or the risk of having cancer.

This estimate y may be considered as being a function ƒ dependent on the inputs x and of the parameters θ.

The whole difficulty of creating a model lies in the adjustment of the parameters θ. These parameters θ are adjusted in a so-called learning phase which requires examples and the use of dedicated algorithms.

In general, all the models constructed by statistical learning require examples. Indeed, as a system capable of learning, these models use the principle of induction, that is to say learning by experience. The examples base consists of a set of N pairs (x, y*) representative of the process studied which it is desired to model.

The variable x is, as above, a value among a set of input values and y* is the real output associated with these inputs considered as the truth which it is desired to estimate (cancer/no cancer diagnosis delivered by a specialist for example). This database is represented in the form of a table of N lines, where each line represents an example (the input values for an individual and its associated class). The aim of the learning is to construct a model, from these N examples, in order to estimate in fine the response which the specialist would have given on a new case that has never been encountered. The expression “capacity for generalization” is used in this case. In the procedure for creating models, the one which will deliver the best capacity for generalization will be chosen.

The representativeness of the data is a very important notion since it determines the quality of the model constructed and since the information which can be learnt from the model is contained in the base through the N examples. The expression “representativeness” is understood to mean the exhaustive character of the cases contained in the base. That is to say that it should be ensured that the model has met a set of cases similar to those encountered in its future use as an estimator. The phase for constituting the learning base is therefore a key step and should be performed rigorously.

The following paragraph describes how the learning algorithm adjusts the parameters of the model according to the constituent elements of the learning base.

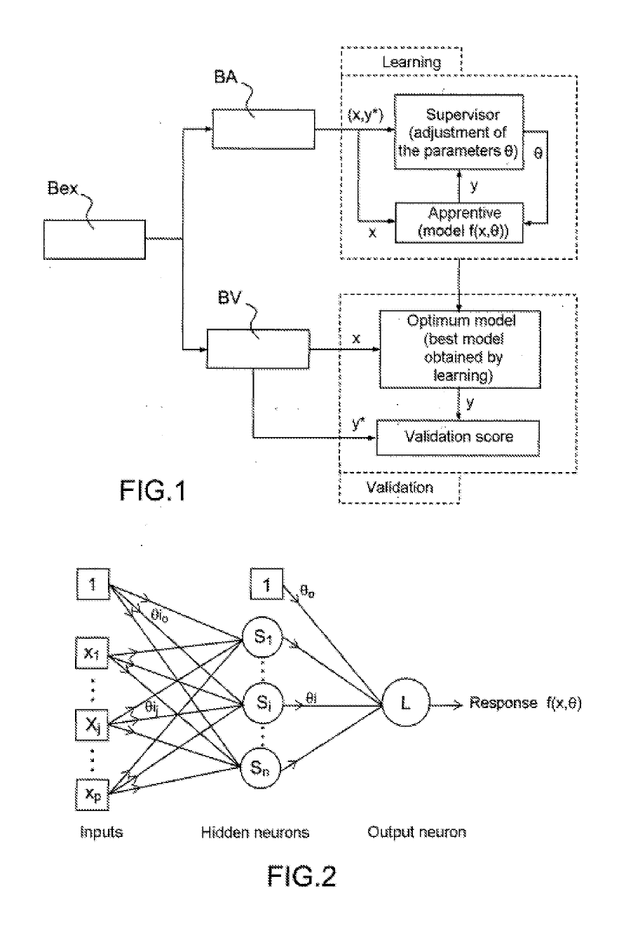

FIG. 1 illustrates a scheme which summarizes the interactions between the examples base Bex, the real results and the predictive results.

During the learning phase, the algorithm modifies the adjustable parameters θ of the model so that the estimation y is as close as possible to that of the proven result also called “supervisor” y*. The criterion which it is therefore desired to minimize by acting on the parameters θ is the deviation between the response of the model and the response of the supervisor on the cases available. This deviation can be obtained in various ways according to the problem treated and is called “cost function”:

Typically, the “cost function” which it is sought to minimize may be for example one of the following functions:
the cross-entropy score in the case of the discrimination (this is equivalent to estimating the attachment to a given class):

−[y*log(ƒ(x,θ))+(1−y*)log(1−ƒ(x,θ))];
the log likelihood criterion noted

log(P(y|x,θ))
and corresponding to the probability of obtaining y from the inputs x and the parameters θ;
the quadratic deviation in the case of the regression:

(ƒ(x,θ)−y*)².

The learning phase therefore consists in finding a set of parameters θ, for a function ƒᵢ of the family F of functions which minimizes the cost function over all the examples, with the aid of the optimization algorithms.

However, a model capable of predicting information that is already known is of little benefit. It is necessary to ensure that it is capable of correctly predicting cases that are not present but are represented in the learning base, and which follow the same laws as those that served for the learning. That is why the example base is generally split into a learning base BA, for adjusting the parameters of the model, and a validation base BV, also called validation base, for testing the model chosen and verifying its robustness.

The important thing for the two sets is to be as representative as possible of the total examples base on the one hand, and of the problem treated on the other hand. If the learning base is not, there is a risk of not correctly modeling the phenomena which is sought. If the validation base is not, there is a risk of the validation scores giving a false idea of the performances of the models, if the example base is not representative of the real cases, no practical application can be derived therefrom.

When sufficient data is available, the two sets (learning base and validation base) are constructed by randomly sampling the elements of the examples base. Thus, on the basis of N elements, a random selection is made of M which will be used for the training, and the remaining (N-M) will serve for the validation.

For the validation score not to be dependent on the particular sampling of a single partition of the total base into learning base and validation base, the procedure is repeated a number of times.

Accordingly, we are going to describe in greater detail the process proposed in the present invention.

In a first step, a family F of functions, the choice depending on the problem posed and the a priori knowledge thereof, is selected. Typically, in the context of the invention, the problem encountered falls in the category of problems of discrimination, that is to say that it is sought to classify new individuals into two groups: patients or controls.

In a second step, a type of function ƒᵢ belonging to the family F is chosen.

In a third step, an optimum model ƒᵢ(x,θ) is constructed by the learning procedure by adjusting the parameters θ.

This construction of a model is repeated with n−1 functions so as to test a sufficient type of functions ƒ₁, ƒ₂, . . . , ƒₙ, the respective qualities of their optimum models are compared.

In a fourth step, the function ƒᵢ is selected which leads to the optimum model having the best validation score, thus determining the so-called function ƒᵢ which “generalizes the best”.

In a fifth step, the parameters θ of the function selected in the preceding step are evaluated with all the examples of the learning base. The optimum model

ƒᵢₒₚ(x,θ)

is thus obtained which, from individual input data xᵢ will be able to provide the predictive result y.

Among the numerous families of functions available, the following families may notably be mentioned:

MLPs (Multi Layer Perceptrons), a subset of the family of networks of neurons,

logistic regression (subset of the family of MLPs);

Support Vector Machines (SVMs);

Relevance Vector Machines (RVMs);

frequentist models related to the nearest-neighbor method.

Most of these types of function are notably described in the reference manual “Réseaux de Neurones, Méthodologie et Applications” by G. Dreyfus et al., Eyrolles Publishing or in “Pattern Recognition and Machine Learning” by C. M. Bishop, Springer 2006. The Relevance Vector Machines are described in “Sparse Bayesian learning and the relevance vector machine”, Tipping, M. E. (2001), Journal of Machine Learning Research 1, 211-244.

The main contribution of the models previously described, compared with the models already used to evaluate risks, lies in the non-linearity of the statistical learning models. Indeed, the models generally used are said to be linear compared with the parameters, which induces a greater ease of implementation, generally at the cost of a lower predictive power. In the case of models described above, which are non-linear compared with the parameters, the implementation is more delicate but makes it possible:

to obtain, in general, better performances of the model;

to detect the synergies between input variables.

The possibility of exploiting the synergies between the input variables is an essential aspect of the inventive character of the subject of the present invention. It constitutes the main contribution of the collaboration of mathematicians in biological and medical discoveries in these studies. Indeed, the mathematical and statistical tools at the disposal of doctors and biologists generally do not make it possible to detect these synergies.

Furthermore, these algorithms have high learning capacities, it is very important to be able to measure their performances in order to verify that they do not overadjust to the training examples (the expression learning “by heart” or “overlearning” is then used). The methodologies for statistical learning make it possible, notably by virtue of the use of the validation examples, to solve this problem and to ensure that the model obtained represents a general phenomenon and not a particular case of training examples. This makes it possible to model phenomena for which little or no a priori knowledge is available.

According to the present invention, a model is prepared that is capable, from the explanatory variables obtained, for example, from variable-selecting methodologies described in the present invention, of predicting a response interpreted as a probability of being a patient or a control.

### It is Advisable, in a First Stage, to Choose a Family F of Model Functions:

The present problem falls in the category of problems of discrimination, that is to say that it is sought to classify new individuals into two groups: patients or controls.

Numerous families of functions are suited to the resolution of these problems. Some are very simple to carry out but do not make it possible to take into account the synergies between the variables. Now, it is not known a priori if such relationships exist or not. It is therefore advisable to choose a family of functions capable of taking account thereof if they exist.

A family that is simple to describe and generally effective is that of the Multi-Layer Perceptrons or MLPs. It is a type of network of neurons which is generally represented according to the scheme illustrated in FIG. 2.

The mathematical formula is of the following form:

$$f ( x , θ ) = L ( {θ}_{0} + {\sum }_{i = 1}^{n} {θ}_{i} {S}_{i} ( {θ}_{i 0} + {\sum }_{j = 1}^{p} {θ}_{ij} {x}_{j} ) )$$

Where L is the “Logistic” function, Sᵢ are functions of the “Sigmoid” type (such as for example the “hyperbolic tangents” function), n is the number of hidden neurons, p the number of input variables and et θ denotes the parameter vector consisting of the components θᵢ and θᵢⱼ or 1≦i≦n and 1≦j≦p. It should be noted that the mathematical object θ is different if it comprises one or two indices. θᵢⱼ denotes the element ij of the matrix θ (matrix of the parameters between the inputs and the hidden neurons) and θᵢ denotes the element i of the parameter vector between the hidden neurons and the output.

Given that the number m of variables is dictated by the problem treated, only the number n of hidden neurons may be chosen in the modeling phase. That is why the functions constituting the family of MLPs for the problem treated are differentiated solely by their number of “hidden neurons”, each of them representing in reality a sigmoid function. For example, the function representing the model obtained from a logistic regression, a modeling method that is well known in the medical field, belongs to this family. It is indeed a particular case of MLP having no hidden neuron. In this case, the model is linear relative to the parameters and the construction of the model then uses learning techniques different from those used in the context of the MLPs.

### In a Second Step, it is Advisable to Validate the Functions:

The higher the number of hidden neurons an MLP possesses, the more it is capable of modeling complex phenomena. It has indeed been demonstrated that any continuous function could be approximated by an MLP having sufficient hidden neurons.

However, in the present case, only the modeling of “general” behaviors is taken into account, and not the specific characteristic of the individuals as present in the database. It is therefore advisable to find an MLP with an optimum number of hidden neurons in order to construct the model that is as general as possible. For that, it is possible to decide a priori to test 5 MLPs, each having from 1 to 5 hidden neurons, and to construct for each an optimum model which will be evaluated on validation data. The MLP having the best power for generalization is then selected.

### In a Third Step, a Validation Method is Determined:

Taking into account the number of examples available, it is possible to carry out a simple random construction of the validation and training sets. However, as the data contain a lot of pointless information, it is not possible to be content with a single training/validation pair because there is a risk of constructing a model suited to a subproblem, and of validating it on something else. For that, the models are evaluated by a cross-validation procedure. The principle is the following:
1) The examples base is randomly separated into five subsets numbered from 1 to 5.
2) The subset 1 is taken as the validation set, and training set is constructed with the subset composed of the combination of the subsets 2 to 5.
3) Model number 1 is trained and its validation score number 1 is calculated.
4) The subset 2 is taken as the validation set, and the training set is constructed with the subsets 1, 3, 4 and 5.
5) The model number 2 is trained and its validation score number 2 is calculated.
6) The procedure is continued until each subset has been used in validation. There are therefore five validation scores. The final validation score is the mean of these five scores.

By virtue of this procedure, all the data are used to calculate the validation score, which makes it possible to avoid focusing on these particular cases.

### In a Fourth Step, the Choice of a Training Cost Function is Made:

The cost function used for the training is partly dictated by the problem posed (discrimination) and the family of function (MLP). In the present case, the cross-entropy may be advantageously used.

### In a Fifth Step, the Choice of the Validation Score Calculation Function is Made:

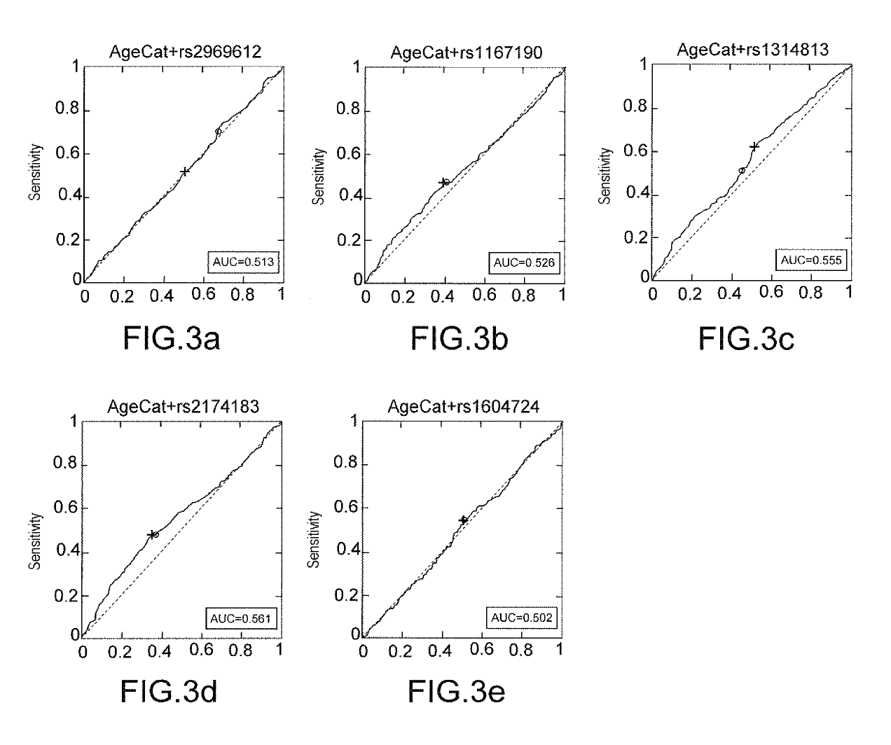

The validation score corresponds to a measurement of the evaluation of the quality of the model. This score may correspond to its good classification level, that is the sum of the number of patients and of controls correctly identified, divided by the total number of individuals in the validation base. This score is simple to calculate and easy to interpret and use, although it occults the performances class by class (it may indeed happen that one of the classes is better identified than the other). This score may also be the AUC (Area Under Curve), that is to say the area under the ROC (Receiver Operating Characteristic) curve as illustrated in FIGS. 3a, 3b, 3c, 3d and 3e.

These figures show how the discrimination performance in the vicinity of the SNP rs2174183 evolves, an ROC curve has thus been established by replacing it with the SNPs rs2969612, rs1167190, rs1314813 or rs1604724.

Having made all the preceding choices, the procedure for selecting the “ideal” MLP function may be launched. The one which makes it possible to obtain the best validation score is selected in order to construct the final model.

### In a Sixth Step, the Construction of the So-Called Optimum Final Model is Carried Out.

For the so-called optimum final model, that is to say the one which is effectively used to calculate the risk, a training procedure is launched on the identified “ideal” function. The training set used is this time the entire example base because no validation is necessary any longer.

According to a more elaborate variant of the invention, it is also possible, for various families of functions F, to produce an optimum model thus leading to the determination of a set of optimum models, intended to manage during use individual input data in order to provide a predictive result.

According to a more elaborate variant of the invention, it is also possible, for various families of functions F, to produce an optimum model resulting from a fusion of decision of other optimum models constructed from all or part of the input variables. This step, which leads to a more elaborate variant of the invention, falls within the scope of the seventh step described below.

### In a Seventh Step, a Fusion of Information of Optimum Models is Carried Out.

The objective of the fusion of information is to improve decision making in terms of robustness and reliability from the combination, via a mathematical operator, of the decisions or of the scores provided by the family of functions [I. Bloch. Fusion d'informations numériques: panorama méthodologique. Dans Journées Nationales de la Recherche en Robotique, Guidel, Morbihan, Octobre 2005]. These operators should take advantage of the complementarities between the various functions at the start of the fusion but also take into consideration their irrelevance. The fusion operators are numerous [Ludmila I. Kuncheva, James C. Bezdek, and Robert P. W. Duin. Decision templates for multiple classifier fusion: an experimental comparison. Pattern Recognition, 34:299-314, 2001] and may be based on various mathematical formalisms such as the theory of probabilities, the theory of belief functions or fuzzy measurements [G. J. Klir and M. J. Wierman. Uncertainty-based information. Elements of generalized information theory, 2nd edition. Studies in fuzzyness and soft computing. Physica-Verlag, 1999].

Statistical or automated learning algorithms may moreover be used for a parametric fusion but they generally require more information a priori for the estimation of the fusion operator.

Regardless of the formalism used, the fusion operators may take the form of a table of rules of combination of the “logical AND/OR” type, of a product of scores with or without a priori which may be conditional or not as in the case of the fusion based on the generalized or non-generalized Bayes theorem [Ph. Smets. Beliefs functions: The Disjunctive Rule of Combination and the Generalized Bayesian Theorem. Int. Jour. of Approximate Reasoning, 9:1-35, 1993], of distances to models predefined by learning or expertise, of weighted sums with or without taking into account the interactions between the inputs of the fusion.

The explanatory power and the interpretation of the results, which are important criteria for the medical and industrial applications, are generally a lot easier via the use of specific fusion operators instead of statistical or automated learning algorithms.

Accordingly and according to the invention, when the method of prediction has been constructed, it is possible to provide the user, typically the doctor or any other entity of the laboratory type, with a tool that helps in decision making that is at the same time impartial, reliable and allows a personalized use at different stages of the patient's progress, thereby making it possible, with a single tool, to perform hierarchical predictions, comprising inputs of the clinical data or genetic data type, the said tool providing at the output such as evaluation of a risk or degree of progression of the disease detected.

With such a tool, it becomes possible to perform an early and non-invasive identification of the risk of developing a prostate cancer with evaluation of the seriousness (including of cancer as a function of occupational exposure to carcinogens, the genetic variants determining sensitivity to these agents to a greater or lesser degree).

It is also possible to evaluate the risk of recurrence of the cancers according to the treatment, including the validation of clinical trials for the pharmaceutical industry, in the form of an activity of a “data search” or biostatistical department.

It is also possible to evaluate the risks of complication of the radiotherapy or curietherapy (or of exposure to ionizing radiation in general), the risks for other urological pathologies (benign prostatic hypertrophy, urinary incontinence).

Working on the genotype of patients makes it possible to access elements which may be highly crucial in the appearance of a pathology and easy to collect. A simple collection of saliva sample indeed makes it possible to easily work on invariant constitutional DNA. The genetic material is informative because it is capable, by identification of the genetic profile, of determining the risk of developing the disease but also the risk of it being aggressive.

### Example of Application Introduced by the Practitioner:

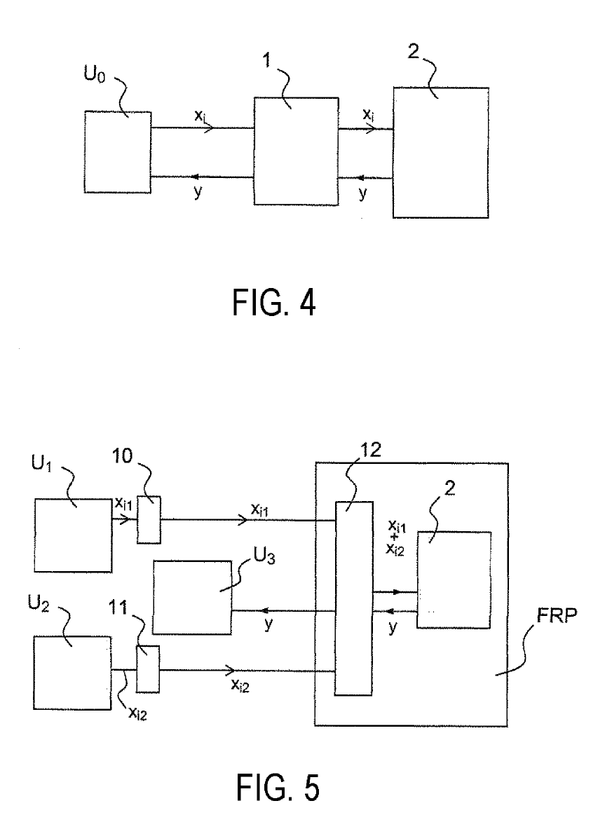

According to one example of use, the application is introduced by the practitioner who acquires information which they have for a patient, such as for example the blood level of total PSA or of free PSA, the age, the weight, the height, the family and personal history, the results of examinations of the rectal touch type and the genotypes of interest. They select the relevant questions and the application interrogates the statistical model or the various statistical models at their disposal. The tool gives personalized and hierarchical response with, for example, for prostate cancer, the risk of developing an aggressive cancer at a given age, the risk of developing metastases or a recurrence of the tumor after initial treatment (at a given age). FIG. 4 illustrates such a configuration in which the individual data xᵢ are acquired by a user U₀ by means of first means at the level of an interface 1, the said interface providing the link with the software 2 using the method of the invention. The predictive information y is restored at the level of the interface to the user U₀, in this case the practitioner.

### Example of Installation Introduced by a Professional Providing Results.

In this case, the information of the clinical type is sent by a patient or by a practitioner to the professional provider of results via communication networks which may be of the internet type.

In parallel, information obtained from samples of the blood and/or saliva type analyzed in a laboratory are also sent to the predictive result professional, the entire information is processed by the model(s) previously produced so as to give a predictive result, the said result being sent back to a health professional who is thus able to inform the patient thereof.

FIG. 5 schematically represents this type of configuration. A first user U₁ acquires a number of individual data x₁ᵢ which may be of the clinical data type at the level of a first interface 10 and sends them via a distant link of the internet type for example to a professional provider of results FRP who has introduced the prediction software 2.

In parallel, a second user, which may be an analytical laboratory, sends another stream of information obtained from blood or salivary samples x₂ᵢ and acquired at the level of a second interface 11 and also sent to the provider FRP via a distant link. After processing all the data received via an interface 12 introduced by the provider FRP, the latter sends the result y to a third user U₃ authorized to inform the patient in question. Typically, when the user U₁ is the practitioner, there may only be two users U₁ and U₂. On the other hand, if the patient has the possibility of directly sending the information to the professional FRP, the result y cannot be directly sent to them by FRP.

The professional provider of results can at any time enrich their databases of examples by new cases treated so as to provide more efficient predictive results.

For submitting cases remotely, provision is made for protecting the personal data of each patient, compatible with the security and ethical rules in use.

We are going to describe below examples of combinations of input data or variables which are particularly suited to the calculation of the risk of onset of prostate cancer.

A first variable is called “family history of prostate cancer”, the values for this variable make it possible to define the family context for the onset of prostate cancer of the patient. The values attributed to each individual depend on the age and/or the degree of relationship and/or the number of cases of onset of prostate cancer in their family.

A second variable is called “family history of breast cancer”, the values for this variable make it possible to define the family context for the onset of breast cancer of a patient. The values attributed to each individual depend on the age and/or the degree of relationship and/or the number of cases of onset of breast cancer in their family.

A third variable is called “personal history of cancer”, it makes it possible to distinguish between the patients who have already had a cancer, regardless of its type.

A fourth variable is called “family history of other cancers”, the values for this variable define the family context for the onset of cancer (other than breast or prostate cancer) and depend on the age and/or the degree of relationship and/or the number of cases of onset of other forms of cancer for a given patient.

A fifth variable is the age encoded in the form of categories of ages.

These variables can be used in combination or alone as input variables of relevant algorithms in order to obtain a calculation of the risk of onset of prostate cancer or to determine the predisposition to prostate cancer.

The predictive value of these variables is reinforced by their use in combination with markers of individual biological variability such as for example single genetic polymorphisms also called SNPs (Single Nucleotide Polymorphisms). An essential property of genetic markers, to which SNPs belong, is their capacity to be transmitted in linkage disequilibrium with markers in their vicinity defined in terms of chromosomal location. The expression genetic distance between two markers or SNP is used. It is considered that two markers are thus genetically linked when the frequency of recombinations between them is rare. The existence of these genetic linkages is responsible for the fact that the SNPs in the vicinity of an SNP of interest are capable of providing the same information or part of the information on a predisposition character. Since for each SNP the relevance of various SNPs present in its vicinity is available, it is possible to obtain for each SNP of great interest the list of neighboring SNPs which can provide information on the predisposition to prostate cancer. The definition of such an interval is of great interest from a practical point of view since it makes it possible to choose markers which provide relevant information among a list according to practical criteria of commercial availability of reagents and experimental criteria for example.

The usual technique for choosing how to delimit intervals would be to calculate the linkage disequilibrium between an SNP and its neighbors, but it is not this notion that has been retained. These intervals have been delimited by correlation calculations actually based on the observation of an effect. The limit given is that beyond which an effect is no longer observed.

In the present application, mention is made of the use of an SNP of interest and/or of one or more of its neighbors. Indeed, each of the SNPs genetically linked to the SNP of interest is capable of providing all or part of the information provided by the SNP of interest. The genetic linkage depends on the physical distance between two genetic elements (in general expressed as nucleotides) and on the frequency of the recombinations between these two elements. The SNP of interest may itself be the causal agent of the predisposition which it is sought to predict, it may also simply be genetically linked to it. Through a transitivity effect, an SNP genetically linked to the SNP of interest will also be able to be genetically linked to the causal predisposition factor. This possibility explains the need to introduce a first “or”. The “and” is also derived from the property given by the genetic linkages. If the predisposition factor is positioned between two genetically linked SNPs, the fact that the alleles present for each SNP are recognized in an individual makes it possible to complete the information on the probability of presence of the causal agent of a predisposition. All these properties seemed to us to be best represented by the wording used in the claims.

Because the nucleotide position systems of reference are changeable, as much precision as possible has been given to the description of the SNPs of interest in the list which follows.

SNPs are currently the genetic markers most widely used, but it is obvious that each SNP can be replaced with a molecular biology marker of any nature so long as the physical or statistical link is obvious for those skilled in the art; the interchangeability of the variables is mathematically very simple to verify provided that there is information on the new variable for a sufficient number of individuals.

### List of the SNPs Linked to a Predisposition to Prostate Cancer and Corresponding Chromosomal Intervals:

SNP rs2174183 located in 4q28.1 on chromosome 4 between the positions 127907634-127908134 according to the location determined by the UCSC genome browser, assembly of March 2006.

Genomic Sequence in the Vicinity of rs2174183: Polymorphic Nucleotide in Bold.

Seq. Id. No. 1
ACCAAATTGTTGCTACCAATCAGTCAATCCTAGGCACATTTACCTTCC
CAGTTGAACAATCAATTATTTACACTTCCTACTTCACTGTATCTTTAG
ATTATCAATATTTTCTTCAATCTTTTAGTTATTTAATGTCATATGACT
ACCCTCAATAATAGTATATATGAATGTTTGTTTTGGTGATGGGAGGTC
AATCAGAT(G/T)GTTCCAGATAACCACTGCCTTCCTACCTTGCCTAA
ATAGGTATTTCACATATTCTTTCCCTTAAAAACTGACATAggtcaggc
acggtggctgacgcctgtaatcccagcactttgggaggccgaggcagg
tggatcacttgaggtcgggagtttgagaccagcccgaccaacatggag
aaaccccgtctctactaaaaatacaaaattagccaggtgtggtggcac
atgcctgtaatcccagctactggggaggctgagacaggagaattgctt
gaactcaggaggcagaggttgcagtgagccaagatcaagccattgcac
tcaagcttgggcaacaagagcaaaactccatctcaagaaacaaaaaaa
aaacaagacaaaaCCAAAAGAACCTGACATAGTTGTTTATCTGCTGAG
AGTACAAGTTATTGTGATAACAAATGGCATTGCAATTGGTCATCCTTT
TCTAATGGTATATTTGCATTTTAATAACTGTATTGAAAAACT

The SNPs in the vicinity of the SNP rs2174183 which can provide information on the predisposition to prostate cancer are defined in a database according to the following table and are positioned in the interval 127602673-128447913 of chromosome 4 or between the SNPs rs12651126 and rs13122922 on chromosome 4:

| | | distance | |
|---|---|---|---|
| | | (bp) to | location UCSC |
| | | the principal | genome browser |
| SNP | Chromosome | SNP | assembly March 2006 |
| rs12651126 | 4 | −304961 | chr4: 127602673-127603173 |
| rs2969612 | 4 | −41669 | chr4: 127865965-127866465 |
| rs1167190 | 4 | −32365 | chr4: 127875269-127875769 |
| rs13148138 | 4 | −10633 | chr4: 127897001-127897501 |
| rs2174183 | 4 | 0 | chr4: 127907634-127908134 |
| rs1604724 | 4 | 21908 | chr4: 127929542-127930042 |
| rs13122922 | 4 | 539779 | chr4: 128447413-128447913 |

The relevance of the associated SNPs and of the SNP of interest for discriminating between patients suffering from prostate cancers and controls may be demonstrated by establishing ROC curves (corresponding to a variable relating to the sensitivity to a test also called “Receiver Operating Characteristic”) as illustrated in FIG. 5 which show the performances of algorithms of the Multi-Layer Perceptron type in relation to discriminating between patients suffering from prostate cancers and the controls using, as input variables, the age category and the genotype associated with the SNP rs2174183 or with its neighbors. The intermediate SNPs not mentioned are therefore capable of carrying information. The corresponding AUC(s) (Area Under Curve, here ROC curve) are capable of being reinforced by the use of the history variables at entry.

SNP rs7576160 located in 2p22.2 on chromosome 2 between positions 37957978-37958478 according to the location determined by the UCSC genome browser, assembly of March 2006.

Genome Sequence in the Vicinity of rs7576160: Polymorphic Nucleotide in Bold.

Seq. Id. No. 2
GTCAGATATATGTGAGTTTTTTGTCAACTAAATTCATAGTTGTCTTAATATTCATCCCTTGCTAAAAT
TAAGGTGCAGAAATAAAATCTGTCTAATAGAGAAATATAAATCCATCTTTTGTCTGGATAATCAAATTTTACTAT
ATTTTGTTTTAATCCTGAGAATGAAATTTTACAAATAGCTCAGGAGGTTTTCCCTAGAGTTCCAAATAAAAGTGT
GTGGATCATATACACGTTCTGCTTAATCACATGACGGTTCCAAATTTTTAATTTCAATCCTTCATTACGATGAAA
ATTTTTG(C/T)GTTTTTTTTCCACCAGCTCTTTGTTTTGTTTTTCAATGGCTCAGGAAAGGAGAGGGGTGTGGG
AGACTCTGTCTCTTTTGACAATCACCAGCGCCATCTACTGTCAAGAAATAAAATCGTGACTCATTGTTAACGCGT
CAATGAACATTAGGGCTTAAAGAGGGAAAGACAATTTTATACCCCAGTACTTACTGATAAATATAAGTTCATGTA
CACATATTTTTATCTTATATTATTGTATTCTTAAGCAGCCTATAGGGAGAATACAATGAACTTAATATATAATCA
TTTATGTAATTC

The SNPs in the vicinity of the SNP rs7576160 which can provide information on the predisposition to prostate cancer are defined in our database according to the following table and are positioned in the interval 37855761-38126567 of chromosome 2 or between the SNPs rs7562836 and rs17021897 of chromosome 2.

| | | distance | location |
|---|---|---|---|
| | | (bp) to the | UCSC genome browser |
| SNP | chromosome | principal SNP | assembly March 2006 |
| rs7562836 | 2 | −102217 | chr2: 37855761-37856261 |
| rs4670780 | 2 | −56053 | chr2: 37901925-37902425 |
| rs4670222 | 2 | −50101 | chr2: 37907877-37908377 |
| rs10206788 | 2 | −48321 | chr2: 37909657-37910157 |
| rs7598641 | 2 | −38008 | chr2: 37919970-37920470 |
| rs9967771 | 2 | −12100 | chr2: 37945878-37946378 |
| rs879321 | 2 | −3587 | chr2: 37954391-37954891 |
| rs2565640 | 2 | −3285 | chr2: 37954693-37955193 |
| rs2278320 | 2 | −414 | chr2: 37957564-37958064 |
| rs7576160 | 2 | 0 | chr2: 37957978-37958478 |
| rs2707223 | 2 | 5806 | chr2: 37963784-37964284 |
| rs4670788 | 2 | 7502 | chr2: 37965480-37965980 |
| rs17021897 | 2 | 168089 | chr2: 38126067-38126567 |

SNP rs2012385 located in 2q38.1 on chromosome 2 between positions 242070828 and 242071328 according to the location determined by the UCSC genome browser, assembly of March 2006.

Genome Sequence in the Vicinity of rs2012385: Polymorphic Nucleotide in Bold.

Seq. Id. No. 3
CTGGCGGATGCACTAGCCGGGCTGAGGGTCAGGAATAGCCTTGTGGCCGCTTGTGCTCCTCTGGCTCCT
CCCAATGAGGGTCCTCTAGTGGAGCCTCCCAATGGGGCTCCTCTACCCTCAGCAGTGCCCTTGGTCACCAGGTCC
TGTCTTGGTGCCAACAAATTCAGTTCTCAAACCATCTACTGAGCACCTGCTCTGGGCTAGGAGCCCTGGAGCCCT
GATACAACCAAGAGGTAGAGCCCGGAGTATTGTTCTTGCTGAGGAGAAGCTTCTGGAAGGTTCAGCCACAAAGAT
GTCATCTGAGATCAGCTTTGAAAACATTGGACAGGAGCAGGTTCGAGAATGGGAGGAGGAAAGGAGGGTTCTCCT
AAGTATTCAAATTAGCACCAGGAGCAGGTTCGAGAATGGGAGGAGGAAAGGAGGGTTCTCC(C/T)GAGTATTCA
AATTAGCACCAAGAGCAGGTTCGAGAATGGGAGGAGGAAAGGAGGGTTCTCCTAAGTATTCAAATTAGCACCACC
TCGTCCACCACAGGGCGTTAGATAAGAAAAAAGAATCCTGCCAGTATCAGACACCTGCGCAGATAGGGTAAGCGA
GAGTCCTGGGAGCCCCTCAGATTCCTAACCTGGACTGCTCTGGAGCCCTTCCACCATCTGTTCCTTTCAGACAAC
AGGAGGAGCAGCAGGTGTCCGGAGAATGTGCTAGGGGCCTCCTAGTATGAGCAGTCCCACATACTGCGTGAGCAG
AAGGAGGAGCCACTCACGAATATCCTCACAGAACGCAGATGAAAAACAAGCCAAACAGAAACGTCACCCACACAT
GAAGAAGGTGGTCATATGGATG

The SNPs in the vicinity of the SNP rs2012385 which can provide information on the predisposition to prostate cancer are defined in our database according to the following table and are positioned in the interval 241767109-242119399 of chromosome 2 or between the SNP rs1540528 and rs7567892 of chromosome 2.

| | | | location UCSC |
|---|---|---|---|
| | | distance (bp) to the | genome browser |
| SNP | chromosome | principal SNP | assembly March 2006 |
| rs1540528 | 2 | −303719 | 241767109-241767609 |
| rs16843438 | 2 | −284703 | 241786125-241786625 |
| rs2074840 | 2 | −280686 | 241790142-241790642 |
| rs2055566 | 2 | −71468 | 241999360-241999860 |
| rs2012385 | 2 | 0 | 242070828-242071328 |
| rs7567892 | 2 | 48071 | 242118899-242119399 |

SNP rs2190453 located in 11p15.1 on chromosome 11 between the positions 17489723-17490223 according to the location determined by the UCSC genome browser, assembly of March 2006.

Genomic Sequence in the Vicinity of rs2190453: Polymorphic Nucleotide in Bold

Seq. Id. No. 4
AGCCGCAGACCATACTCTAAGTAGCCTCAGAGCCACACCTGAGATGGAGAGGCCCAGCCTTAGACTCT
GGTGGGGTAGAGTGAAGAGGACAGACTCAAATCTCTAAGCCAGGTGTATCAAAGGCTAACCTGAGACCTACCATC
TGGTCAGAAAGGCTAACCTCAGACTCACACCCCCCGACCAAGGAGGCTAGTTTCAATTCCAAAGCCAGGAGCAAG
ACTCACACCCCCAAGCAAGGAGATTAGTTTCAATTCCTAAGCCAGGAGCTAACCTCAGATGGCCCTGGGCAGGTG
GCATGATCTCTCTCTCCAGGCTGGGGAGCAGGAAAGGGCTCACTCCACCCTTGTATGCCATTTGAGGAGAACAAC
TCCAGCTGGTCCTCTGGGAGCACATGGAGAAC(A/G)ACCACATTGTGTCCCAGGGTTGCTTGCCTGGCCTGCAG
GCAGGACACATACCTCCTGGGCCAGCCGGTTGATCTTTAGCTGCTTTTCCTTCTCCAGCATTTCCTCTTTCTCTT
TGTAAAGCTTTTGCTCAAACTCCAGTTCTTTCTTATTCTTTCTCAAGTCCTGCAGGCTGCCATACTTGGCTTTCT
TCTTATCTTTTCCTTTCTGAGTAGATGTGGCATTGTTTATATGACAAAGGTTAGAAATAGTGTCGACAGCACAGC
ACACGGGGCATCCAGTCCTCACATAACACAACCATCCCATGGTGAGCCCCTCCCCCAGCTCTCTCACCACTCTGG
ACATCAGACCTCAGGTTTAGGACAGGAAGGCCACTGCTACCTACTGCAGAGTGGGAGACACA

The SNPs in the vicinity of the SNP rs2190453 which can provide information on the predisposition to prostate cancer are defined in our database according to the following table and are positioned in the interval 17464539-17757162 of chromosome 11 or between the SNP rs12278956 and rs1003921 of chromosome 11.

| | | | location UCSC |
|---|---|---|---|
| | | distance (bp) to the | genome browser |
| SNP | chromosome | principal SNP | assembly March 2006 |
| rs12278956 | 11 | −25184 | 17464539-17465039 |
| rs1006099 | 11 | −2934 | 17486789-17487289 |
| rs2190453 | 11 | 0 | 17489723-17490223 |
| rs2190454 | 11 | 238 | 17489961-17490461 |
| rs7119071 | 11 | 39005 | 17528728-17529228 |
| rs1003921 | 11 | 266939 | 17756662-17757162 |

SNP rs888298 located in 17q24.2 on chromosome 17 between positions 63955680 to 63956180 according to the location determined by the UCSC genome browser, assembly of March 2006.

Genomic Sequence in the Vicinity of rs888298: Polymorphic Nucleotide in Bold.

Seq. Id. No. 5
CTTAGAAAAAAGGGATTTGGggccaggtgcggtggctcacacctgtaatccctgcactttgggaggcc
gaggtgggtggatcacgaggtcaggagatcgagaacatcctggctaacatggtgaaaccccatctctactaaaaa
tacaaaaacattagccgggcgtggtggcaggtgcttgtagtcccagctacttgggagggtgaggcaggagaattg
cttgaacacgggaggtagaggttgtggtgagctgagactgcactccagcctgggcaacagagtgagactctatct
caaaaaaaaaaaaaaaaaaaaaagataaaaGGGATTTTGGATCCTTATAACACCTTATCCAAATCTTTAACTTTT
TCCTGTTTTTCAAAAAAGAAACTGTGCTGTCTGAAGGCCTGAGGAAGTAGCAGACTGAGTGCTACAGAATAGAAC
AGGACACACTCCCCTTGGGCCTTTATCATTTCCCCAGAGTGGGCAGTCCTCCCGGACACC(A/G)CAGAATCCCT
ACCTGGCAAGAGAGGCTGCAGCAGCTGAGTTGCTTAAACCAAAATTTAAGTCCCAAACCTGAAAGTTTTAAGAAA
AGCAAACCCCCAATACTTCCCAGACCTGTTTCAAATCATTCTTGTCGGAGAAGAAATGTAAAGGAAGGGAGAACT
CTTAGATATTGGTTCCAATGAACCGATGCTCATCTTGGTT

The SNPs in the vicinity of the SNP rs888298 which can provide information on the predisposition to prostate cancer are defined in our database according to the following table and are positioned in the interval 63815611-64165896 of chromosome 17:

| | | distance | location |
|---|---|---|---|
| | | (bp) to the | UCSC genome browser |
| SNP | chromosome | principal SNP | assembly March 2006 |
| rs7211107 | 17 | −140069 | chr17: 63815611-63816111 |
| rs888298 | 17 | 0 | chr17: 63955680-63956180 |
| rs887281 | 17 | 209716 | chr17: 64165396-64165896 |

SNP rs8110935 located in 19q13.43 on chromosome 19 between positions 62239851-62240351 according to the location determined by the UCSC genome browser, assembly of March 2006.

Genomic Sequence in the Vicinity of rs8110935: Polymorphic Nucleotide in Bold.

Seq. Id. No. 6
TTTAAAAACAATTTTTTGTTCTCCTGGTAACTGTGGTTCTCCATTCATCCCAGTGTGTTCCCTGAAAG
CAGAGATCcttctccaaattcatgttgaagtcctaaaccccagtacctcagaatgagattgtattttgagatggg
cctttacagaggtaattaaggttaaatgatattatcagggtaggccctaatccaatatggctggtgtccttatag
aagaggagattaggacacagacacacacagggggatgaccacgtgaggagaggagggaagacggccaaatacgag
ccaagcagagacaccttagcagaaaccaaccctgcccacaccttgatgttgacctgcagcctccagaactgtgaa
aattttctgttacatgagccacccagtctgtggtactttattatggctgccagagcagactaagacaGTCACCCA
TTTAAGGGGAAAAAAAAGGAAGTTCAGGTTGAAGAAACAGGAAACATTCTGAAAACATGCATATAATCAACAAGA
AAACAAAGAATTATTTAGCATATTAGAAATGGAAAAAAAGTccgggcgcgatggctcatgcaggtaatcccagca
cttogggaggctgaggcaggcagatcacctgaggtcaggagttcgagaccagcctggccaatatggtg(A/C)at
ccccgtctagaatatgaagcaggcagaagaacgtgaaaaactagactggcttagcctcccagcccacatctttct
cccatgctggatgctccctgccattaaacatcagactccaagttcttcagttttgggactcggactggctctcct
tgctcctcagcttgcagatggcctattgtgggaccttgtgatcatgtgagttaatatttaataaactccctaata
tatcctatcagttctgtccctctagagaacactgactaatacaCCCAGACTTGCAGAATCACCCTCACCTTCAAC
ACCAGCATTCTGGCCTGGGGGCTGGACATGCAGGCTGGCCTGTTCCTTTGCAATCATCCCAGCATCACAGAGGCC
ACTGTGGCTGCATGGACCTATCACTCCTGACCTGTTGTTACTCCCTCTCCTCATCTTCCCTGTCCTGCCCCTTGA
GACggctccacttcctgaactccccaaatccaacttccacattccatcttcattgctaacaccctggaccagggc
actgagatctctaccctacaagaccacggcaccctcctcatggggctccccacctccacaccaggccctgggtcc
tccaccttcccaacaggagccagagggagagctttaagtcataaaacagatgatgttgcctctccttgccattcg
gacttacaactttccagtggcctccaatgaacctacaatgaaatccaaaatccCCAGCATAAGAGTAT

The SNPs in the vicinity of the SNP rs8110935 which can provide information on the predisposition to prostate cancer are defined in our database according to the following table and are positioned in the interval 62026584-62294837 of chromosome 19 or between the SNP rs1860565 and rs1565944 of chromosome 19.

| | | distance | location |
|---|---|---|---|
| | | (bp) to the | UCSC genome browser |
| SNP | chromosome | principal SNP | assembly March 2006 |
| rs1860565 | 19 | −213267 | chr19: 62026584-62027084 |
| rs8110935 | 19 | 0 | chr19: 62239851-62240351 |
| rs1565944 | 19 | 54486 | chr19: 62294337-62294837 |

SNP rs2788140 located in 1q32.3 on chromosome 1 between positions 210171227-210171727 according to the location determined by the UCSC genome browser, assembly of March 2006.

Genome Sequence in the Vicinity of rs2788140: Polymorphic Nucleotide in Bold.

Seq. Id. No. 7
CCAATACAGTGCACATTCTTCAATATATCATTGAAGATCCTCCACAATTAGACACAGGCCTAGCAGCC
AGACCTCTCttttctttttttttttttgagacggagtctcgctctgtcgcccaggctggagtgcagtggcgcagt
ctcggctcaccgcaagctccgcctcccgggttcatgccattctcctgcctcagcctcccgagtagctgggactac
aggcgcctgccaccacgcccggctaattttttgtatttttagtagagacggggtttcaccgtgttagccaggatg
gtctcgatctcctgacctcgtgatctgcccgcctcggcctcccaaagtgctgggattacaggcgtgagccactgc
acccggccCAGACCTCTCTTTTCTACGGCCCTCTGTGTGTATCCCAGCCCGCAGTAAAACTGGCACCCTGGGCAT
TCCATGAGCTCAGTTTGCACTATCTTACCTTTGTGGCTTTGCTCATATTTTCCCTCT(A/G)TCTGAACACTCTT
CCCTCCATCCGTGAAAAACCTGTTCGTCCTTCCATGTCCTGATTTCTAGCCAGACACAATACTCAGTATTCCTCC
ATAGCCCGTATCCCAATCCATCTGTGTGAAGCAGTCTAGCTGCATGGCCCTGGGGTCGGAGGCACTGTAGACAAA
TGGAGGCTAATGTTACCATGTCCTGCCAGGAGCAGCCAGCTCCCTCCACTGCCCCATGCCTCCCATCAGCTCCCT
GGCTATT

The SNPs in the vicinity of the SNP rs2788140 which can provide information on the predisposition to prostate cancer are defined in our database according to the following table and are positioned in the interval 210157195-210446272 of chromosome 1 or between the SNPs rs12135924 and rs7546833 of chromosome 1.

| | | distance | |
|---|---|---|---|
| | | (bp) to the | location UCSC |
| | | principal | genome browser |
| SNP | chromosome | SNP | assembly March 2006 |
| rs12135924 | 1 | −14032 | chr1: 210157195-210157695 |
| rs2788140 | 1 | 0 | chr1: 210171227-210171727 |
| rs7546833 | 1 | 274545 | chr1: 210445772-210446272 |

SNP rs7934514 located in 11q22.1 on chromosome 11 between positions 99214118-99214618 according to the location determined by the UCSC genome browser, assembly of March 2006.

Genomic Sequence in the Vicinity of rs7934514: Polymorphic Nucleotide in Bold.

Seq. Id. No. 8
GTAACCAAGCTAAGACTGGATATAGATCCCACAGATATTTTTGGAAATGATGCCTGAAATGAATCGTTCTTCTTC
CAGTTCTGAAAGCTTATGGCCCTATGATAGCATAAAAATCAAACATCTATCAAGTATTTTTATTTTCTCCAGTAT
CACTCTTTGTAAATGATACTTCTATCTCTTATTTTTTGTTTTTTCATCttttatttttaaaataattttCT(C/T)
ACAATTAATATAGGGAGAGGAAAAATGGTTtattagttacctattcctatatttaaaaaatcctcaaaacttag
caatttaaaacaacaatcaagcattttctcttcaagtctgaaatctgagtaccttagctgggaggttctggctct
aggtctttcatgaggctgcagtcatgctgtcagttatagctccattctcatttgaaaactttacaaagggaggat
ccacttaacaattcacctatgtgattgttgttaggcctcagtttcttgctgccttttggccaagccaggtatttc
agttccttaccatgtcggcctctccacagcctgaaaaaatttcctttggatatgcaatggtcttcttcttgaggg
agtgacccacgaggaaagtgtaccccagaaggaagttgcattacttagtattagaagtaatatagtatgcctttt
gcttttagctagaaataagtcattaagtcaagctgacactcacggggaaagaaattaagctcaactccttgaagg
gagggttatcaaaaaagttgtggacatatcttttaaactaACCCAAGTAGGTTTGGAAAAATTCTTCACAAGTAG
GTTTGGAAAAATTCTTCACAAGTTAATTGGTCTAAAGATGATATAAAAGGCATGTTTACTTTATATCATTATTTT
GAAATACAATTAAAACAAACAAGATTAAAAAGGAGGCATGAAAAGGTTACTTTCATTGAA

The SNPs in the vicinity of the SNP rs7934514 which can provide information on the predisposition to prostate cancer are defined in our data base according to the following table are positioned between the interval 99092040-99333419 of chromosome 11 or between the SNPs rs605559 and rs12574821 of chromosome 11.

| | | distance | location |
|---|---|---|---|
| | | (bp) to the | UCSC genome browser |
| SNP | chromosome | principal SNP | assembly March 2006 |
| rs605559 | 11 | −122078 | chr11: 99092040-99092540 |
| rs1441381 | 11 | −88366 | chr11: 99125752-99126252 |
| rs10750395 | 11 | −78780 | chr11: 99135338-99135838 |
| rs2583150 | 11 | −58325 | chr11: 99155793-99156293 |
| rs7934514 | 11 | 0 | chr11: 99214118-99214618 |
| rs12574821 | 11 | 118801 | chr11: 99332919-99333419 |

SNP rs3828054 located in 1q21.3 on chromosome 1 between positions 149779269-149779769 according to the location determined by the UCSC genome browser, assembly of March 2006.

Genomic Sequence in the Vicinity of rs3828054: Polymorphic Nucleotide in Bold.

Seq. Id. No. 9
TGAGACCCGCGGCCCAAGCACGGGCTCGCCGGCGCCGAGTCCCAGGCAGGAGCCGCAGTGTCCTACCAA
AGGGCAGGGACGCCCCGAACCCTCCAGCCTCAAAGGAGTCTTCACCCCGCGACTCCCACTGCCCGTCGCAGGCAA
AAGAATAAAAAGAGAGAAGCGCCGCGCAGGGCTGACCGCGCGAGCCGGGCACCAGGTGATGTCAGCCAACACGGC
GCGGGGCACGGAAGGGGCGGACTTAGAAACCGGGAATACAAAACGGAGAAGACAGCGAGAGCGCTTTTTCTTACC
GCCGCC(C/T)GGTCCTCTGGGTGCACGTCCACCAGGGTACACCAGTTCCGCGTCCCGTTCATCTTCCCTCGGGG
TCGCAGCACACACGCCACTTGTCCACCCCGCTGTCTGGCTCCAACTGGGCGGGCGCGCGCGGAACCGCCCCCTTG
TATAGGCCCATCAGGGGCGGGGCTGAAGATAGGCCGCGCCCCCAGTTCGCGGTTTCGCAGAGAACTAACGATAGG
CGAGGAGGTGAGGTGGGCGGAGCCAATGGGTCTGGGACATGCCCCATCGGTGCTCGCATAGATTTACACAAAGGT
GGGGCTTGGGA

The SNPs in the vicinity of the SNP rs3828054 which can provide information on the predisposition to prostate cancer are defined in our database according to the following table and are positioned in the interval 149382371-149874970 of chromosome 1 or between the SNPs rs11807526 and rs6702842 of chromosome 1.

| | | distance | |
|---|---|---|---|
| | | (bp) to the | location UCSC |
| | | principal | genome browser |
| SNP | chromosome | SNP | assembly March 2006 |
| rs11807526 | 1 | −396898 | chr1: 149382371-149382871 |
| rs3828054 | 1 | 0 | chr1: 149779269-149779769 |
| rs6702842 | 1 | 95201 | chr1: 149874470-149874970 |

SNP rs1499955 located in 3q13.31 on chromosome 3 between positions 116719413-116719913 according to the location determined by the UCSC genome browser, assembly of March 2006.

Genomic Sequence in the Vicinity of rs1499955: Polymorphic Nucleotide in Bold.

Seq. Id. No. 10
CCTCTATTACAGATGTCTAGAATAACAAGCAAATTTAACCACTATCACCTACGGCACAAACTTGCAAA
AGCTGTCCACACCATTTTTTCTTTCTTGCTTGCTTTAATTGTCAGGCTGCCCATTCCTCCCACTTCTGTTCTATT
TTCTTAAAGCACAACGAGTTCCTAGTTGATAGTATGGTGGAGAAGAGTAGAAACAGCATGGTCTATTTATTTTAT
TTTTAATTCACCTAGTATTCACAAATAAGAAACGGGTATTTGTAGAAAAAATATATCATATATAAAAAGTAGATA
AGTCCCA(G/T)GCAGGCCATTTTTTAGCTGATATTTACTTATTGCAGATTCATACAAGGGTTAAATTAGATAAA
ACACTTTGCGTGCTGCTAATAAACAATATAAATGTAAAAATACAATTCTGTTAGACGTTAAAGTACAAATGGAAT
AGTATTTACATTTCAAAGGAACTTTGGGTTCAGTCAGCCTTTATAGGTATAAGAAATGATGTAACAGAACTATCA
CTGGACTAGCAGTAAGGAAACCTGGGCTCCAACCTTGCCTTTATCACAGTCTCTAAATGACTGTGATATTAGAAA
AGTCACTCATTT

The SNPs in the vicinity of the SNP rs1499955 which can provide information on the predisposition to prostate cancer are defined in our database according to the following table and are positioned in the interval 116302446-117011700 of chromosome 3 or between the SNPs rs9289008 and rs2289271 of chromosome 3

| | | distance | |
|---|---|---|---|
| | | (bp) to the | location UCSC |
| | | principal | genome browser |
| SNP | chromosome | SNP | assembly March 2006 |
| rs9289008 | 3 | −416967 | chr3: 116302446-116302946 |
| rs17755786 | 3 | −296763 | chr3: 116422650-116423150 |
| rs7428182 | 3 | −118281 | chr3: 116601132-116601632 |
| rs7650434 | 3 | −92831 | chr3: 116626582-116627082 |
| rs1353909 | 3 | −75480 | chr3: 116643933-116644433 |
| rs1499954 | 3 | −75317 | chr3: 116644096-116644596 |
| rs1499955 | 3 | 0 | chr3: 116719413-116719913 |
| rs2289271 | 3 | 291787 | chr3: 117011200-117011700 |

SNP rs4855539 located in 3p14.1 on chromosome 3 between positions 69108069-69108569 according to the location determined by the UCSC genome browser, assembly of March 2006.

Genomic Sequence in the Vicinity of rs4855539: Polymorphic Nucleotide in Bold.

Seq. Id. No. 11
AAGTCACATGTCTTTAGTTTGTTTTTTCTTGGTCTTACTTTTCACAGGGAAAAATTCTCTTCATGAGG
CTAATTTGAAGTTTTTGAAATTAAAGACTGGAATACTTTCATGCTGACAGAGGTAGACGCACACGCACTGGTATA
TGCAGTTACAAATACTCGCATAAAATGGAAACCATTATTTCATATATAAATTAATTAATCACAAATGCTCTCCAT
GGCTAAGAAGGAATCAGTGGAAACCAGACAGAAGGTATGCAAGACAGTCCTACAGAATGTTCTAATTTGCTTTTA
TCACATG(C/T)AGTTGCTACATTTTAGGAAAACATGATTTAAATATGAAACATGTAATATAAATTAATATAGTG
GCATGATTTATTCAGGTTCTCGATGCATATAACCTGGAGGTGACTAAACGCTGATCTATAACATGGTCCTATAGC
TTGGTACTGAGAATCACAACTCTGCGTGTGTGTGTGTGTGTGTGTGTGTGTGTGTGTGTGTGTGTATGTTTTGCA
TGTTTTCCTTTCCTACCACAAACAGTGTTATAACCAGATTATGGCAAATAAAAGAACAGTTGTAAATTTACCCAA
ATATATCATAAA

The SNPs in the vicinity of the SNP rs4855539 which can provide information on the predisposition to prostate cancer are defined in our database according to the following table and are positioned in the interval 69049525-69153397 of chromosome 3:

| | | distance | location |
|---|---|---|---|
| | | (bp) to the | UCSC genome browser |
| SNP | chromosome | principal SNP | assembly March 2006 |
| rs6768792 | 3 | −58544 | chr3: 69049525-69050025 |
| rs6785239 | 3 | −24227 | chr3: 69083842-69084342 |
| rs4855539 | 3 | 0 | chr3: 69108069-69108569 |
| rs1745 | 3 | 44828 | chr3: 69152897-69153397 |

SNP rs4242382 located in 8q24.21 on chromosome 8 between positions 128586505-128587005 according to the location determined by the UCSC genome browser, assembly of March 2006.

Genomic Sequence in the Vicinity of rs4242382: Polymorphic Nucleotide in Bold.

Seq. Id. No. 12
CTTACAGCATACCCGAAAGCATTGGTGAGGACACAAAAACTACAGATAAGAATCAGATTCTAAAAAGA
CAATTCTCTTTTCCATTCCTGTCCTCTCCCCTGCAACTTCCCAATCCCTCACCTCTAATTAACCCGCCCACCCCT
TCACTAGCTTCTGATTTCAGGCAACGTCCAGTACTTGTTCCACCTTTCTCTCTGACCAGCCATCAAGAAGATCTT
GTATGTTTCTCCTACACACCCCTGCCCCTGGACCCAGGAATTCTTCCATTTTTCCATATTTGGGCTATATTAAGT
AATAAGCCCACATGCTTTCTGTTGAGAAAATACAAAAAGATGTTTCCCTCTGTCATAAAGAAAAAGAGGTAACCC
AGGGAACATTTTGTCCCTCTAGTTATCTTCCC(A/G)CAGGCCCATCAAGAATCAGGCAGTAGGTGAAAAAGAAA
CACAGAGAACCTAGGAACACAATAGGAAGACCACCATGGGCCCTTAGGGAGTCAGCGAAGGCTTATGATGCAAAA
AGAAGGTCCCAGGTACCTTAAAAACTCCACTTCCCTCTCTAGGATCCCCAAGAGAGCTTGACAGCGTCCCTCTAT
GCAGATGTTCATAAATCAGGCATATGTAACTCTGCGGTTTCCTGCACATAATTGATCACAGTTGAGCTGCTCAGA
CATTAAATCCAAAGGACATCAGAGAAGGACGAGTTCAGTAAAGAACACTGAGAAAGAAGTGGACCCTGAGCATAG
ATCTTGGCATACATGCGTGGGAAATGGCCTCTCAAGGGGTCATTATCCATTCAATTACACAC

The SNPs in the vicinity of the SNP rs4242382 which can provide information on the predisposition to prostate cancer are defined in our database according to the following table and are positioned in the interval 128539973-128619555 of chromosome 8 or between the SNP rs7830412 and rs4407842 of chromosome 8.

| | | distance | |
|---|---|---|---|
| | | (bp) to the | location UCSC |
| | | principal | genome browser |
| SNP | chromosome | SNP | assembly March 2006 |
| rs7830412 | 8 | −46532 | chr8: 128539973-128540473 |
| rs1447293 | 8 | −45253 | chr8: 128541252-128541752 |
| rs921146 | 8 | −42388 | chr8: 128544117-128544617 |
| rs4871799 | 8 | −34931 | chr8: 128551574-128552074 |
| rs1447295 | 8 | −32535 | chr8: 128553970-128554470 |
| rs9297758 | 8 | −30985 | chr8: 128555520-128556020 |
| rs7831028 | 8 | −25544 | chr8: 128560961-128561461 |
| rs11775749 | 8 | −22907 | chr8: 128563598-128564098 |
| rs16902169 | 8 | −21067 | chr8: 128565438-128565938 |
| rs13253127 | 8 | −20982 | chr8: 128565523-128566023 |
| rs6985504 | 8 | −20797 | chr8: 128565708-128566208 |
| rs7831150 | 8 | −18135 | chr8: 128568370-128568870 |
| rs723555 | 8 | −17474 | chr8: 128569031-128569531 |
| rs16902173 | 8 | −13574 | chr8: 128572931-128573431 |
| rs17766217 | 8 | −13076 | chr8: 128573429-128573929 |
| rs12155672 | 8 | −10549 | chr8: 128575956-128576456 |
| rs1562432 | 8 | −9971 | chr8: 128576534-128577034 |
| rs4871808 | 8 | −4028 | chr8: 128582477-128582977 |
| rs4242382 | 8 | 0 | chr8: 128586505-128587005 |
| rs4242384 | 8 | 981 | chr8: 128587486-128587986 |
| rs7017300 | 8 | 7695 | chr8: 128594200-128594700 |
| rs11988857 | 8 | 14300 | chr8: 128600805-128601305 |
| rs9656816 | 8 | 17081 | chr8: 128603586-128604086 |
| rs12542685 | 8 | 20010 | chr8: 128606515-128607015 |
| rs7837688 | 8 | 21787 | chr8: 128608292-128608792 |
| rs6991990 | 8 | 27810 | chr8: 128614315-128614815 |
| rs13258742 | 8 | 31105 | chr8: 128617610-128618110 |
| rs4407842 | 8 | 32550 | chr8: 128619055-128619555 |

SNP rs11526176 located in 7p15.2 on chromosome 7 between positions 27546048-27546548 according to the location determined by the UCSC genome browser, assembly of March 2006.

Genomic Sequence in the Vicinity of rs11526176: Polymorphic Nucleotide in Bold.

Seq. Id. No. 13
CATACTTCTAAATGAAAGTTACTTGCTTTTCAAGAAAAATTTGAAGTCCATGGGTTATTGCTGCGTGA
TTGTACTACAAATAGAGAGGACTATGGCAAGTACAGTTGACCCTTGAATGATGAGGGGGTTAGGGGTGCCAACCC
CCAGTGCAGTCAAAAACCCATGTATAACTTTTGACTCTCCAAAAACTTAACTACTAATAGCCCACTGTTGACTGG
AAGCCTCGTCAATAACATAAACAGTTGATTAACACATATTTTGTATATGTATTATATATTGTATTCTTATGGTAA
AGCAAGCTAGAGAAAAAAATGTTACTAAGGGAATCATTAAGGAAGATAAAATATATTTATTATTCATTAAGTGGA
AGTGGATCATCATAAAGGTCTTCAATCCCATCATCTTAATAATGAGTAGGCTGAGGAGGAAGAGGAGGGGTTGCT
CTTCGCTGTCTCGGGGTGACAGAGGCAGAAGAGGTGGAGGTGGTAGAAGGGGAGGCAGAAGGGGCAGGCACACTC
CGGATAACTTTATGGAAATTGTAATTTCTATCTGATGTTTTTGCTCTTTCATTTCTCTAAAAACGTTTTTGTATG
GTACCAATC(C/T)GTCTTCCACTGTTTGCTTTATTTTCAGTGTCTGTATCAGAGAAGGGTCCATGTTGTAAAAG
AAGTTGAAAGGAGTCTTGAATAATCAGAACCGTTCTGCCATACTGTCTAATGTCAATTTGTTTCCTGGCACTGCT
TTTGGTACATCTTCTTCCTCATCATCTGGTACTGTTCAGAAGCACTCATCTCCATCAAGCCTCTTCTGTTAATTA
CTCTGCTGTGGTGTCTATTAGCTCTTGAATTAATCCAAGATCCATATCTTGAAAGCCTTCATACACTCCCCACCT
TTTTTGCCATATGCACAATCTCTTTAGTGATTTCCTTGATTGGCCCTGCCATAAATCCTGTGAAGTCTTGCACAA
CATCTGGACAGTTTTTTCCAGCAGGAATTTACTGTTAGGGGCTTGATGGCCTTCAAGGCGTTTTCCACAATAACA
ATGGCATCTTCAATGGTGTAATCTTTCCAGATTTTCATGTTCTATCAGGGTTTTCTTCCACAGTGACAATCCTTC
CCATAGAGTACCATGTGTAATGAGCCTTAAAGGTCCTTATGATCCCCTACTCTAGAGGCTGAATTAGGGGCGTTA
TGTTTAGGGGCAAGTTGGCCCCTTGGACACCTTCAGTGTTGAACTCATGTTATTCTGGGTGGCCAGGGGTACTGT
CCAATATCAAAATAACTTTAAAAGTCAGTCCCTTACTGGCAAGATATTGCCTGACTCCAGAGACAAAGCCATTGA
TGGAAACAATCCAGAAACAGGGTTCTCATCGTCCAGGCCTTCTTGCTGTACAACCAAAAGACAGGCAGCTGGTAT
TTATCTTTTCACTTAAAGCCTCAGAAGTTAGCAACTTTATAGATAAGGGCAGTCCTGATTTTCAACCCAACTGCA
TTTGTACAAAACAGTAGAGTTAGCCTATCCTTTCCTGCCTTAAATCCTGGTGCTGCTTGCTTCTCTTCCTAATAA
ATGTCCTTCGAGCATCCTTTTTTTTTTTTTTTTCTCCGTAATAGGGCACTTCTGTCTGCATTAAAAACTCATTCA
GGCAGATATACTTTCTCTTCAATGATTTTTTCTTAATGGCGCCTGGGAACTGTCTGCTGTCTCTTGGTTGGCAGA
AGCTACTTCGCCTATTTCTTGACATTTTTTAAGCAAACCTCTTCCTAAAATTATCAAACCATCCTTTGCTGGCAT
TAAATTCTCCAGCTTTAGATCCTTCACTTTCTTTTTGCTTTAAGTTGTCATATTTTTCTTGAATCATATTAGATG
TAAGTATGCCTTTCTACAGCAATCCTGCATCTACATAAAAGCTGCATTTTCAATGTGAGATAAAAAGATGTTCTG
CAAAAAGTGCAAGCCTGCTGGAGTAGCTGCAGTGATGGGTTCATGACTATTCTTTTCTTTGTTTACAATGGTCCT
TACATTGGATTTGTTTATCTTGAAATGGAGGGCAAACGCAGCCGCAGACCTCAATCCATGGTATGTATCAGGCAA
TTCAACTTTTTCTTGTAATGTCATGACTTTTCTCAGCTTCTTAGGAGCACTTCCAGCATCACTAGTGGCACTTTG
TATGGGTCCCATGGTGTCATTCAAGGTTTATGGTATTGCACTAAACATGATAAAAAAATACAAGAGAATTCCAAG
AGATCAATTTTTACTATGATACACAATTTACTAAAGAGATGAACCACTCACACAAAGATGATTAGTGTCACATGA
CATTTTATGCTCAATACTTGTAACACTTGAGTTCACTGCAATAGCAACAGGTGGCCACAAAATTATTACAGTAGT
ACAGTATTACTAGAGTTAATTTTATGCCATTATGATTTAATGCATCTTTACATTTCTTTACATTTCTCTCAACTG
TAAATGGTGCCATGTATGGTCTATAAATATTTGTAAACTTTGATAAATTTTAACTCTTTATAACAGATTTGTGCA
TATTTATAAACTAGTATCTATCTACATATATTTTATGCGTTCACGACATATCTAACTTTTTCTT

The SNPs in the vicinity of the SNP rs11526176 which can provide information on the risk of onset of prostate cancer are defined in our data base according to the following table and are positioned in the interval 27414591-27808301 of chromosome 7 or between the SNP rs11761572 and rs2237344.

| | | distance | location |
|---|---|---|---|
| | | (bp) to the | UCSC genome browser |
| SNP | chromosome | principal SNP | assembly March 2006 |
| rs11761572 | 7 | −131457 | chr7: 27414591-27415091 |
| rs11526176 | 7 | 0 | chr7: 27546048-27546548 |
| rs10447552 | 7 | 103525 | chr7: 27649573-27650073 |
| rs42088 | 7 | 122088 | chr7: 27668136-27668636 |
| rs2237344 | 7 | 261753 | chr7: 27807801-27808301 |

SNP rs6492998 located in 15q15.1 on chromosome 15 between positions 39,333,673-39,334,173 according to the location determined by the UCSC genome browser, assembly of March 2006.

Genomic Sequence in the Vicinity of rs6492998: Polymorphic Nucleotide in Bold.

Seq. Id. No. 14
ACCTCCTTATTGAGACTGAAGTTCAGGCTAGGTTGTGCATCACCACTTGATACTAGACTTGGTATTTAAACTGCC
TTTTCTCAGCTAAAGTTTCTTAAGCTTGTTAGACATTAAACTGAAGTATGTAGCCATGCAATTCAAATCAGCCTT
AGTCTTAATTTAAAAGTGAGTAGTTATTGTTTCTTGACCTCTGTCAGACA(A/G)GAGGAGCTACATTTTGATGAT
AGTGTAGACTTTGTATTACAGAACAAATTATGTAATAAAAGCTTAGTACATGTTTGTTGAATTAAATAATCAGGA
CCTCGGTAATTTTCTCTTTCATCATCTTAAGCAATCCAGTTATCTTATGAATGACTTCTTCTGGTTCATGCATTG
ATATAAAATTATTACACTAAATGGTCAAG

The SNPs in the vicinity of the SNP rs6492998 which can provide information on the predisposition to prostate cancer are defined in our database according to the following table are positioned in the interval 38991207-39584443 of chromosome 15:

| | | distance | location UCSC genome browser |
|---|---|---|---|
| SNP | chromosome | bp | assembly March 2006 |
| rs12592197 | 15 | −337006 | chr15: 38991207-38991707 |
| rs6492997 | 15 | −5460 | chr15: 39328213-39328713 |
| rs6492998 | 15 | 0 | chr15: 39333673-39334173 |
| rs170296 | 15 | 250270 | chr15: 39583943-39584443 |

SNP rs6681102 located in 1q43 on chromosome 1 between positions 236,853,987-236,854,487 according to the location determined by the UCSC genome browser, assembly of March 2006.

Genomic Sequence in the Vicinity of rs6681102: Polymorphic Nucleotide in Bold.

Seq. Id. No. 15
AAGGACTGAAAACTGCAATAGAGTTACCAGAGATGCCATTCTTTTAAAATTCAGCAACGTTCATTTCCATTGTGC
TTAAAGTTTTTGTATTTCTCTTTTTAGCAACATAGGTTTGAAGACTATTTTACAATATTGTATAGAATATAAAAC
TTCAAAGTACATATTTCCTATGTAAAGTCACATGCTGTATAATGACATTTcagtggtcccataagattataatgg
agctggaaaattcctattgcctcgtatttacaatactatatttttactgttattttagagtgtaccccgacttat
taaaaaaaatcaaacaagttaactataatacagcctcaggctgtcttcacgaggcatccagaagaaggtattgtt
atcataggagatgacacctctatgcttgttattgcccctgaataccttccagtgggacaagaggtggaggtggaa
aacagtgatattgatgatcctgacttgtgcaggcctaggctaatgtatgtgtctgtgtcttaatttttaccaaag
ttttaaaagttaaaaaattgggaaaaagcttattgaataaggatataaagaatatgttttgtacagctctgcgat
atgttttaaactacgttattactaaagagtcaaaaagccttaaaaacttaaaaaattattaattaaaaaagttac
agtatgctaaggttaatttattattgaagaaaaaattaacaagtttagtattgtctgatttgtaaatgctcataa
agtctatagtagtgtatagtaatatcctaggccttcacatacactccccattcactctgactcacccagagcaac
ttccagtcctgcaagctccattcatggtaagtgcactgtacaggtgtcccatggctggaaaccatcattctcagc
aaactaacacaggaacagaaaaccaaacaccgcatgttctcactcataaatgggagttgcacaatgagaacgcat
ggacacaaggaggggaatatcacacactggggcctgtcgtggggtggggggctaggggagggatagcattagaag
aaatacctaatgtagatgacgggttaatgggtgcagcaaaccaccatggcacgtgtatacctatgtaacaaacct
gcacgttctgcacatgtatcccagaacttaaagtataataaagaaagtaaaaaaaaaaatcttttatactttttt
tactgcgccttttctatgtttagatagacacatacttactgttgtgttataactgcctacagtatatagtatagt
aacatgctacacaggtttgtagcccaggagcaataggctatactatataggctaggtgtgtggtagactatgata
tctaaatttgtacactctatgatgttcacacaatgatggaatcacctaacatttatcaggacgtatccc(c/t)g
gtgttaagcaacacatgattTTGTTATACTAACAATTCTCTTAGAGATTATTGGGGAAAAATTTAATAAGATATT
TCCTACGTTTGTAATAGACCATCAGTGGTGACGCTCTAACAAGCTGTCATGAAGATGGCCATACACAACAATTCT
GCGTGTTTTCTTTTGCTATTTAAGAGTGCTCTGTTTGGGAACCCTGACTTATAAACCGTGGTTCTGGCCA

The SNPs in the vicinity of the SNP rs6681102 which can provide information on the predisposition to prostate cancer are defined in our database according to the following table and are positioned in the interval 236815776-236998150 of chromosome 1:

| | | distance | |
|---|---|---|---|
| | | bp to the | location UCSC |
| | | principal | genome browser |
| SNP | chromosome | SNP | assembly March 2006 |
| rs652252 | 1 | −38211 | chr1: 236815776-236816276 |
| rs10754645 | 1 | −1597 | chr1: 236852390-236852890 |
| rs6681102 | 1 | 0 | chr1: 236853987-236854487 |
| rs7547641 | 1 | 34418 | chr1: 236888405-236888905 |
| rs2174076 | 1 | 50252 | chr1: 236904239-236904739 |
| rs2689128 | 1 | 143663 | chr1: 236997650-236998150 |

SNP rs2048873 located in 2q13 on chromosome 2 between positions 113139055-113139555 according to the UCSC genome browser numbering, assembly of March 2006.

Genomic Sequence in the Vicinity of rs2048873, Polymorphic Nucleotide in Bold

Seq. Id. No. 16
TAACGGGCACCCTCtgctaactgacaatactgggcaaatacagatgttctccacgccagtttcatcatgtacaaa
atcaggataagatctaccacaaaaggcca(C/T)gaggattaaatgTAGTCTTCTGCAAGACCATTAAACTGACA
GCAGGATGCAACGGCATGTACCCAGCCAGTGGCCTAACCTTGCAGGCACAGGTTAGACTAGGCACTGCCTTACCC
TOTTCGATTOTTAGTGTTGGTTTCTAGTGAAACGCTCCAAATAAACTCAAAATTCAAAAGTATTGTTCCAAACCC
TCAGGACAGGAACTATCAATCTAGTTTGCCAAGAAATGTACTTTTCATTAACTTCTGATCAGGGGCAAAAATATA
ATGGGTCAGAACTGAAGAATCCCATACTGAGAACTTTTAAACAAAACTTAGCTACACATTGCCTCCCACTCATTT
TTGCTTTCCTTGTACTGAtgtcctttgaacactagtctgaactgcagaatccacttatacacagacttactttca
cctctgccatccctgagacagcaagaccaactcctcctttcctcctcagtcaactcaagatgacaaggatgaaaa
cctttatgatccatttccactta

The SNPs in the vicinity of the SNP rs2048873 which can provide information on the predisposition to prostate cancer are defined in our database according to the following table and are positioned in the interval 113062733-113411386 of chromosome 2.

| | | distance | |
|---|---|---|---|
| | | (bp) to the | location UCSC |
| | | principal | genome browser |
| SNP | chromosome | SNP | assembly March 2006 |
| rs1047652 | 2 | −76322 | chr2: 113062733-113063233 |
| rs2048873 | 2 | 0 | chr2: 113139055-113139555 |
| rs6542074 | 2 | 6918 | chr2: 113145973-113146473 |
| rs7600475 | 2 | 271831 | chr2: 113410886-113411386 |

SNP rs6804627 located in 3p14.2 on chromosome 3 between positions 60963960-60964460 according to the UCSC genome browser numbering, assembly of March 2006.

Genomic Sequence in the Vicinity of rs6804627, Polymorphic Nucleotide in Bold

Seq. Id. No. 17
ATTTGCAATCTGCAAAAGAAAAGCCATCTATCTAAAGGGGCACGCCACAC
TGTTATTCCTTTGTAATATTAAGAAATTTATCCTAATTTAAAAGATAACT
GAATTCTTATTCTTTTACAAATTAGACTTTAAAACACAGCCACTGAATTG
ACCAAGCACTACCAAGCTTTTATCCTACTTTTATTTAAATGTACTGAAAC
ATTAGTGATGAAAGCTTTCATTTAAAGAATTCTGATGATTCTAATATTCA
(C/T)TTATAATGTCCATTTAGCTACCACATTGTGTTTATGCCCCTTAAA
AGCTGAAGCTATGACTGCTCTAGTACTGAGTTCTCCAGTGCTTATCATTA
ATTAAAAGGTAAAACACGATTACCAGGGTATCTGCAATCAAGCTTTCAAT
GTAAGAAATATCAATATCCAGTACTTGAGAACATTTTGGAACCAATTTTA
ATAGGTAAAAAAGTCCAAAGAGAAGAAAAAATGTTCTTTATTATTTCAAA
TTAAA

The SNPs in the vicinity of the SNP rs6804627 which can provide information on the predisposition to prostate cancer are defined in our database according to the following table and are positioned in the interval 60928379-60979489 of chromosome 3.

| | | distance | location UCSC |
|---|---|---|---|
| | | (bp) to the | genome browser |
| SNP | chromosome | principal SNP | build dbSNP128 |
| rs9879276 | 3 | −35581 | chr3: 60928379-60928879 |
| rs12053964 | 3 | −31608 | chr3: 60932352-60932852 |
| rs6804627 | 3 | 0 | chr3: 60963960-60964460 |
| rs6786392 | 3 | 15029 | chr3: 60978989-60979489 |

SNP rs10245886 located in 7p12.3 on chromosome 7 between positions 47546720-47547220 according to the UCSC genome browser numbering, assembly of March 2006.

Genomic Sequence in the Vicinity of rs10245886, Polymorphic Nucleotide in Bold

Seq. Id. No. 18
ATACGTGAGCAACGTGTGTGCTCGATGTCAGAGGAAATACAGCGGCTGGC
TCACCCCGCCCCTCCCAGAGGGACGATCTACACGCAGTGTTAGGAGGGGG
CACGGAGTCCACAGATCATGGGAAGAACTCCATGAATGGCCTGTGACTTG
AAGCAGAAGCAGACACTTTCCAGACAGGAAAAGAGGTGAGGAGAGGCAAG
GGTGGTAAAGCGCCGTATTTTTGGTGAACTGGCCAAAGGCTGGGTGGCTA
ATGCACAGCTGTGTTGGGACACTGAGGGTAGACAGGGCTCAAGAAGCAAG
(G/T)ACAGGGTGGTGAGCAGGATTGCACAAAGCAGTCACAAGGAAGGAG
GCCCCAGTACCGAGCTGGGCTGGACTCCAACGTCACAGGGGGCTCTAACT
GGCAAAAAGGAAAAAGCATCACAGGTGTATGTTCATCCTGGAGGACCCCT
GGCAGTCCTGGGAGGACACTCGGGAGAAAGCAGGAGTGGACATGGAAACT
CTAGGTAAGAGAACCTCAGCCTCGGGCAACAGCCCTAGAAACACAGATAA
ATGTACAGGGGAGAGGACGGCCATAGCAGTGGAGAGGTGACGGGAGATTG
GTCAT

The SNPs in the vicinity of the SNP rs10245886 which can provide information on the predisposition to prostate cancer are defined in our database according to the following table and are positioned in the interval 47461234-47557773 of chromosome 7.

| | | distance | location UCSC |
|---|---|---|---|
| | | (bp) to the | genome browser |
| SNP | chromosome | principal SNP | build dbSNP128 |
| rs2941528 | 7 | −85486 | chr7: 47461234-47461734 |
| rs10245886 | 7 | 0 | chr7: 47546720-47547220 |
| rs625224 | 7 | 10553 | chr7: 47557273-47557773 |

SNP rs1511695 located in 1q41 on chromosome 1 between positions 218514703-218515203 according to the UCSC genome browser numbering, assembly of March 2006.

Genomic Sequence in the Vicinity of rs1511695, Polymorphic Nucleotide in Bold

Seq. Id. No. 19
AGAGCACAGATGACTGTTGTTAAGAGAGAGATGTGTTACTGAGGAAGATA
AGCAGCAGCCCCTTGCCAATCCTTAGCAGCAGCTTGAAGCGAAGGGGTTG
AGTTGCAGGATGGGCACTAAACGCAGATGTGAGAGAAAGAGCAATGGACT
TGGAATCATGACTTTGGGGAATTCATGTCACTTTTTTGGGACTTAGTTTC
TTGGTTTATAAAATGAA(A/G)AGGCTGGGCTCTAAAGTTCATCCCAGGG
ATATGTAGGTTTTGGTAAGAGACTGGGAATGGCAAGTTCTGGGAGCTGGA
ATTGCTTAGAAGGAGTGGTCTGTGTAAGCACCCTAGTAAGAAGCTTGGGT
CAGCAGGAGAAAATGTGAGGGTACTGGACATCTCTAAGGGAAAGTAAGGG
GAGCATAGCAAGGGCGTGGAGAGTCCTTGAAGCCTTACCTCATAGCTGTG
CTAAGGGTCATCCTTGAATTGAAGATTGAGGAGAAGCAAGGGCTATTTAC
AGTTAttattcaacaaacatttatggagtgctttttacattaaagatact
gtagtaagcacAGTAAGGCAATAAGGACAAGTGATCCAGAGATTCACTAC
TTAAAAGCAGACAAACACAAATGCTCTAAGAGCAGAGTGTGATGAGTACC

The SNPs in the vicinity of the SNP rs1511695 which can provide information on the predisposition to prostate cancer are defined in our database according to the following table and are positioned in the interval 218280585-218521047 of chromosome 1.

| | | distance | |
|---|---|---|---|
| | | (bp) to | location UCSC |
| | | the principal | genome browser |
| SNP | chromosome | SNP | assembly March 2006 |
| rs12022181 | 1 | −234118 | chr1: 218280585-218281085 |
| rs1511695 | 1 | 0 | chr1: 218514703-218525203 |
| rs10779402 | 1 | 5844 | chr1: 218520547-218521047 |

SNP rs4669835 located in 2p25.1 on chromosome 2 between positions 12289824-12290324 according to the UCSC genome browser numbering, assembly of March 2006.

Genomic Sequence in the Vicinity of rs4669835, Polymorphic Nucleotide in Bold

Seq. Id. No. 20
ATTACAGGTGTGAGCCACCATGCCAGGCCCAGGTTATGTAAATATTTAAT
TGAGATAATCCACATAATGCATAAATCTTAGAACATAGCAACAAATCAAT
AAAGAGTAGCAATGGTGTCGTCACCTCTGCCACATTCATCAGCAATCAAG
GTGTGTGCCCCATCAGTCAGTGGCCAAGACAGGGCTCCACATGTCCCGCA
TCTGCTCATACCCAAGAGCGAACTTTCCTCGACTTCCTGCTTCATCCTCC
(A/G)TGGTCTTTGTTGAAACAAAACTTGAACCAACAGTTCAACAATAAA
CCAGAGTATTTTACTTTGTTTTCTTCTTTCCCTAGATAACTTTTTATTAT
CTTCAGAGACTAGGGCTCTGTCGTCAATAAATATTTTTCAGACAAGGGGA
AGAAGAACACTAGGTGAAACACAAAACCTTAGGAGAAAGGTTACCACATT
TATTTTGATGCCAATCCCACTGAAAGTTAAAGTCAAAGCATCTGTTAACC
AGATC

The SNPs in the vicinity of the SNP rs4669835 which can provide information on the predisposition to prostate cancer are defined in our database according to the following table and are positioned in the interval 12111054-12324507 of chromosome 2.

| | | distance | location UCSC |
|---|---|---|---|
| | | (bp) to the | genome browser |
| SNP | chromosome | principal SNP | assembly March 2006 |
| rs6744880 | 2 | −178770 | chr2: 12111054-12111554 |
| rs4669835 | 2 | 0 | chr2: 12289824-12290324 |
| rs10495595 | 2 | 34183 | chr2: 12324007-12324507 |

SNP rs12605415 located in 18q12.1 on chromosome 18 between positions 24135069-24135569 according to the UCSC genome browser numbering, assembly of March 2006.

Genomic Sequence in the Vicinity of rs12605415, Polymorphic Nucleotide in Bold

Seq. Id. No. 21
TGCACAAGATCTACTTGAGGTCTGTGCAATCCCATTTCAAATCTCAGCAG
TTAGTTTGCGGATATTGACAAAATGATTCCAAAGTTTATATGGAGAGATA
AAAGATGCAAAAAAGTCAAGTCAGTGTTGGATAAGGAGAAAAGTGGAAGA
CTAACATTAACCTAATTCAAGACTGACTGTAAAGCTATAGTAATCAAGAC
AGTGTAGTATTGGTGATAGAATAGAAAAATTGAATAGATTAATGGAAGAG
AATAGAGAGCCCAGAAATAGACTCACATAAATATTGCCAACAGATTTTTG
ACAAAGGAGTAAAGGCAATACCTTGGCAGATAGTCTTTCAGCATATGGTG
CTGGAACAGCCAGTCATCTACAGGCAAAAAAAAAAAAAAAAAATTCCCTA
AATTTAAACCCCTCAGAAAAATTAACTAAAAAGAGTTATAATCCTAAATG
CAAAATTCAAAACTATAAAACTCCTGGAAGATAACAGGAGAAAATCTGGA
TACTATTAGGTATAGTGATG(G/T)CTTTCAAAATAAACCACCAAAGGCA
TGCTTCATGGAAAAAAAAGTTGACAAGCTGGATGTTATTAAAATTAAAAC
TTCTGCTTTGCAAACAACAATTTCAAGAGTATAAGACAAGCCACAGACTG
GAAAAAAATATTTTCACAAGATACACTACTAAAGCACTCTTATCCAACAT
GTAAAAGACACTCAAAATTTAATAATGAGAAAATATACAACCTTATTTAA
AAAATAGACAAAATATATGAACAACCACCTCACAAAAGAAGACAAACATA
TGAAAAATTAGCACATGAATGACGTTCAACTTCATATTGTCATTAGAGAA
TTGCAAATTAAAACAGTGAGATACCACTGCACACCTATTAGAATGTCCAA
AATCCAAAATACTGACAAGACCAAATGTTGTCAAGGATGTGGAGCAACAG
GAACTCTCATTCACTGCTAGTGGGAATACAAAATGGTACAGACAGTTTGG
AAGACAGTTTGGCAATTTATTATAAGAACAACCACCTCACAAAAG

The SNPs in the vicinity of the SNP rs12605415 which can provide information on the predisposition to prostate cancer are defined in our database according to the following table and are positioned in the interval 23907695-24187878 of chromosome 18.

| | | distance | location UCSC |
|---|---|---|---|
| | | (bp) to the | genome browser |
| SNP | chromosome | principal SNP | assembly March 2006 |
| rs524047 | 18 | −227374 | chr18: 23907695-23908195 |
| rs12605415 | 18 | 0 | chr18: 24135069-24135569 |
| rs11083271 | 18 | 44738 | chr18: 24179807-24180307 |
| rs1880016 | 18 | 52309 | chr18: 24187378-24187878 |

SNP rs749915 located in 4p14 on chromosome 4 between positions 39151013-39151513 according to the UCSC genome browser numbering, assembly of March 2006.

Genomic Sequence in the Vicinity of rs749915, Polymorphic Nucleotide in Bold

Seq. Id. No. 22
TCCGACAATCATTATCACATGACTTTTTATCCCTTGGAAAATGATTTTCT
TTTCATAAATCAATTCAAGCTATTGATTAAAATAAGAGCTGAAATTCCAA
AAGTAAAAAAAATTTGCATTGTAGCTAGTAAAACAACTAAACGTTCCTAC
GGAGAAAAATAATCTTATGGATATTTTTCTGTTGCCTCTGGGGGAAAAAT
ACAAAGAAATTTAATGATGCAAGCAATGCTATCAAATAAGATACTTTTCA
GTGCTTAAACTGATTGAAACTGAGTCTGGAGATGCAGCTGGCATCATTTC
CAAATAAATATGTATTTCTCAGAAAACCCTATTAGATGCTTGACATGCTC
TGTCATTTCTGAATAACCTACTACTGAAATCTACACATAGAAAAAATTAA
TAAACTAATTGTTTCTGCTTTTACTATAGTAGCTGAGTTACAAAGCAGGG
GGCTGAATTTGTTTAAGAAACAAAAGATTAAGAGAAACTTTTCTTAATAT
GATCCCCATGGAGCAAAGCTCCTAAGGATGTTCCAGAAGAAAAACTACGC
CCTCTACCAAGACCACCAAAGGTATTAGAATTTGTCAAGAGTTTTAGTGA
CTGGTGGTAGAACTTAATGTGGAAAGTTAA(C/T)GGCCTAAATGAAACC
ATGCCCCACAATCTAACTTACCTGCTTTATATGAAGAACGCACCAAAGGG
CCACTTGCAGTATAATGAAATCCAAGTTCATTTCCTACTTTTTCCCAGTA
TTTGAATTTTTCAGGAGTAATATATTCTTCAACCTAGATTTAAATAATTA
CTTCTGATCAGATTTTAGAATTCCACTTTGATTCTCCAGAAAGTCTATAC
CTATGTATGCAGAATGCTCTTCACTGCGTAATTTATCTTGCCCCCACCCC
CAGGCTTTTGTCCTCTCCCTCCTCCCTGACTACGTGTTTACTGGTTACTT
TTTGGCCACTCTATTGGGATGTAAATACAGGGAATTACAGAGACAGGGAA
GCATATCAATTTTGTGCTACAATGGCTATTCCAAAGGACAGAGAAAGAAG
AG

The SNPs in the vicinity of the SNP rs749915 which can provide information on the predisposition to prostate cancer are defined in our database according to the following table and are positioned in the interval 39097014-39163238 of chromosome 4.

| | | distance (bp) to | location UCSC |
|---|---|---|---|
| SNP | chromosome | the principal SNP | genome browser |
| rs3860070 | 4 | −53999 | chr4: 39097014-39097514 |
| rs749915 | 4 | 0 | chr4: 39151013-39151513 |
| rs2608836 | 4 | 11725 | chr4: 39162738-39163238 |

SNP rs13226041 located in 7q22.2 on chromosome 7 between positions 104851579-104852079 according to the UCSC genome browser numbering, assembly of March 2006.

Genomic Sequence in the Vicinity of rs13226041, Polymorphic Nucleotide in Bold

Seq. Id. No. 23
AAAaaacagatttaaggtataattgacatacaataagtggtacatcttaa
gggtgtacaatttgagaactttggacatactattcacctgagaaattgtt
aacacaaccaagatgatgaacatatccatcacctccaaagttttctcata
cCCTGTGGTAATCTCTCCTAATCTCACCATATGATCCCATCTCTAAACAC
GTACTGATCTACATTTTACCCTTTTTTGAttgctttatggtagaatttgc
tttattgtggtggcctggaattggacctgcaatatctccgaggaatgcct
gtatgctgggcaaaaaaagccagacaaaaaagggtatatattctattatt
ctatgtttagaaaattttagaaaagtaaactaatctatagtgacaaaaag
tagTCagtagatcctatctcaagacaccactttctttgctcatccataag
aaggaactcctcatctattcaagtttgatcatgagattgcagaaattcag
(C/T)tacatcttatggctcacttTctttcttccttccttcccccctccc
tccttccctccctctcttccttcccttccttccttccttccttccttcct
tccttccttcctttctgtctttctttctCTCTCTCTCTCTCTCTCCCCCC
CACCCCCCAACtttctttttttctattttttttttttttgacagagtctc
actctgttgcccaggctggagtgcaatggcgcgatcttggctcactgcaa
cctctgcctcctgcgttcaagcaattctcctgcctcagcatctgaagtag
ctgggattaacaggcgagcaccactatgcctggctcattttttaattttt
ttttagtagagatggggttcaccatgttggccaggctggtctcgaactcc
agacctcaggtgatctgcccgccttggcctcccaaagtgctgggattata
ggtgtgagccactacacccggccCAGGCTCTACTTCTAATCCTTGTTCTC
TCACA

The SNPs in the vicinity of the SNP rs13226041 which can provide information on the predisposition to prostate cancer are defined in our database according to the following table and are positioned in the interval 104002818-104863625 of chromosome 7.

| | | distance (bp) | |
|---|---|---|---|
| | | to the | location UCSC |
| | | principal | genome browser |
| SNP | chromosome | SNP | assembly March 2006 |
| rs4400323 | 7 | −848761 | chr7: 104002818-104003318 |
| rs6966728 | 7 | −446276 | chr7: 104405304-104405804 |
| rs9655780 | 7 | −397259 | chr7: 104454320-104454820 |
| rs2299297 | 7 | −319298 | chr7: 104532281-104532781 |
| rs13226041 | 7 | 0 | chr7: 104851579-104852079 |
| rs6945887 | 7 | 2636 | chr7: 104854215-104854715 |
| rs6947486 | 7 | 11546 | chr7: 104863125-104863625 |

SNP rs721429 located in 17q24.2 on chromosome 17 between positions 62122117-62122617 according to the UCSC genome browser numbering, assembly of March 2006.

Genomic Sequence in the Vicinity of rs721429, Polymorphic Nucleotide in Bold

Seq. Id. No. 24
AAGCTTCAAGGGACATTGCAATTTAAATAAATTCATCTTGTTTTCTTGGG
TCCTGATACTCAAATGAGTAATATGTGATATATTATCCATCAGCTTTCTA
ATGGGACATCATTTTTCATTACATTCTGACAACAGAAATATCCCAT
(C/T)GCAGACAAAGCCCCAGGTGTGCTGCCTCTTAGCTATCTTTGTTCT
GCTACAAGTTTCTTTTTGGCTTTTTAAATATTAGATGTTTAACTTGCTCT
GGAATAGAGCAATGGTGTGCAGCAAAAGTTACGGTTACAGTAAGAGGAGG
AAAAGGCCAAGGCGCTTTTAGCTTCTTAATTTGCTCTGTTTTTTAAATGA
TGAACGAAATAATAAATGACAAAAACAATAAAAAGCCTGGACAATTGAGC
AAAATTGAATGGTGTAGGCTCATTTAAGGAAAGCTGCTTGACTTTTTAAT
ATTAGAATCTCCATTAACTGTTAACAGCACATGGAGTAGATAAGCAACCC
TACAGGTAGAAATGAGTTCGTTGAAAGTCCATTCCCAGCTAAAAGCCATC
AAAATGCAAATTAAAAGTAGTCATTGTGATACTGGAGCAAAATGAGCAAA
CGTATGTTTCGTTTTGTGAAATCTGAAGCTT

The SNPs in the vicinity of the SNP rs721429 which can provide information on the predisposition to prostate cancer are defined in our database according to the following table and are positioned in the interval 61335448-62195826 of chromosome 17.

| | | distance | location UCSC |
|---|---|---|---|
| | | (bp) to the | genome browser |
| SNP | chromosome | principal SNP | assembly March 2006 |
| rs1345451 | 17 | −786669 | chr17: 61335448-61335948 |
| rs721429 | 17 | 0 | chr17: 62122117-62122617 |
| rs12232511 | 17 | 73209 | chr17: 62195326-62195826 |

SNP rs9364048 located in 6q13 on chromosome 6 between positions 70455536-70456036 according to the UCSC genome browser numbering, assembly of March 2006.

Genomic Sequence in the Vicinity of rs9364048, Polymorphic Nucleotide in Bold

Seq. Id. No. 25
TTTGCTATTTCTTATGTAAACTTGGTGGGATTTGGATACTAGTTACTAAA
ATGAGATAAAATATGAATCTGGTTTCAAGACTTCTATAAGGGTAAACTAC
TTTAGGAGACAGAAAAGGAATAGGACAACTCTCCCTATCCCATGACTTGG
GGTGGGGGTAGATGAGAAAAATAAATGGAGGCGAGAAGGAAAGAAGTTCA
(A/G)TCTAAGAATGGAGATTTCATAGCTTGGTCAGACATGCATGTCCAT
ACAGATAAACTAGCAGACAGTTAAAAAATAAGAAAAGAAAGTTAAGATTC
TGAATTCTTGATTTCTTCCCCATATATTATTCAGCATAACTAGCTTATAT
ACTGTCAACTCTCCAAACAACATTAAAAAACCTCACTCATCTAGCAAAGC
TAAGT

The SNPs in the vicinity of the SNP rs9364048 which can provide information on the predisposition to prostate cancer are defined in our database according to the following table and are positioned in the interval 70074721-70679396 of chromosome 6.

| | | distance | |
|---|---|---|---|
| | | (bp) to the | location UCSC |
| SNP | chromosome | principal SNP | genome browser |
| rs13195278 | 6 | −380815 | chr6: 70074721-70075221 |
| rs9364048 | 6 | 0 | chr6: 70455536-70456036 |
| rs17689448 | 6 | 223360 | chr6: 70678896-70679396 |

SNP rs4242384 located in 8q24.21 on chromosome 8 between positions 128586505-128587005 according to the UCSC genome browser numbering, assembly of March 2006.

Genomic Sequence in the Vicinity of rs4242384, Polymorphic Nucleotide in Bold

Seq. Id. No. 26
CCAGGGCCACCTGAAACACCCTCAATTTCAGAAACATTTTACATTTCATG
ACTAGCAGATAAATACCCCTGGGGTAGTGAATTTTCAAAATCTCACACAG
GTCTCCTTAGAGcagagtttctcatctccagcaatattgacatttggagt
cagataattatttttgggttggggggtgggcactgatatgttcattgtag
gatgtttagcaagatctctggactctgcacactagataccagtagcaccc
ccatagtggtgacaattaactgtgtccccagacattgccaaatgtatcct
ggggagcaaaatcatctccTATTCTCACCTCCTGAGAAAGAAGTGCAGGA
TATCACAATAGCAGAGGGCAATGGAAGATGACAGTCCCATGCTAGAAGCT
GCTTTAC(A/C)AACACAGTCAGCTGCTATCTCCACAACAGGCGGGTGAG
GAAGGATTCATGACCCTCAATGAAATGAACAAATGCAAGCAAAGCCAAGT
TGCCATTGAATGTGGCAGTTAttgtttatttattttattatttattttat
ttatttatATTTTAATTTCTCTCTCTCTTTTTTCttttttcttttttttt
tttttttttagagagagattgggtctcactgtgttgcccaggctggtctc
aaatgtctggcttcaagcaatcctctcaccttagactcccaaagtgcACT
CCGCCCTGCCAGAGTTACTATTTGAATCCAGACATTCTGACTCTGAGGCT
GCGTTTTAACCAGCCTGACATCACGCCTCAAGCAGGGGATTTTTCAAAGG
ACAGGATGATGGAGCTGAGGCTCAAGAGACAGTCAGCCTTG

The SNPs in the vicinity of the SNP rs4242384 which can provide information on the predisposition to prostate cancer are defined in our database according to the following table and are positioned in the interval 128539973-128619555 of chromosome 8.

| | | distance | |
|---|---|---|---|
| | | (bp) to | location UCSC |
| | | the principal | genome browser |
| SNP | chromosome | SNP | assembly March 2006 |
| rs7830412 | 8 | −47513 | chr8: 128539973-128540473 |
| rs1447293 | 8 | −46234 | chr8: 128541252-128541752 |
| rs921146 | 8 | −43369 | chr8: 128544117-128544617 |
| rs4871799 | 8 | −35912 | chr8: 128551574-128552074 |
| rs1447295 | 8 | −33516 | chr8: 128553970-128554470 |
| rs9297758 | 8 | −31966 | chr8: 128555520-128556020 |
| rs7831028 | 8 | −26525 | chr8: 128560961-128561461 |
| rs11775749 | 8 | −23888 | chr8: 128563598-128564098 |
| rs16902169 | 8 | −22048 | chr8: 128565438-128565938 |
| rs13253127 | 8 | −21963 | chr8: 128565523-128566023 |
| rs6985504 | 8 | −21778 | chr8: 128565708-128566208 |
| rs7831150 | 8 | −19116 | chr8: 128568370-128568870 |
| rs723555 | 8 | −18455 | chr8: 128569031-128569531 |
| rs16902173 | 8 | −14555 | chr8: 128572931-128573431 |
| rs17766217 | 8 | −14057 | chr8: 128573429-128573929 |
| rs12155672 | 8 | −11530 | chr8: 128575956-128576456 |
| rs1562432 | 8 | −10952 | chr8: 128576534-128577034 |
| rs4871808 | 8 | −5009 | chr8: 128582477-128582977 |
| rs4242382 | 8 | −981 | chr8: 128586505-128587005 |
| rs4242384 | 8 | 0 | chr8: 128587486-128587986 |
| rs7017300 | 8 | 6714 | chr8: 128594200-128594700 |
| rs11988857 | 8 | 13319 | chr8: 128600805-128601305 |
| rs9656816 | 8 | 16100 | chr8: 128603586-128604086 |
| rs12542685 | 8 | 19029 | chr8: 128606515-128607015 |
| rs7837688 | 8 | 20806 | chr8: 128608292-128608792 |
| rs6991990 | 8 | 26829 | chr8: 128614315-128614815 |
| rs13258742 | 8 | 30124 | chr8: 128617610-128618110 |
| rs4407842 | 8 | 31569 | chr8: 128619055-128619555 |

SNP rs2352946 located in 16q24.1 on chromosome 16 between positions 84758022-84758522 according to the UCSC genome browser numbering, assembly of March 2006.

Genomic Sequence in the Vicinity of rs2352946, Polymorphic Nucleotide in Bold

Seq. Id. No. 27
TGACAGTATCCACTGTGGACATCCTGGTTCCATCTTCCATTGTATACTGG
GTGTGTGTAGGCAGATGATTTGTATTTTCAGTTTATGAGTCTCAAGGAAT
CACAGTGTGGAAGCTACACTCAAGCAATGAAACCCAAAGTGCCTCCTATG
CACCTGGACCTGGTTTAGATGACAAGATCCTGACCTCTAGCTTGGGTCTG
CTATCCTAATGGAATAGGACTTATGAGGGCCTCAGGGAGTGGGGGTGAGT
GTAATTTGGACATGGAAGAATTGTAAATAGTCATACCCAGAGTGTAGCAG
GCAGTGATGGGttaaatatggctagacattttcgtcacgtctcccattga
gtggcagagttcatttccgctcccattgaatctagaatagcctgagcctt
gctttgcccaacgggacatagtagaagtgatgctgtataatgtctgaggc
tggggcttaggagagctcggcttcaggttgcagctccacaga(C/T)tcc
ctctcttggagctcagatgcagtgtcgtgagaaccccagtacttgcggtg
aggcaatggaaaggaactgaagtgcttctattgatgtctccagccgagct
cccagccaacagccagcaccgagtgccagtgtgtgagcaagtcaccaggg
atgtccagtcaagatgaaccttcagatgaccacagaacccagctgacatc
tcagggagtaaaactgtccagctgaacctcatcaccccactcaatcatga
gaactagttattttttacttaagccactttttttggggggcggtttgtcc
tgaagcaatagataattaaaacaAGCACCTTTCTTCCACTTTAACATTTT
TGATCTGGTTAAAACTCTCTTTCAAGTTAAAAATGACCCTGATCTTGCAT
GTTCCTCGTAAAAAAACAAGACCTCATGTACCTTTTAGGGGAGGGGCTAG
ACTTGACATTGCCATGGTAGGGAGGGATTGGGGCCGTTTATGAGA

The SNPs in the vicinity of the SNP rs2352946 which can provide information on the predisposition to prostate cancer are defined in our database according to the following table and are positioned in the interval 84695541-84776802 of chromosome 16.

| | | distance | |
|---|---|---|---|
| | | (bp) to the | location UCSC |
| SNP | chromosome | principal SNP | genome browser |
| rs16940461 | 16 | −62481 | chr16: 84695541-84696041 |
| rs4079379 | 16 | −43911 | chr16: 84714111-84714611 |
| rs11117451 | 16 | −37550 | chr16: 84720472-84720972 |
| rs2352933 | 16 | −36193 | chr16: 84721829-84722329 |
| rs8054806 | 16 | −32624 | chr16: 84725398-84725898 |
| rs7187622 | 16 | −15556 | chr16: 84742466-84742966 |
| rs2352934 | 16 | −13144 | chr16: 84744878-84745378 |
| rs17242223 | 16 | −2519 | chr16: 84755503-84756003 |
| rs2352946 | 16 | 0 | chr16: 84758022-84758522 |
| rs11117464 | 16 | 18280 | chr16: 84776302-84776802 |

SNP rs6755695 located in 2p12 on chromosome 2 between positions 79511959-79512459 according to the UCSC genome browser numbering, assembly of March 2006.

Genomic Sequence in the Vicinity of rs6755695, Polymorphic Nucleotide in Bold

Seq. Id. No. 28
CCTCTTTAAAGCTGGACTTTGAGGAGTTCAGATGACCAGGTATACACTCC
CTCCTGGTCAGTTAAAAGTTATACTCACCACTTTATCCTGATGTAATTTC
TTGAACCCACAGTGTCAGACACTGTTTTAGAGACCGGTAATGTTATTCTC
TTATTTGATATTCTTAAGAATTGCAACTACTTtatgagttagcctaatgc
aggtaacactgaggcaggaaaagaccccagagttagtgacatacaacagc
aaaggttgattgttgctcatgctgtagatctaatgcagatcagctgtggc
tctgctgtgcattgcctttgtcctgaaatctagactaaaagggcaCTTTT
GAATACAAAATTGCAAAGGAAAAAGAGACCCAGAAAACTATTCGCTCTTA
AAACTTGTCAGACAtgacacgtgttactcctgcccacatttcactgacca
aataagttag(A/G)tagtcacttctaagttcagtagggtggaaaaatat
aatcCTCCTGCAAGGAAGGACAGGGTAGAAAAATGGAATATATGGCTAGC
AGAAATGCAATCTGCAATGCACTATTTAGCCACCAAATATTTAGTTCCCT
CTCTCACCCATAGGCAGAACATACCTCCTTCCCTGAGGAGGCAACTCAAA
AGTCCTATTCAGTAATTGTTCTTAGCTTAAAAGTCAGGCTTTTCGGTGAT
GCAAATTTTTTTCACCATAGGCCTGTATGTT

The SNPs in the vicinity of the SNP rs6755695 which can provide information on the predisposition to prostate cancer are defined in our database according to the following table and are positioned in the interval 79446556-79664842 of chromosome 2.

| | | distance | location UCSC |
|---|---|---|---|
| | | (bp) to the | genome browser |
| SNP | chromosome | principal SNP | assembly March 2006 |
| rs1434173 | 2 | −65403 | chr2: 79446556-79447056 |
| rs10865443 | 2 | −7068 | chr2: 79504891-79505391 |
| rs6755695 | 2 | 0 | chr2: 79511959-79512459 |
| rs10496227 | 2 | 9898 | chr2: 79521857-79522357 |
| rs1864548 | 2 | 30871 | chr2: 79542830-79543330 |
| rs6719738 | 2 | 101537 | chr2: 79613496-79613996 |
| rs1864551 | 2 | 107836 | chr2: 79619795-79620295 |
| rs2566539 | 2 | 123044 | chr2: 79635003-79635503 |
| rs1972755 | 2 | 125486 | chr2: 79637445-79637945 |
| rs1549761 | 2 | 152383 | chr2: 79664342-79664842 |

SNP rs1138253 located in 19p13.3 on chromosome 19 between positions 4276183-4276683 according to the UCSC genome browser numbering, assembly of March 2006.

Genomic Sequence in the Vicinity of rs1138253, Polymorphic Nucleotide in Bold

Seq. Id. No. 29
ACCACGCCAAGCTAATTTTTGTATTTTTAGTAGAGACGGGGTTTCACCAT
ATTGGCCAGGCTGGTCTTGAACCCCTGACCTCAGGTGATCCGCCCACCCT
GGCCTCCCAAAGTGCTGGGATTACAGGCGTGAGCCACCGCGCCCGGCCCA
GACACAGACTTATACATGGGCACACACACAGACACACAGGGACACATGCC
TGTCTCCAGGCATCCACACAGACCCCCCCGCCAACCTGCAAGGTGTCCCT
GTATGACATGGGTCTTGACAGTGACCACGTTTCCCCATCAGGTCCTGCAC
CCTGCACAGGTGGCCCCAAGCCGCTGTCACCTGCGTCTAGCCAGGACAAG
CTGCCCCCACTGCCCCCACTACCGAACCAGGAAGAGAACTACGTGACCCC
(C/T)ATTGGAGATGGCCCAGCTGTTGACTATGAGAACCAAGATGGTGGG
TGGGGAACAGAGCTGCTGAGAGCTGGGGGTTGGGGAAACAGGTTAACAGC
TGATGTGACACGTTACACTTTTGTCCACGCAGTGGCTTCCTCTAGTTGGC
CAGTCATCCTGAAGCCAAAGAAGTTGCCAAAGCCTCCTGCCAAGCTTCCA
AAGCCACCCGTTGGACCCAAGCCAGGTTGGGGTCCCCCCCATATCCCACC
CTCACCTGATGGCAGGCCAGCCTCAGCCCTCATCTGACTTTTTTTTTTTT
TTTTGAGACAGTCTCACTCTGTCGCCCAGGCTGGAGTGCAGTGGCACAAC
CTTGGCTCACTGCAAGCTCCGCCTCCTGGGTTCACGCCATTCTCCTGCCT
CAGCC

The SNPs in the vicinity of the SNP rs1138253 which can provide information on the predisposition to prostate cancer are defined in our database according to the following table and are positioned in the interval 4098195-4506560 of chromosome 19.

| | | | location UCSC |
|---|---|---|---|
| | | distance (bp) to | genome browser |
| SNP | chromosome | the principal SNP | assembly March 2006 |
| rs350885 | 19 | −177988 | chr19: 4098195-4098695 |
| rs1138253 | 19 | 0 | chr19: 4276183-4276683 |
| rs4435380 | 19 | 10436 | chr19: 4286619-4287119 |
| rs12978346 | 19 | 15309 | chr19: 4291492-4291992 |
| rs8102860 | 19 | 20915 | chr19: 4297098-4297598 |
| rs10853973 | 19 | 229877 | chr19: 4506060-4506560 |

SNP rs10148742 located in 14q21.3 on chromosome 14 between positions 43356636-43357136 according to the UCSC genome browser numbering, assembly of March 2006.

Genomic Sequence in the Vicinity of rs10148742, Polymorphic Nucleotide in Bold

Seq. Id. No. 30
CAATAATATATGCTTTGTGCAATAGAAATATAACATTAACAAAACAATTT
AATGAATATTCTTGTCTGTATTTTTGAAAATATTTTCATTTAAGAAAGCT
CATAAGAATATAATTACTGGCCTAGGGTTTATTCAAAATTAAATATTTTT
AACCATCTTAAATTGTCCTCCAGAATTGTTGTATCCATTAATCCGAAATA
(A/C)CCTGCATGGAAGGGCCTTTTTGACAACATATTCATAACAATTTAA
TGCTATCTCTAACAGTTTGATGGGTTAGCTTCTCTATGTTAATTTACATT
TATCTGATTACTCTAAAATATGCATATCTTTCAAAGTATATTTGCCATTT
TTAGTTGTCTCTTTGTTCATATTAATTGTTTTTTTGGTTATTTGCTTGCT
TGTTTCAGTTTATTGCTTTGGTGGATGAGGTTTGTAAAATTCTAACATTT
TACTATACTTTTTAGTTCATGAATTT

The SNPs in the vicinity of the SNP rs10148742 which can provide information on the predisposition to prostate cancer are defined in our database according to the following table and are positioned in the interval 43257771-43665346 of chromosome 14.

| | | distance | location UCSC |
|---|---|---|---|
| | | (bp) to the | genome browser |
| SNP | chromosome | principal SNP | assembly March 2006 |
| rs1957265 | 14 | −98865 | chr14: 43257771-43258271 |
| rs10148742 | 14 | 0 | chr14: 43356636-43357136 |
| rs10484239 | 14 | 40413 | chr14: 43397049-43397549 |
| rs10484238 | 14 | 65146 | chr14: 43421782-43422282 |
| rs2208774 | 14 | 82396 | chr14: 43439032-43439532 |
| rs17309330 | 14 | 308210 | chr14: 43664846-43665346 |

SNP rs1773842 located in 10p11.23 on chromosome 10 between positions 29389042-29389542 according to the UCSC genome browser numbering, assembly of March 2006.

Genomic Sequence in the Vicinity of rs1773842, Polymorphic Nucleotide in Bold

Seq. Id. No. 31
TAATTGGTAATAAACTATGGTGCTTCCAAATAATGAAATTCTTTGTAGCC
ATTAAAAATGTTGCTATAGATCCCTATTTATGCTGTAACCTGCTCCATGC
TGAGCCACATTCCTGGTTCCCCTCCCTGCATTGCTTTTTCCCTAGCACGA
ATCCCTCAAATGTGCTCTGTAATTTATTCCTTCAATATCTGCATCCTTAT
CTGTAACTACCCGCTAGAATGTAAGCTCAGAGAGGACAGTGTTAAGTGTC
TTTCTTCTTGGATGTATCTCAACTGCCCAGAAAAATTCTTCACAAGAGTT
CTTGAGTAGGCACTCAATAAATATTTGTTGTAGGAGAGCAACTTAGAACC
AGAATTTCTGTGCAAAGAAGTATAAACATGTTCAAAACCTCTAGGGCATC
CTATAAAATTGTTTCTATGGAGATATATATACATTCACACTTTAAAAGGG
ACTTTTTAAAGCACCATGAAACATGCTCAGAGATGATAGATCATCAATAT
(C/T)TCCCCCCCGTTTTAGGATCTTCAGCAAAGCATAATGTGTTTTTTT
CTATCAGAACTTAAAAGAACACTTTGTTCTTCCACAATCTTTTTTTCACT
GTATGAACTTAAGACTGTTTTTTAAAAGTAAGCTCCTAGGATTTCCCTTT
ACAATCCAAATAGTTCCCTGACCTAGTCTAAAAGTCCTAATAAAGAGTTA
TTTTGAGATTGACTTTTCTTTTGTAGTTTTATATTTATTGCGTTTTAAGA
AAGCATCTCCCAGAAACATTGCATTAACAAAATAAAATCTAGGCCGGGTG
TGGTGGCTCACACCTGTAATCCCAGCACTTTGAGAGGCCGAGCCAGGCGG
ATCGCTTGAGCCCAGGAGTTTGAGACCAGCCTGGGCAACATAGGGAGACA
ATGTCTCTGCAAAAAGATATAAAAATTAGCCGGGCATGGTGACACGCAAC
TTTACTCCCAGCTACTTGAGAGGCTGAGGCAGGAGTATCGCTTGAGCCCG
GAAGG

The SNPs in the vicinity of the SNP rs1773842 which can provide information on the predisposition to prostate cancer are defined in our database according to the following table and are positioned in the interval 29356293-29651117 of chromosome 10.

| | | distance | location UCSC |
|---|---|---|---|
| | | (bp) to the | genome browser |
| SNP | chromosome | principal SNP | assembly March 2006 |
| rs2887372 | 10 | −32749 | chr10: 29356293-29356793 |
| rs1773842 | 10 | 0 | chr10: 29389042-29389542 |
| rs11597304 | 10 | 261575 | chr10: 29650617-29651117 |

The so-called cancer history variables and the age category variable may be combined with the SNPs mentioned above as input variables of algorithms of the logistic regression type MLP SVM RVM or another type of statistical learning algorithm. The classifiers thus obtained can be used as they are, but it is also possible to optimize the performance of the tool by producing meta-classifiers which have been developed by fusing the classifiers. This fusion operation is similar to that of variable selection, a step during which the optimization, with respect to a certain fusion criterion, comes from the search for complementarity between the classifiers: classifiers or meta-classifiers can then be used for carrying out a calculation of risk of prostate cancer.

Among all the possible combinations of input variables, in addition to the current biological and clinical data (such as the PSA), it would be possible not to use the family history or the age combined directly with the SNPs and to constitute a meta-classifier using them in a second step, but they were selected as being particularly relevant (all the nucleotide locations cited correspond to that defined by the UCSC genome browser, assembly of March 2006):

the combination of the four cancer history variables, that is to say family history of prostate cancer, family history of breast cancer, personal history of cancer, family history of other cancers, and an age category variable;

the combination of the four cancer history variables, an age category variable and a variable defining the genotype linked to the SNP rs2174183 or to one of its neighbors in the interval 127602673-128447913 of chromosome 4;

the combination of the four cancer history variables, an age category variable, a variable defining the genotype linked to the SNP rs2174183 and/or or to one or more of its neighbors in the interval 127602673-128447913 of chromosome 4 and/or a variable defining the genotype linked to the SNP rs7576160 and/or to one or more of its neighbors in the interval 37855761-38126567 of chromosome 2 and/or a variable defining the genotype linked to the SNP rs2012385 and/or to one or more of its neighbors in the interval 241767109-242119399 of chromosome 2;

the combination of the four cancer history variables, an age category variable, a variable defining the genotype linked to the SNP rs2174183 and/or to one or more of its neighbors in the interval 127602673-128447913 of chromosome 4 and/or a variable defining the genotype linked to the SNP rs2190453 and/or to one or more of its neighbors in the interval 17464539-17757162 of chromosome 11 and/or a variable defining the genotype linked to the SNP rs888298 and/or to one or more of its neighbors in the interval 63815611-64165896 of chromosome 17;

the combination of the four cancer history variables, an age category variable, a variable defining the genotype linked to the SNP rs2174183 and/or to one or more of its neighbors in the interval 127602673-128447913 of chromosome 4 and/or a variable defining the genotype linked to the SNP rs2788140 and/or to one or more of its neighbors in the interval 210157195-210446272 of chromosome 1 and/or a variable defining the genotype linked to the SNP rs7934514 and/or to one or more of its neighbors in the interval 99092040-99333419 of chromosome 11;

the combination of the four cancer history variables, an age category variable, a variable defining the genotype linked to the SNP rs2174183 and/or to one or more of its neighbors in the interval 127602673-128447913 of chromosome 4 and/or a variable defining the genotype linked to the SNP rs3828054 and/or to one or more of its neighbors in the interval 149382371-149874970 of chromosome 1 and/or a variable defining the genotype linked to the SNP rs1499955 and/or to one or more of its neighbors in the interval 116302446-117011700 of chromosome 3;

the combination of the four cancer history variables, an age category variable, a variable defining the genotype linked to the SNP rs2352946 and/or to one or more of its neighbors in the interval 84695541-84776802 of chromosome 16 and a variable defining the genotype linked to the SNP rs6755695 and/or to one or more of its neighbors in the interval 79446556-79664842 of chromosome 2 and a variable defining the genotype linked to the SNP rs1138253 and/or to one or more of its neighbors in the interval 4098195-4506560 of chromosome 19;

the combination of the four cancer history variables, an age category variable, a variable defining the genotype linked to the SNP rs2174183 and/or to one or more of its neighbors in the interval 127602673-128447913 of chromosome 4 and a variable defining the genotype linked to the SNP rs8110935 and/or to one or more of its neighbors in the interval 62026584-62294837 of chromosome 19;

the combination of the four cancer history variables, an age category variable, a variable defining the genotype linked to the SNP rs2174183 and/or to one or more of its neighbors in the interval 127602673-128447913 of chromosome 4 and a variable defining the genotype linked to the SNP rs4855539 and/or to one or more of its neighbors in the interval 69049525-69153397 of chromosome 3 and a variable defining the genotype linked to the SNP rs4242382 and/or to one or more of its neighbors in the interval 128539973-128619555 of chromosome 8;

the combination of the four cancer history variables, an age category variable, a variable defining the genotype linked to the SNP rs2174183 and/or to one or more of its neighbors in the interval 127602673-128447913 of chromosome 4 and a variable defining the genotype linked to the SNP rs11526176 and/or to one or more of its neighbors in the interval 27414591-27808301 of chromosome 7;

the combination of the four cancer history variables, an age category variable, a variable defining the genotype linked to the SNP rs6492998 and/or to one of its neighbors in the interval 38991207-39584443 of chromosome 15 and/or a variable defining the genotype linked to the SNP rs11526176 and/or to one or more of its neighbors in the interval 27414591-27808301 of chromosome 7 and/or a variable defining the genotype linked to the SNP rs6681102 and/or to one of its neighbors in the interval 236815776-236998150 of chromosome 1;

the combination of the four cancer history variables, an age category variable, a variable defining the genotype linked to the SNP rs2048873 and/or to one or more of its neighbors in the interval 113062733-113411386 of chromosome 2 and/or a variable defining the genotype linked to the SNP rs6804627 and/or to one or more of its neighbors in the interval 60928379-60979489 of chromosome 3 and a variable defining the genotype linked to the SNP rs10245886 and/or to one of its neighbors in the interval 47461234-47557773 of chromosome 7;

the combination of the four cancer history variables, an age category variable, a variable defining the genotype linked to the SNP rs1511695 and/or to one or more of its neighbors in the interval 218280585-218521047 of chromosome 1 and a variable defining the genotype linked to the SNP rs4669835 and/or to one or more of its neighbors in the interval 12111054-12324507 of chromosome 2 and/or a variable defining the genotype linked to the SNP rs12605415 and/or to one of its neighbors in the interval 23907695-24187878 of chromosome 18;

the combination of the four cancer history variables, an age category variable, a variable defining the genotype linked to the SNP rs749915 and/or to one or more of its neighbors in the interval 39097014-39163238 of chromosome 4 and/or a variable defining the genotype linked to the SNP rs13226041 and/or to one or more of its neighbors in the interval 104002818-104863625 of chromosome 7 and/or a variable defining the genotype linked to the SNP rs721429 and/or to one or more of its neighbors in the interval 61335448-62195826 of chromosome 17;

the combination of the four cancer history variables, an age category variable, a variable defining the genotype linked to the SNP rs4242384 and/or one or more of its neighbors in the interval 128539973-128619555 of chromosome 8 and a variable defining the genotype linked to the SNP rs9364048 and/or to one of its neighbors in the interval 70074721-70679396 of chromosome 6;

the combination of the four cancer history variables, an age category variable, a variable defining the genotype linked to the SNP rs2352946 and/or to one or more of its neighbors in the interval 84695541-84776802 of chromosome 16 and a variable defining the genotype linked to the SNP rs6755695 and/or to one or more of its neighbors in the interval 79446556-79664842 of chromosome 2 and a variable defining the genotype linked to the SNP rs1138253 and/or to one of its neighbors in the interval 4098195-4506560 of chromosome 19;

the combination of the four cancer history variables, an age category variable, a variable defining the genotype linked to the SNP rs13148138 and/or to one or more of its neighbors in the interval 127602673-128447913 of chromosome 4 and/or a variable defining the genotype linked to the SNP rs1773842 and/or to one or more of its neighbors in the interval 29356293-29651117 of chromosome 10 and a variable defining the genotype linked to the SNP rs10148742 and/or to one or more of its neighbors in the interval 43257771-43665346 of chromosome 14.

On the basis of the SNP list presented, there is a high probability of relevant information on predisposition to breast cancer and to other forms of cancer being obtained on the principle of the same invention. In order to verify it, it would be necessary to put together a database of examples of patients and of controls suffering from the form of cancer of interest, to form their medical files and either to reiterate the combinations of input variables that we have given or to re-initiate a small process of variable selection in order to reform small, more specific combinations. A process of statistical learning and of meta-modeling could then be re-initiated. Since the various forms of cancer share tumorigenesis mechanisms, it is probable that the relevant information can be obtained in this way.

Example of a Method According to the Invention Using Certain SNP Selections and Comparison with Prediction Methods of the Known Art:

According to one method example, the present invention was developed in two steps, one aimed at selecting the relevant genetic markers that constitute the core of the tool and a second step consisting in carrying out the mathematical modeling that can take them into consideration in order to establish a risk calculation.

The method of the present invention was developed on the basis of the following steps: with data specific to the Centre de Recherche pour les Pathologies Prostatiques “CeRePP” [Prostate Disease Research Center], established by Professor Cussenot and collaborators thereof, 1315 individuals having given their consent were referenced, they belong to two separate categories: patients suffering from prostate cancer and controls. In order to limit the appearance of statistical biases, the two categories of individuals were paired in the best way possible, the most obvious example of a variable to be equilibrated being, for example, age.

Since the probability of developing prostate cancer varies with age, patients and controls should have age distributions as close as possible, otherwise the artifact linked to this statistical bias with respect to age may be unduly exploited by the statistical learning algorithms, as a discriminating variable, leading to incorrect modeling.

The medical files of the patients contain the status with respect to prostate cancer, the family history of prostate cancer, the family history of breast cancer, the family history of other cancers, and the personal history of cancer.

The individuals considered were then genotyped sufficiently thoroughly to cover the entire genome. With regard to the analysis, the applicant was able to provide individual genotypes for 27188 SNPs distributed over the 24 chromosomes of the human genome.

The 27188 SNPs and also the other variables were then subjected to a process of variable selection with the use, for example:
of the genetic algorithms as described by Krause, Rüdiger and Tutz, Gerhard (2004): Variable selection and discrimination in gene expression data by genetic algorithms. Sonderforschungsbereich 386, Discussion Paper 390;
of a variable selection implementing mutual information calculation as described by A. Kraskov et al., Estimating mutual information, Physical Review, 2004, 66138, and B. V. Bonnlander et al., Selecting Input Variables Using Mutual Information and Nonparametric Density Estimation.

Genetic algorithms belong to the evolutionary algorithm family. Their name does not come from the possible applications in the field of genetics, but from an analogy between how they operate and the theories of evolution of the living world. They are generally used to solve optimization problems. The principle is to generate a population of potential solutions in the solution search space. Each potential solution is evaluated by a function, known as “fitness” function, adapted to the problem to be treated. At each iteration of the algorithm, new potential solutions are generated in the search space by selecting the best solutions of the preceding iteration and making use of two other functions, namely combinations and mutations. More specifically:
“selection” is intended to mean: a selection of the best solutions, carried out via, for example, the fitness function. This process is inspired by that of natural selection, only the best-adapted individuals participate in reproduction, thereby improving, from generation to generation, the overall adaptation of the population;
recombination: this operation consists in mixing the characteristics of two potential solutions adopted in the selection phase. This operation corresponds to the reproduction phase which consists in creating a new potential solution from two existing adopted solutions;
mutation: this operation consists in changing a part of the characteristics of a potential solution in a random manner with a relatively low degree of mutation so as not to fall into a random search. Mutation allows the algorithm not to prematurely converge toward a local extreme.

These operations are inspired by the theory of evolution in order to cause the solution population to gradually evolve toward the optimum solution. These genetic algorithms can therefore be used in the variable-selection phase, where each potential solution is a model constructed from a set of variables. Only the sets of variables which make it possible to obtain the best models are used.

Mutual information is a measure derived from information theory which consists in quantifying the mutual dependence of two random variables (or groups of random variables).

More strictly, the mutual information of two random variables X and Y is defined in the following way:

$$I ( X , Y ) = {\int }_{Y} {\int }_{X} p ( x , y ) log ( \frac{p ( x , y )}{p ( x ) \cdot p ( y )} ) d x d y$$

where p(x,y) is the joint probability of X and Y, and where p(x) and p(y) are, respectively, the marginal probabilities of X and of Y. In the context of discrete random variables, the integrals are replaced with the sum in the following way:

$$I ( X , Y ) = {\sum }_{y ∈ Y} {\sum }_{x ∈ X} p ( x , y ) log ( \frac{p ( x , y )}{p ( x ) \cdot p ( y )} )$$

The mutual information quantifies the mutual dependence of two random variables X, Y or two groups of variables X, Y, i.e., in which measure knowledge regarding X reduces the uncertainty regarding Y. This mutual information calculation can therefore be used in the context of a selection of variables using this measure to determine the mutual dependence of a variable, or a group of variables (in this case, the SNPs), with the output (the status).

The first step in the work carried out by the applicant therefore consisted of a variable selection or dimension reduction.

It was thus able to isolate SNPs in small groups. The originality of these groups lies in the complementarity or the synergy between the SNPs that the algorithm calculations made it possible to demonstrate.

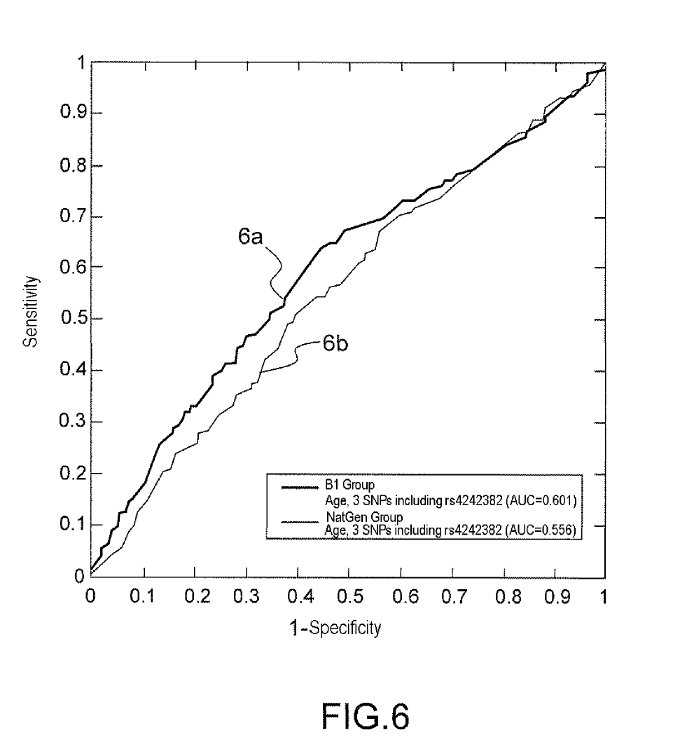

In addition to the SNPs discovered by virtue of implementing the methods described in the present invention, mention may be made of the example of the SNP rs4242382 which was already identified in the literature, and in particular in the article by G. Thomas et al., Multiple loci identified in a genome-wide association study of prostate cancer, Nature Genetics, vol 40, num3, March 2008. In this article, the SNPs are selected on the basis of their p-value. The authors thus identified the SNP rs4242382 as the applicant identified also by means of its methods. On the other hand, said methods made it possible to identify a synergy between this SNP and two other SNPs among the 27188 SNPs available in the base. This group of 3 SNPs is identified as group B1. The applicant then compared the performances obtained by the models constructed from group B1 with the performances of the models constructed from the best 3 SNPs, in the sense of the p-values, of the Nature Genetics article. The results are presented in FIG. 6, and more specifically curves 6a and 6b, which are the ROC curves relating to the B1 model and to the Nature Genetics model which obtain, respectively, AUCs of 0.601 and 0.556. This result shows that group B1, containing 3 SNPs in synergy, including rs4242382, discovered by carrying out the methods of the invention, gives a better performance than the grouping of the best 3 SNPs available in the abovementioned Nature Genetics article.

Some of the SNPs selected in the present invention, such as rs2174183, are not directly located in a gene; the biological function to which it is linked is unknown and could be elucidated with knowledge of complex regulations such as epigenetic regulations or microRNA, which are entirely new, and which are emerging in the cancerogenesis field.

These groups of SNPs discovered (each group contains a few SNPs) possibly in synergy with “history” and “age” variables, were then used as input data for the construction of models of patient/control discrimination by statistical learning.

At this stage, it is possible to establish the performance of the discrimination by means of a ROC curve. At the end of this modeling and validation phase, a statistical model is provided which has been constructed from input data of SNP and/or age and/or history type and which can be used on new data of the same types in order to estimate the status of an individual when the latter is unknown. The models therefore make it possible to recognize an individual who is at risk of prostate cancer according to certain performances illustrated by the ROC curves. It was thus possible to provide a series of models which themselves served as input data for establishing a meta-model by “fusion” techniques.

The result is a method for the discrimination of individuals suffering or not suffering from prostate cancer, which is original by virtue of the variable-selection methods used, the SNPs and the combinations of which it is constituted, the modeling and then the meta-modeling, or fusion, carried out and also the extent of the performances obtained.

The age of the patients and the family history of cancer, carefully encoded, are represented in the input data. This is because interactions were found between these variables and the SNPs that were discovered. While it was known that the history contains information that is highly predictive with respect to the risk of prostate cancer (and, moreover, the risk of cancer in general), it is the interaction with the SNPs that were discovered that constitutes the added value of our work.

The invention can therefore be presented in the following way:
A list of SNPs discovered by means of a variable-selection process which, in addition to the selection for the intrinsic predictive value of the SNP, makes it possible to guarantee synergy between the SNPs selected, but can also make it possible to guarantee synergy with the cancer history variables and clinical variables.
One or more models constructed by statistical learning from all or part of the variables described in the previous point, making it possible to estimate the status for unknown individuals.
One or more meta-models constructed from the models described in the previous point.

The particular feature of the invention is to make it possible to discriminate individuals suffering from prostate cancer and healthy individuals, i.e., when the individuals are of unknown status, it makes it possible to identify those having a healthy-individual or affected-individual profile, and the degree of predisposition of said individuals to prostate cancer. For practical use, the degree of predisposition to prostate cancer may be given, for example, by means of a calculation of risk at a given age, by means of a curve of risk variation as a function of age, the tool as a whole finally taking the form of a practical application.

The alleles at risk are unspecified for each SNP; this knowledge, which is advantageous for studying the biological mechanism involved, is not essential to the operating of the invention, since it is, in the end, a very complex combination of the value of each input variable that can be associated with a particular risk. Thus, in a group containing three different SNPs, chosen as input variables, each one can be represented by two different alleles, which represent 3 genotypes per SNP and 27 different genetic profiles when combining the whole (3 SNP1 genotypes×3 SNP2 genotypes×3 SNP3 genotypes). The risk information with the best performance is linked to each particular combination among 27. For about ten combinations of SNPs distributed over several groups, it will therefore be necessary to clarify 270 genotypes, which is not necessary for correct operating of the invention and which was not necessary for its design since it is precisely a question of automatic learning, and the algorithms used establish and use the relevant genotype-risk association rules.

In order to use the invention, it is necessary to know the genetic profile of an individual and to have collected the biological data thereof. This can currently be carried out simply by those skilled in the art. For this, it is necessary to collect a sample of body fluid or tissues, to extract the DNA therefrom by means of a process well known to those skilled in the art of molecular biology, and to establish the genotype of each individual with respect to the SNPs of interest by means of a method to be chosen from the various technologically or commercially available solutions; simply, PCR TaqMan® (Applied Biosystems) genotyping techniques or conventional DNA sequencing techniques can be used.

The results obtained with the method of the invention are compared with those obtained and published by Zheng S L, Sun J, Wiklund F, et al., Cumulative association of five genetic variants with prostate cancer. NEngl JMed 2008; 358:910-9. The efficiency of the SNP selection carried out in the context of the invention is also compared with the efficiency of the selection carried out and published in the article G. Thomas et al., Multiple loci identified in a genome-wide association study of prostate cancer, Nature Genetics, vol 40, num3, March 2008.

In the remainder of the description, the following model names are agreed:
NEJM: model constructed with: Age, Atcd, rs4430796, rs1859962, rs16901979, rs6983267 and rs1447295, described in Zheng S L, Sun J, Wiklund F, et al., Cumulative association of five genetic variants with prostate cancer. NEngl JMed 2008; 358:910-9;
NG1: model constructed with Age, Atcd, rs4242382, rs10993994, rs6983267 described in G. Thomas et al., Multiple loci identified in a genome-wide association study of prostate cancer, Nature Genetics, vol 40, num3, March 2008;
NG2: model constructed with Age, Atcd, rs4242382, rs10993994, rs6983267, rs4430796, rs10896449, rs4962416, rs10486567 described in G. Thomas et al., Multiple loci identified in a genome-wide association study of prostate cancer, Nature Genetics, vol 40, num3, March 2008;
PSA: AUC of the PSA test as carried out at the current time, described in I. M. Thompson et al., Operating Characteristics of prostate-specific antigen in men with an initial PSA level of 3.0 ng/mL or Lower, JAMA, vol 294, num1, 2005;
D2: model constructed with Age, Atcd and 3 of the SNPs selected by the methods of the present invention;
B2: model constructed with Age, Atcd and 7 of the SNPs selected by the methods of the present invention;
Fusion: a meta-model of fusion of the present invention.

The first article relates to 5 SNPs having a link with prostate cancer. According to the authors, each SNP has a moderate link, but when the 5 SNPs are combined, the predictive capacity of the models is improved.

The following SNPs are involved: rs4430796, rs1859962, rs16901979, rs6983267 and rs1447295.

The authors use age, region, family history identified in terms of antecedents, called “Atcd”, and the five SNPs to construct their models (identified as model 3 in the article). They obtain an AUC for this model of 0.633 (the confidence interval at 95% being 0.617 to 0.65).

The aim of the comparison is to determine the provision of information linked to the addition of the SNPs described in the article and the provision of information linked to the addition of the SNPs obtained on the basis of the methods described in the present invention.

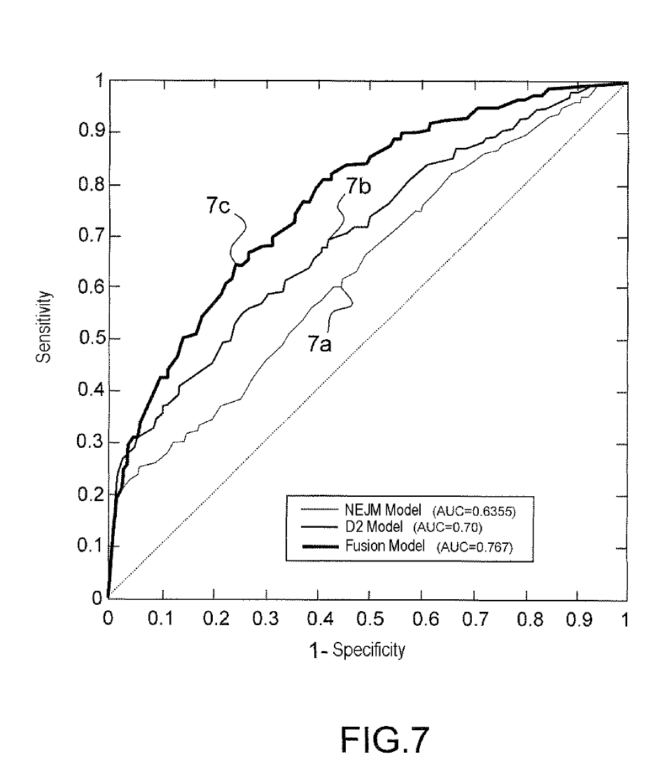

The comparison is carried out according to several steps:
Creation of a model constructed from the SNPs of the article: the applicant created a model (called NEJM model) on the basis of the 5 SNPs of the article mentioned above and the history and age variables of its own base. The applicant obtained, with this NEJM model, an AUC of 0.636, as illustrated in FIG. 7, which is found to be in the confidence interval of model 3 of the abovementioned article.
Construction of a model based on SNPs obtained using the selection methods of the present invention: the applicant created a model on the basis of one of its groups of SNPs containing 3 SNPs and the history and age variables of its own base (identified as D2 model).
Model comparison: it is then possible to compare, using ROC curves (sensitivity as a function of specificity), the performance of the model obtained from the SNPs of the abovementioned article (NEJM model) with models based on the applicant's own SNPs (D2 model and fusion model).

The results are presented in FIG. 7 and, more specifically, curves 7a, 7b and 7c are, respectively, the ROC curves for the models termed NEJM, D2 and Fusion, which obtain, respectively, AUCs of 0.636, 0.70 and 0.767.

Finally, the applicant compared models constructed with the same SNP groups (NEJM and D2) without using the history variables in order to measure the provision from the SNPs alone.

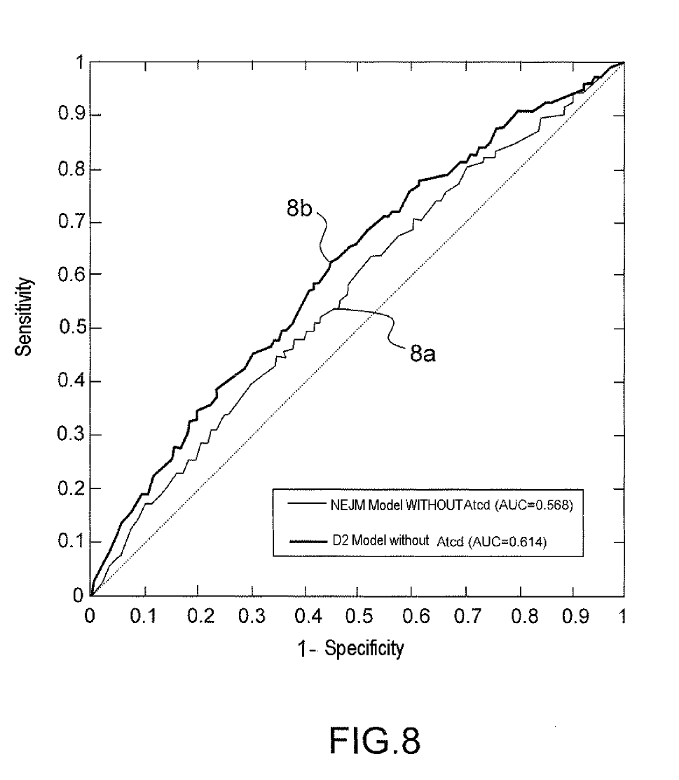

The results are presented in FIG. 8 and, more specifically, curves 8a and 8b are, respectively, the ROC curves relating to the NEJM and D2 models without Atcd, which obtain, respectively, AUCs of 0.568 and 0.614.

It should also be noted that the performances of the model of the present invention are better with fewer SNPs. Specifically, the NEJM model contains 5 SNPs, whereas the D2 model of the invention contains only 3 SNPs. This comparison makes it possible to conclude that the SNP selection described in the present invention makes it possible to create models which obtain better AUCs and therefore have a greater capacity for discrimination.

The applicant also established comparisons with the results published in the study by G. Thomas et al., Multiple loci identified in a genome-wide association study of prostate cancer, Nature Genetics, vol 40, num3, March 2008.

The team which published this study is part of the CGEMS consortium, i.e. they use the same 27188 SNPs as those presented in the present invention, but on different populations. Their strategy for detecting the SNPs of interest is based on calculating the p-values (statistical test). The aim of the comparison is to determine the provision of information linked to the addition of the SNPs described in the article and the provision of information linked to the addition of the SNPs obtained using the methods described in the present invention.

The comparison is carried out according to several steps:
Creation of a model based on SNPs of the article: the applicant created a model (called NG1 model) using the history and age variables and the best 3 SNPs, in the sense of the p-values (the 3 SNPs for which the p-values are the lowest), as indicated in the abovementioned Nature Genetics article. The following SNPs are involved: rs4242382, rs10993994 and rs6983267.
Creation of a model based on SNPs obtained using the selection methods of the present invention: the applicant created a model on the basis of one of its groups of SNPs containing 3 SNPs and the history and age variables of its own base (identified as D2 model).
Model comparison: it is then possible to compare, using ROC curves, the performance of the model obtained from the SNPs of the abovementioned article (NG1 model) with the models based on the applicant's own SNPs (D2 model and fusion model).

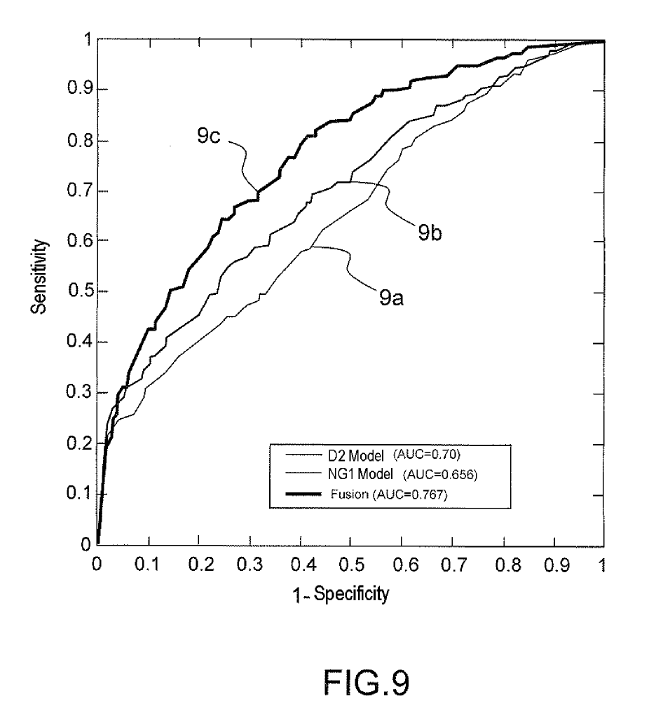

The results are presented in FIG. 9 and, more specifically, curves 9a, 9b and 9c are, respectively, the ROC curves relating to the NG1, D2 and Fusion models, which obtain, respectively, AUCs of 0.656, 0.70 and 0.767.

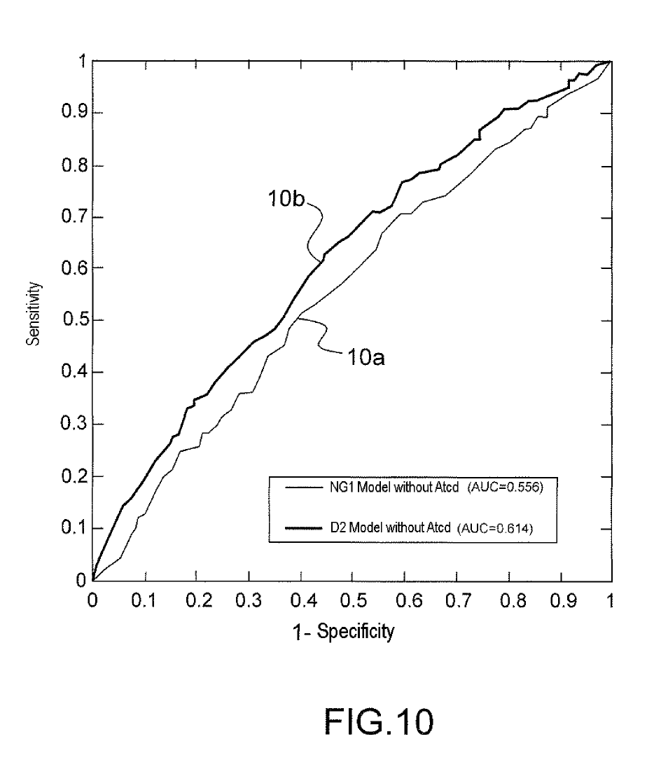

A comparison with the same NG1 and D2 groups was carried out by the applicant without using the history variables. The results are presented in FIG. 10 and curves 10a and 10b, respectively, relating to the NG1 and D2 models without history, which obtain, respectively, AUCs of 0.556 and 0.614.

Finally, the applicant carried out a comparison of the same type on the basis of the best 7 SNPs of the Nature Genetics article. The experimental procedure is identical:
Creation of a model based on SNPs of the article: the applicant created a model (called NG2 model) using the history and age variables and the best 7 SNPs, in the sense of the p-values, as indicated in the abovementioned Nature Genetics article. The following SNPs are involved: rs4242382, rs10993994, rs6983267, rs4430796, rs10896449, rs4962416 and rs10486567.
Creation of a model based on SNPs obtained using the selection methods of the present invention: the applicant created a model on the basis of 7 SNPs obtained using its methods and the history and age variables of its own base (identified as B2 model).
Model comparison: it is then possible to compare, using ROC curves, the performance of the model obtained from the SNPs of the abovementioned article (NG2 model) with the model based on the applicant's own SNPs (B2 model).

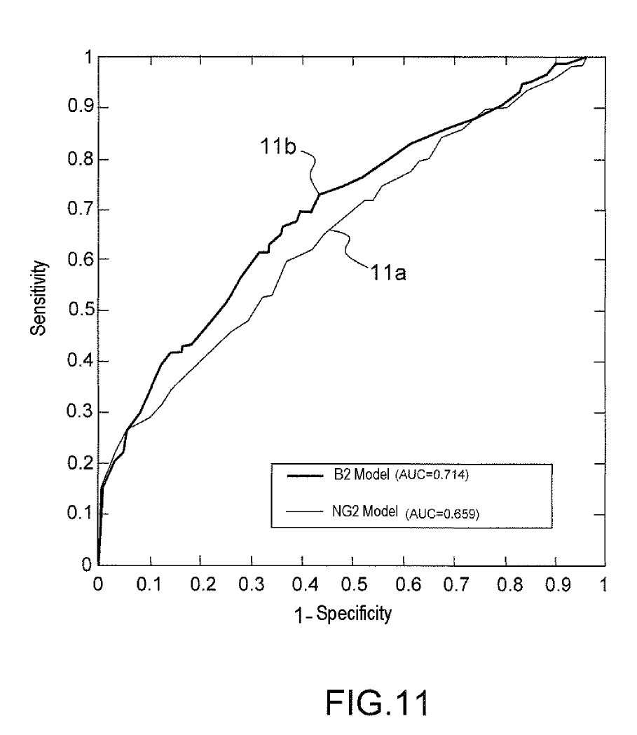

The results are presented in FIG. 11 and curves 11a and 11b, respectively, relating to the NG1 and B2 models, which obtain, respectively, AUCs of 0.659 and 0.714.

In conclusion, it appears that, in any event, the models of the present invention have better performance levels than those constructed from the SNPs of the known art.

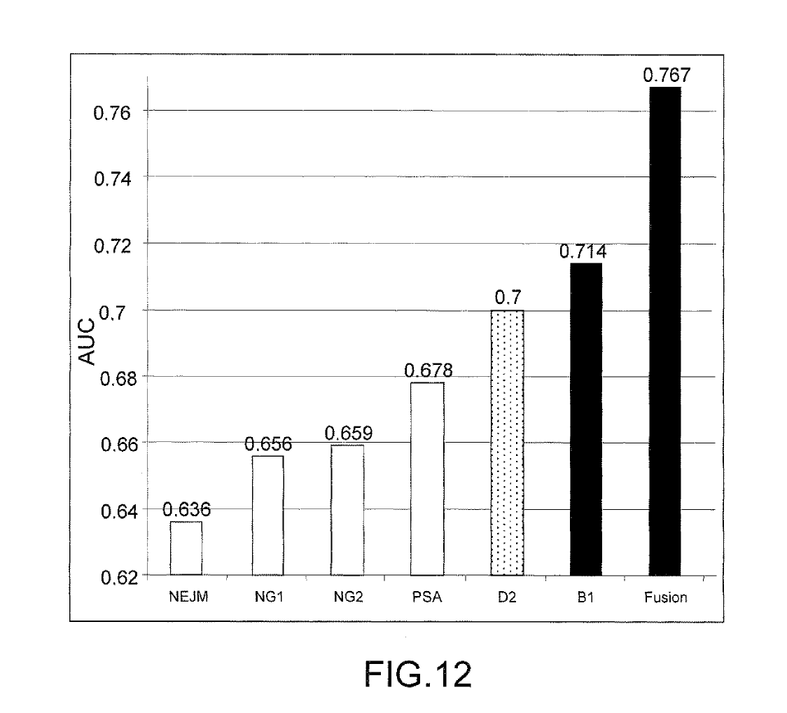

FIG. 12 illustrates the performances in terms of AUC of the models described above.

1. An individual prediction method for the screening or diagnosis or therapeutic management or prognosis of prostate cancer, comprising collecting individual input data (xᵢ) and providing predictive information on the risk (y) linked to a type of disease, wherein:
representative information, which is genetic information and results of clinical information on a patient, is collected in order to obtain said individual data, said clinical information comprising at least the age of the patient;
the individual data (xᵢ) are acquired using data acquisition means;
a prediction tool is produced by constructing at least one model by statistical learning, the input variables of this model being said representative information and the model by statistical learning being non-linear with respect to its parameters; and
the genetic input information comprises at least one variable or a combination of variables among the following (all the nucleotide locations cited correspond to those defined by the “UCSC genome browser”, assembly of March 2006) and having a link to prostate cancer:
variable defining the genotype linked to the SNP rs2174183 and/or to one or more of its neighbors in the interval 127602673-128447913 of chromosome 4;
variable defining the genotype linked to the SNP rs7576160 and/or to one or more of its neighbors in the interval 37855761-38126567 of chromosome 2;
variable defining the genotype linked to the SNP rs2012385 and/or to one or more of its neighbors in the interval 241767109-242119399 of chromosome 2;
variable defining the genotype linked to the SNP rs888298 and/or to one or more of its neighbors in the interval 63815611-64165896 of chromosome 17;
variable defining the genotype linked to the SNP rs8110935 and/or to one or more of its neighbors in the interval 62026584-62294837 of chromosome 19;
variable defining the genotype linked to the SNP rs2190453 and/or to one or more of its neighbors in the interval 17464539-17757162 of chromosome 11;
variable defining the genotype linked to the SNP rs2788140 and/or to one or more of its neighbors in the interval 210157195-210446272 of chromosome 1;
variable defining the genotype linked to the SNP rs3828054 and/or to one or more of its neighbors in the interval 149382371-149874970 of chromosome 1;
variable defining the genotype linked to the SNP rs1499955 and/or to one or more of its neighbors in the interval 116302446-117011700 of chromosome 3;
variable defining the genotype linked to the SNP rs4855539 and/or to one or more of its neighbors in the interval 69049525-69153397 of chromosome 3;
variable defining the genotype linked to the SNP rs11526176 and/or to one or more of its neighbors in the interval 27414591-27808301 of chromosome 7;
variable defining the genotype linked to the SNP rs7934514 and/or to one or more of its neighbors in the interval 99092040-99333419 of chromosome 11;
variable defining the genotype linked to the SNP rs6681102 and/or to one or more of its neighbors in the interval 236815776-236998150 of chromosome 1;
variable defining the genotype linked to the SNP rs6492998 and/or to one or more of its neighbors in the interval 38991207-39584443 of chromosome 15;
variable defining the genotype linked to the SNP rs2048873 and/or to one or more of its neighbors in the interval 113062733-113411386 of chromosome 2;
variable defining the genotype linked to the SNP rs4669835 and/or to one or more of its neighbors in the interval 12111054-12324507 of chromosome 2;
variable defining the genotype linked to the SNP rs12605415 and/or to one or more of its neighbors in the interval 23907695-24187878 of chromosome 18;
variable defining the genotype linked to the SNP rs749915 and/or to one or more of its neighbors in the interval 39097014-39163238 of chromosome 4;
variable defining the genotype linked to the SNP rs13226041 and/or to one or more of its neighbors in the interval 104002818-104863625 of chromosome 7;
variable defining the genotype linked to the SNP rs721429 and/or to one or more of its neighbors in the interval 61335448-62195826 of chromosome 17;
variable defining the genotype linked to the SNP rs2352946 and/or to one or more of its neighbors in the interval 84695541-84776802 of chromosome 16;
variable defining the genotype linked to the SNP rs9364048 and/or to one or more of its neighbors in the interval 70074721-70679396 of chromosome 6;
variable defining the genotype linked to the SNP rs6755695 and/or to one or more of its neighbors in the interval 79446556-79664842 of chromosome 2;
variable defining the genotype linked to the SNP rs1138253 and/or to one or more of its neighbors in the interval 4098195-4506560 of chromosome 19;
variable defining the genotype linked to the SNP rs1773842 and/or to one or more of its neighbors in the interval 29356293-29651117 of chromosome 10;
variable defining the genotype linked to the SNP rs10148742 and/or to one or more of its neighbors in the interval 43257771-43665346 of chromosome 14;
variable defining the genotype linked to the SNP rs10245886 and/or to one or more of its neighbors in the interval 47461234-47557773 of chromosome 7.

2. The individual prediction method for the screening or diagnosis or therapeutic management or prognosis of prostate cancer as claimed in claim 1, further comprising a first step of selecting genetic input data by algorithms capable of detecting synergies between several variables.

3. The individual prediction method for the screening or diagnosis or therapeutic management or prognosis of prostate cancer as claimed in claim 1, wherein the information of clinical type comprises information of cancer type.

4. The individual prediction method for the screening or diagnosis or therapeutic management or prognosis of prostate cancer as claimed in claim 1, wherein the input data correspond to the combination of a variable defining the genotype linked to the SNP rs2174183 and/or to one or more of its neighbors in the interval 127602673-128447913 of chromosome 4 and/or of a variable defining the genotype linked to the SNP rs7576160 and/or to one or more of its neighbors in the interval 37855761-38126567 of chromosome 2 and/or of a variable defining the genotype linked to the SNP rs2012385 and/or to one or more of its neighbors in the interval 241767109-242119399 of chromosome 2.

5. The individual prediction method for the screening or diagnosis or therapeutic management or prognosis of prostate cancer as claimed in claim 1, wherein the input data correspond to the combination of a variable defining the genotype linked to the SNP rs2174183 and/or to one or more of its neighbors in the interval 127602673-128447913 of chromosome 4 and/or of a variable defining the genotype linked to the SNP rs2190453 and/or to one or more of its neighbors in the interval 17464539-17757162 of chromosome 11 and/or of a variable defining the genotype linked to the SNP rs888298 and/or to one or more of its neighbors in the interval 63815611-64165896 of chromosome 17.

6. The individual prediction method for the screening or diagnosis or therapeutic management or prognosis of prostate cancer as claimed in claim 1, wherein the input data correspond to the combination of a variable defining the genotype linked to the SNP rs2174183 and/or to one or more of its neighbors in the interval 127602673-128447913 of chromosome 4 and/or of a variable defining the genotype linked to the SNP rs2788140 and/or to one or more of its neighbors in the interval 210157195-210446272 of chromosome 1 and/or of a variable defining the genotype linked to the SNP rs7934514 and/or to one or more of its neighbors in the interval 99092040-99333419 of chromosome 11.

7. The individual prediction method for the screening or diagnosis or therapeutic management or prognosis of prostate cancer as claimed in claim 1, wherein the input data correspond to the combination of a variable defining the genotype linked to the SNP rs2174183 and/or to one or more of its neighbors in the interval 127602673-128447913 of chromosome 4 and/or of a variable defining the genotype linked to the SNP rs3828054 and/or to one or more of its neighbors in the interval 149382371-149874970 of chromosome 1 and/or of a variable defining the genotype linked to the SNP rs1499955 and/or to one or more of its neighbors in the interval 116302446-117011700 of chromosome 3.

8. The individual prediction method for the screening or diagnosis or therapeutic management or prognosis of prostate cancer as claimed in claim 1, wherein the input data correspond to the combination of a variable defining the genotype linked to the SNP rs2174183 and/or to one or more of its neighbors in the interval 127602673-128447913 of chromosome 4 and of a variable defining the genotype linked to the SNP rs8110935 and/or to one or more of its neighbors in the interval 62026584-62294837 of chromosome 19.

9. The individual prediction method for the screening or diagnosis or therapeutic management or prognosis of prostate cancer as claimed in claim 1, wherein the input data correspond to the combination of a variable defining the genotype linked to the SNP rs2174183 and/or to one or more of its neighbors in the interval 127602673-128447913 of chromosome 4 and of a variable defining the genotype linked to the SNP rs4855539 and/or to one or more of its neighbors in the interval 69049525-69153397 of chromosome 3 and of a variable defining the genotype linked to the SNP rs4242382 and/or to one or more of its neighbors in the interval 128539973-128619555 of chromosome 8.

10. The individual prediction method for the screening or diagnosis or therapeutic management or prognosis of prostate cancer as claimed in claim 1, wherein the input data correspond to the combination of a variable defining the genotype linked to the SNP rs2174183 and/or to one or more of its neighbors in the interval 127602673-128447913 of chromosome 4 and of a variable defining the genotype linked to the SNP rs11526176 and/or to one or more of its neighbors in the interval 27414591-27808301 of chromosome 7.

11. The individual prediction method for the screening or diagnosis or therapeutic management or prognosis of prostate cancer as claimed in claim 1, wherein the input data correspond to the combination of a variable defining the genotype linked to the SNP rs6492998 and/or to one of its neighbors in the interval 38991207-39584443 of chromosome 15 and/or of a variable defining the genotype linked to the SNP rs11526176 and/or to one or more of its neighbors in the interval 27414591-27808301 of chromosome 7 and/or of a variable defining the genotype linked to the SNP rs6681102 and/or to one or more of its neighbors in the interval 236815776-236998150 of chromosome 1.

12. The individual prediction method for the screening or diagnosis or therapeutic management or prognosis of prostate cancer as claimed in claim 1, wherein the input data correspond to the combination of a variable defining the genotype linked to the SNP rs2048873 and/or to one or more of its neighbors in the interval 113062733-113411386 of chromosome 2 and of a variable defining the genotype linked to the SNP rs6804627 and/or to one or more of its neighbors in the interval 60928379-60979489 of chromosome 3 and of a variable defining the genotype linked to the SNP rs10245886 and/or to one or more of its neighbors in the interval 47461234-47557773 of chromosome 7.

13. The individual prediction method for the screening or diagnosis or therapeutic management or prognosis of prostate cancer as claimed in claim 1, wherein the input data correspond to the combination of a variable defining the genotype linked to the SNP rs1511695 and to one or more of its neighbors in the interval 218280585-218521047 of chromosome 1 and of a variable defining the genotype linked to the SNP rs4669835 and/or to one or more of its neighbors in the interval 12111054-12324507 of chromosome 2 and/or of a variable defining the genotype linked to the SNP rs12605415 and/or to one or more of its neighbors in the interval 23907695-24187878 of chromosome 18.

14. The individual prediction method for the screening or diagnosis or therapeutic management or prognosis of prostate cancer as claimed in claim 1, wherein the input data correspond to the combination of a variable defining the genotype linked to the SNP rs749915 and/or to one or more of its neighbors in the interval 39097014-39163238 of chromosome 4 and/or of a variable defining the genotype linked to the SNP rs13226041 and/or to one or more of its neighbors in the interval 104002818-104863625 of chromosome 7 and/or of a variable defining the genotype linked to the SNP rs721429 and/or to one or more of its neighbors in the interval 61335448-62195826 of chromosome 17.

15. The individual prediction method for the screening or diagnosis or therapeutic management or prognosis of prostate cancer as claimed in claim 1, wherein the input data correspond to the combination of a variable defining the genotype linked to the SNP rs4242384 and/or to one or more of its neighbors in the interval 128539973-128619555 of chromosome 8 and of a variable defining the genotype linked to the SNP rs9364048 and/or to one or more of its neighbors in the interval 70074721-70679396 of chromosome 6.

16. The individual prediction method for the screening or diagnosis or therapeutic management or prognosis of prostate cancer as claimed in claim 1, wherein the input data correspond to the combination of a variable defining the genotype linked to the SNP rs2352946 and/or to one or more of its neighbors in the interval 84695541-84776802 of chromosome 16 and of a variable defining the genotype linked to the SNP rs6755695 and/or to one or more of its neighbors in the interval 79446556-79664842 of chromosome 2 and of a variable defining the genotype linked to the SNP rs1138253 and/or to one or more of its neighbors in the interval 4098195-4506560 of chromosome 19.

17. The individual prediction method for the screening or diagnosis or therapeutic management or prognosis of prostate cancer as claimed in claim 1, wherein the input data correspond to the combination of a variable defining the genotype linked to the SNP rs13148138 and/or to one or more of its neighbors in the interval 127602673-128447913 of chromosome 4 and/or of a variable defining the genotype linked to the SNP rs1773842 and/or to one or more of its neighbors in the interval 29356293-29651117 of chromosome 10 and of a variable defining the genotype linked to the SNP rs10148742 and/or to one or more of its neighbors in the interval 43257771-43665346 of chromosome 14.

18. The individual prediction method for the screening or diagnosis or therapeutic management or prognosis of prostate cancer as claimed in claim 1, wherein the input data also contain variables linked to the age and to the clinical data and/or to the personal and family anamnesis data.

19. The individual prediction method for the screening or diagnosis or therapeutic management or prognosis of prostate cancer as claimed in claim 18, wherein the anamnesis data include the combination of four cancer history variables and one age category variable, the said history variables relating respectively to family history of a breast cancer, family history of prostate cancer, personal history of cancer, family history of other cancers.

20. The individual prediction method for the screening or diagnosis or therapeutic management or prognosis of prostate cancer as claimed in claim 1, further comprising:
the constitution of a database of examples (Bex) consisting of input data (xₘᵢ) and of proven results (yₘ*);
the construction of at least one optimum model by statistical learning comprising the following steps:
the choice of a family (F) of multivariable functions (f₁, . . . , fᵢ, . . . f_{N});
for a given function fᵢ the production of a model defined by the adjustment of parameters θj such that the estimation delivered by the model yₘ=fᵢ(xₘᵢ, θj) is as close as possible to that of the proven result yₘ*,
the comparison of the various estimations so as to define a function fᵢ that is optimized fᵢₒₚ and that makes it possible to define an optimum model;
the exploitation of the said optimum model from the said individual data (xᵢ) so as to provide the said predictive information (y) on the risk linked to prostate cancer.

21. The individual prediction method for the screening or diagnosis or therapeutic management or prognosis of prostate cancer as claimed in claim 20, wherein the example base (Bex) is generally split into a learning base (BA), for adjusting the parameters of the model, and a validation base (BV), also called validation base, for testing the model chosen and verifying its robustness.

22. The individual prediction method for the screening or diagnosis or therapeutic management or prognosis of prostate cancer as claimed in claim 20, further comprising the construction, in parallel, of a set of optimum models, each model being produced from a family (Fk) of functions, the predictive information on the risk linked to a disease resulting from the combination of the set of optimum models.

23. The individual prediction method for the screening or diagnosis or therapeutic management or prognosis of prostate cancer as claimed in claim 22, further comprising selection of an optimum subset of optimum models by an optimization method of the genetic algorithm type.

24. The individual prediction method for the screening or diagnosis or therapeutic management or prognosis of prostate cancer as claimed in claim 20, wherein the family of functions is of the MLP (Multi Layer Perceptron) type, a subset of the family of networks of neurons or of the Support Vector Machines (SVM) type or of the Relevance Vector Machines (RVM) type or of the frequentist model type relating to the nearest neighbor method.

25. An individual prediction device for the screening or diagnosis or therapeutic management or prognosis of prostate cancer comprising first means for acquiring individual information data by a user, at least a first software interface on which the said first means operate, and means running a software using the method as claimed in claim 1 and providing a predictive information on the risk linked to prostate cancer.

26. The individual prediction device for the screening or diagnosis or therapeutic management or prognosis of prostate cancer as claimed in claim 25, wherein said predictive information on the risk is restored to the user via the said software interface.

27. The individual prediction device for the screening or diagnosis or therapeutic management or prognosis of prostate cancer as claimed in claim 25, further comprising means of communication between the first acquisition means and the software, allowing the transmission of the information data and that of the predictive information.

28. The individual prediction device for the screening or diagnosis or therapeutic management or prognosis of prostate cancer as claimed in claim 25, further comprising second individual information data acquisition means and a second software interface, the first acquisition means relating to the acquisition of information of the clinical type, and the second means relating to the acquisition of information derived from a sample from the individual.
